(19) United States
(12) Patent Application Publication
(10) Pub. No.: US 2024/0386325 A1
(43) Pub. Date: Nov. 21, 2024

(54) MODULAR FRAMEWORK FOR TRAINING FORWARD-IN-TIME MACHINE LEARNING PROCESSES IN DISTRIBUTED COMPUTING ENVIRONMENTS

(71) Applicant: The Toronto - Dominion Bank, Toronto (CA)

(72) Inventors: Guangwei YU, Toronto (CA); Maksims VOLKOVS, Toronto (CA); Salya Krishna GORTI, Toronto (CA); Baiju Hasmukhrai DEVANI, Toronto (CA)

(21) Appl. No.: 18/665,211

(22) Filed: May 15, 2024

Related U.S. Application Data
(63) Continuation-in-part of application No. 18/373,918, filed on Sep. 27, 2023.
(60) Provisional application No. 63/466,925, filed on May 16, 2023.

(51) Int. Cl. G06N 20/00

(52) U.S. Cl. CPC G06N 20/00

(57) ABSTRACT

The disclosed embodiments include computer-implemented processes and systems that establish configurable pipelines for training and deploying machine-learning processes in distributed computing environments. By way of example, an apparatus may obtain a dataset comprising a plurality of indexed data elements, and based on sample and temporal identifiers associated with each of the indexed data elements, the apparatus may perform operations that partition the dataset into corresponding ones of a plurality of partitioned datasets in accordance with first configuration data. The apparatus may generate feature vectors associated with each of the partitioned datasets based on a corresponding subset of the indexed data elements and in accordance with second configuration data. The apparatus may also perform operations, in accordance with third configuration data, that train a machine-learning process to predict an occurrence of a target event during a future temporal interval based on the feature vectors associated with each of the partitioned datasets.

### CROSS-REFERENCE TO RELATED APPLICATION

This application claims the benefit of priority under 35 U.S.C. § 119 (e) to prior U.S. Application No. 63/466,925, filed May 16, 2023, and is a continuation-in-part of prior U.S. application Ser. No. 18/373,918, filed Sep. 27, 2023. The disclosures of these applications are incorporated by reference herein to their entireties.

### TECHNICAL FIELD

The disclosed embodiments generally relate to a configurable, and modular, framework for training machine-learning processes in distributed computing environments.

### BACKGROUND

Today, machine-learning processes are widely adopted throughout many organizations and enterprises, and inform both user- or customer-facing decisions and back-end decisions. Many machine-learning processes operate, however, as “black boxes,” and lack transparency regarding the importance and relative impact of certain input features, or combinations of certain input features, on the operations of these machine-learning processes and on the output generated by these machine-learning and processes. Further, many of existing machine-learning processes are developed in response to specific use-cases, and are incapable of flexible deployment across multiple uses cases without significant modification and adaption by experienced developers and data scientists.

### SUMMARY

In some examples, an apparatus includes a memory storing instructions, a communications interface, and at least one processor coupled to the memory and the communications interface. The at least one processor is configured to execute the instructions to obtain a dataset comprising a plurality of indexed data elements. Each of the indexed data elements include a sample identifier and a temporal identifier associated with a corresponding temporal interval. The at least one processor is configured to execute the instructions to, based on the sample and temporal identifiers, perform operations that partition the dataset into corresponding ones of a plurality of partitioned datasets in accordance with first configuration data. Each of the partitioned datasets include a subset of the data elements. The at least one processor is configured to execute the instructions to generate feature vectors associated with each of the partitioned datasets based on the corresponding subset of the data elements. The feature vectors are generated in accordance with second configuration data. The at least one processor is configured to execute the instructions to perform operations, in accordance with third configuration data, that train a machine-learning process to predict an occurrence of a target event during a future temporal interval based on the feature vectors associated with each of the partitioned datasets.

In other examples, a computer-implemented method includes obtaining, using at least one processor, a dataset comprising a plurality of indexed data elements. Each of the indexed data elements include a sample identifier and a temporal identifier associated with a corresponding temporal interval. The computer-implemented method includes based on the sample and temporal identifiers, performing operations, using the at least one processor, that partition the dataset into corresponding ones of a plurality of partitioned datasets in accordance with first configuration data. Each of the partitioned datasets include a subset of the data elements. The computer-implemented method includes generating, using the at least one processor, feature vectors associated with each of the partitioned datasets based on the corresponding subset of the data elements. The feature vectors are generated in accordance with second configuration data. The computer-implemented method includes, using the at least one processor, performing operations, in accordance with third configuration data, that train a machine-learning process to predict an occurrence of a target event during a future temporal interval based on the feature vectors associated with each of the partitioned datasets.

Further, in some examples, a tangible, non-transitory computer-readable medium storing instructions that, when executed by at least one processor, cause the at least one processor to perform a method that includes obtaining a dataset comprising a plurality of indexed data elements. Each of the indexed data elements include a sample identifier and a temporal identifier associated with a corresponding temporal interval. The method includes, based on the sample and temporal identifiers, performing operations that partition the dataset into corresponding ones of a plurality of partitioned datasets in accordance with first configuration data. Each of the partitioned datasets include a subset of the data elements. The method includes generating feature vectors associated with each of the partitioned datasets based on the corresponding subset of the data elements. The feature vectors are generated in accordance with second configuration data. The method includes performing operations, in accordance with third configuration data, that train a machine-learning process to predict an occurrence of a target event during a future temporal interval based on the feature vectors associated with each of the partitioned datasets

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIG. 1 is a block diagram illustrating portions of an exemplary computing environment, in accordance with some embodiments.

FIGS. 2A, 2B, 3A, 3B, and 4A illustrate portions of an exemplary computing environment, in accordance with some embodiments.

FIG. 4B is a diagram of an exemplary graphical user interface, in accordance with some embodiments.

FIGS. 5A-5C and 6A-6D illustrate portions of an exemplary computing environment, in accordance with some embodiments.

FIG. 7 is a flowchart of an exemplary process for configuring an execution of sequential operations within a training or inferencing pipeline associated with a machine-learning process, in accordance with some embodiments.

FIG. 8 is a flowchart of an exemplary process 800 for executing sequentially application engines within training or inferencing pipeline associated with a machine-learning process, in accordance with some embodiments.

Like reference numbers and designations in the various drawings indicate like elements.

### DETAILED DESCRIPTION

Many organizations and enterprises rely on a predicted output of machine-learning processes to support and inform a variety of decisions and strategies. These organizations and enterprises may include, among other things, operators of distributed and cloud-based computing environments, financial institutions, physical or digital retailers, or entities in the entertainment or loading industries. Further, in some instances, the decisions and strategies informed by the predicted output of machine-learning processes may include customer- or user-facing decisions, such as decisions associated with the provisioning of resources, products or services in response to customer- or user-specific requests, and back-end decisions, such as decisions associated with an allocation of physical, digital, or computational resources among geographically dispersed users or customers, and decisions associated with a determined use, or misuse, of these allocated resources by the users or customers.

In some instances, the machine-learning processes may include a forward-in-time machine-learning process, which may be associated with a corresponding set of process-specific operations that, when executed sequentially by one or more computing systems (e.g., in a distributed computing environment), facilitate a generation of corresponding input datasets, an ingestion of the input datasets by the forward-in-time machine-learning process, and a generation of corresponding elements of predictive output. The predictive output of the forward-in-time machine-learning process may, for example, include a predicted likelihood of an occurrence of one, or more, target events during a future temporal interval (e.g., a “target” interval) based on the corresponding input datasets, which may be associated with a corresponding, prior temporal interval, e.g., a “lookback” interval. In some instances, the sequential execution of the process-specific operations by the one or more computing systems (e.g., distributed components of a distributed computing system) within a production environment may establish an inferencing pipeline for each of the machine-learning processes, which may generate the corresponding elements of predictive output in accordance with an underlying, process-specific delivery schedule (e.g., at an expected delivery time on a daily basis, a weekly basis, a bi-monthly basis, or on a monthly basis) and additionally, or alternatively, in real-time and in response to a request received from an additional device or computing system.

Further, and prior to deployment and active use within a production environment, each of the machine-learning processes may be trained adaptively using corresponding, and labeled, training, validation, and testing datasets associated with one or more prior temporal intervals, e.g., within a development environment. By way of example, during the adaptive training of the forward-in-time machine-learning process, the one or more computing systems may execute sequentially an additional set of process-specific operations that, among other things, retrieve and preprocess selectively source data tables, apply one or more target-generation and feature-generation operations to the source data tables based on the prior lookback and target intervals, and train adaptively the forward-in-time machine-learning process based on input datasets that include feature vectors and target, ground-truth labels. In some instances, the sequential execution of the additional sets of process-specific operations by the one or more computing systems within a development environment may establish a corresponding training pipeline for each of the machine-learning processes.

The sequential execution of the process-specific operations associated within the training pipeline, and additionally, or alternatively, the sequential execution of the process-specific operations associated within the inferencing pipeline, may output, for each of the machine-learning process, elements of process-specific explainability data that characterizes a predictive capability and an accuracy of the corresponding machine-learning process, which facilitates not an evaluation of the performance of the corresponding machine-learning process during an initial training phase within the development environment, but also an ongoing evaluation and monitoring of that performance during inferencing within the production environment. These initial, and ongoing, evaluation and monitoring processes may establish a conformity of each machine-learning process with one or more constraints imposed by an external governmental or regulatory entity, or internally by the organization or enterprise, and may enable the one or more computing systems to perform additional processes to mediate or mitigate an established non-conformity of one, or more, of a machine-learning process with the imposed constraints.

Today, however, these organizations and enterprises do not rely on the predictive output of a single machine-learning process, but often instead rely on the predictive output of dozens, if not hundreds, of discrete, machine-learning processes, and corresponding training and inferencing to inform decisions and strategies on a daily, monthly, or quarterly basis. Each of these discrete, machine-learning processes may be associated with a corresponding training, inferencing, and in some instances, monitoring pipelines of sequentially executed operations subject to concurrent execution in accordance with process-, and output-specific, schedules. Despite similarities or commonalities in process types, process configurations, data sources, or targeted events across the discrete, machine-learning processes, the training, inferencing, and monitoring pipelines associated with many machine-learning processes are characterized by fixed execution flows of sequential operations established by static, process- and pipeline-specific executable scripts, and by discrete, executable application modules or engines that are generated by data scientists in conformity within the particular use case within a corresponding pipeline and that perform static and inflexible process-specific operations.

The reliance on fixed execution flows, status executable scripts, and hand-coded, use-case-specific executable application modules or engines to perform static, and inflexible, process-specific operations within corresponding pipelines may, in some instances, discourage wide option of machine-learning technologies within many organizations. For example, the generation of hand-coded scripts or executable application modules or engines for each use-case of a machine-learning process within a corresponding training, inferencing or monitoring pipeline may result in duplicative and redundant effort by data scientists, e.g., as the multiple uses cases may be associated one or more common hard-coded scripts or executable application engines. Further, the time delay associated with the generation of these hand-coded scripts or executable application modules or engines, and with the post-training and pre-deployment validation of each of the machine-learning processes trained via the execution of corresponding ones of the hand-coded scripts or executable application modules or engines, may reduce a relevance of the predictive output to the decisioning processes of these organizations and render impractical real-time experimentation in the feature-generation or feature selection processes. Additionally, in some examples, a development of, and experimentation with, adaptive training and inference processes that rely on these hard-coded scripts or executable application engines may be impractical for all but experienced developers, data scientists, and engineers, who possess the skills required to generate and deploy the hard-coded scripts or executable application engines within the distributed computing environment.

Further, the processes that train forward-in-time, machine-learning processes within these adaptive training pipelines often experience data leakage, which may result poor process generalization and may overestimate an expected performance of the trained process. By way of example, data leakage may be introduced into these adaptive training pipelines during adaptive training pipelines during the application of the one or more target-generation and feature-generation operations to the source data tables and during the generation of the labeled, training, validation, and testing datasets, and sources of the data leakage may include, but are not limited to, a leakage of data between the temporally distinct training, validation, and testing datasets, an introduction of target, ground-truth labels or data from future temporal intervals into the source data tables, or an introduction of data into the source data tables, or into the training, validation, and testing datasets, that falls outside the scope of the use-case of the forward-in-time, machine-learning process. In some instances, the introduction of data leakage into these adaptive training pipelines may result in process overfitting that reduces a utility and predictive capability of the trained, forward-in-time, machine-learning process.

In some examples, described herein, one or more processors of a distributed or cloud-based computing system may implement a modular and configurable computational framework that facilitates an end-to-end training, validation, and deployment of a machine-learning process based on a sequential execution of application engines in accordance with established, and in some instances, configurable, pipeline-specific scripts. In some instances, the modular and configurable, computational framework described herein may be implemented within corresponding ones of an established training pipeline, inferencing pipeline, and/or target-generation pipeline of sequentially executed application engines, and may address flexibly multiple, distinct various use cases and facilitate interaction with developers and data scientists, of varied skill levels while maintaining a standardized, artifact-based approach to process monitoring, versioning, and explainability across the established training, inferencing, and/or target-generation pipelines, and without the occurrences of data leakage that characterize many existing processes for training forward-in-time machine-learning processes. Certain of these exemplary processes, as described herein, may be implemented in addition to, or as an alternate to, processes that rely on hand-coded scripts and a sequential execution of hard-coded application engines to train adaptively a machine-learning process, and to generate elements of process-specific predictive output based on an application of the trained machine-process to corresponding input datasets, on a use-case by use-case basis.

Further, and as described herein, one or more engine- and pipeline-specific operational constraints imposed on each of the sequentially executed application engines within corresponding ones of the training, target-generation, and inferencing pipelines may facilitate a facilitate compliance with one or more process-validation operations or requirements, and additionally, or alternatively, with one or more governmental or regulatory requirements, at each step within the training, target-generation, and inferencing pipelines. Certain of these exemplary processes, which may facilitate a validation a compliance of the sequentially executed application engines with the one or more process-validation operations or requirements, governmental requirements, and/or regulatory requirements at a pipeline level across multiple potential user cases, may also be implemented in addition to, or as an alternate to, processes that rely on hand-coded executable scripts and a sequential execution of hard-coded application engines associated with each of the multiple use-cases, which are often validated for compliance with the one or more process-validation operations or requirements, governmental requirements, and/or regulatory requirements on a use-case by use-case basis.

### A. Exemplary Computing Environments

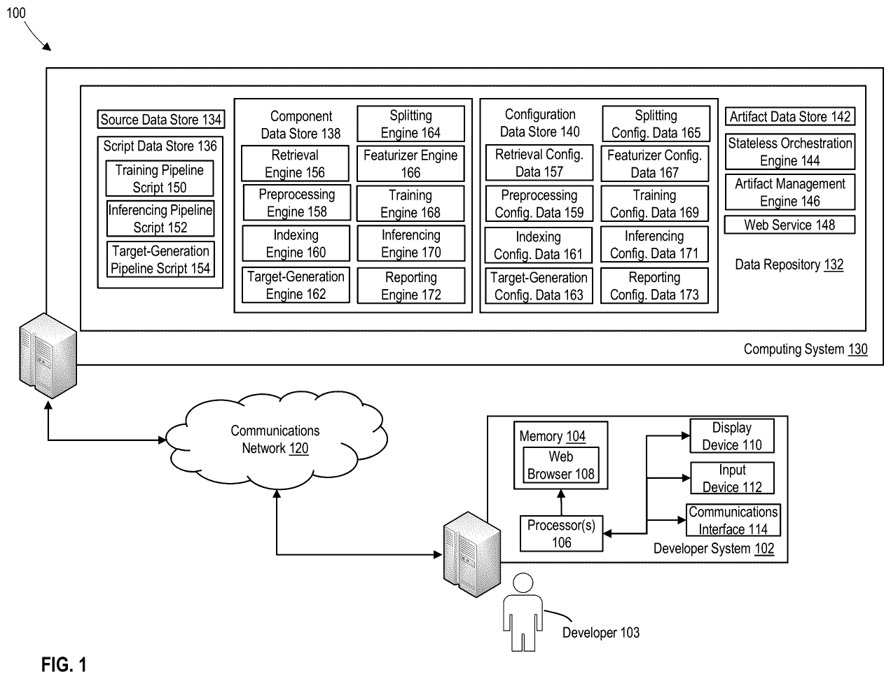

FIG. 1 illustrates components of an exemplary computing environment 100, in accordance with some exemplary embodiments. For example, as illustrated in FIG. 1, environment 100 may include one or more computing systems associated with, or operated by, an organization or enterprise, such as a developer system 102 and computing system 130. In some instances, developer system 102 and computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

Developer system 102 may include a computing system or device having one or more tangible, non-transitory memories, such as memory 104, that store data and/or software instructions, and one or more processors, such as processor(s) 106, configured to execute the software instructions. Memory 104 may store one or more software applications, application engines, and other elements of code executable by one or more processor(s) 106, such as, but not limited to, an executable web browser 108 (e.g., Google Chrome™, Apple Safari™, etc.) capable of interacting with one or more web servers established programmatically by computing system 130. By way of example, and upon execution by processor(s) 106, web browser 108 may interact programmatically with the one or more web servers of computing system 130 via a web-based interactive computational environment, such as a Juypter™ notebook or a Databricks™ notebook. Developer system 102 may also include a display device 110 configured to present interface elements to a corresponding user, such as developer 103, and an input device 112 configured to receive input from developer 103, e.g., in response to the interface elements presented through display device 110.

By way of example, display device 110 may include, but is not limited to, an LCD display device or other appropriate type of display device, and input device 112 may include, but is not limited to, a keypad, keyboard, touchscreen, voice activated control technologies, or appropriate type of input device. Further, in additional aspects (not illustrated in FIG. 1), the functionalities of display device 110 and input device 112 may be combined into a single device, such as, a pressure-sensitive touchscreen display device that presents interface elements and receives input from the user of developer system 102, such as developer 103. Developer system 102 may also include a communications interface 114, such as a wireless transceiver device, coupled to processor(s) 106 and configured by processor(s) 106 to establish and maintain communications with communications network 120 via one or more communication protocols, such as WiFi®, Bluetooth®, NFC, a cellular communications protocol (e.g., LTER, CDMA®, GSM®, etc.), or any other suitable communications protocol.

Examples of developer system 102 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface device or unit, such as display device 110. Further, a user, such as a developer 103, may operate developer system 102 and may do so to cause developer system 102 to perform one or more exemplary processes described herein.

In some examples, each of developer system 102 and computing system 130 may represent a computing system that includes one or more servers and tangible, non-transitory memories storing executable code and application engines. Further, the one or more servers may each include one or more processors, which may be configured to execute portions of the stored code or application engines to perform operations consistent with the disclosed embodiments. For example, the one or more processors may include a central processing unit (CPU) capable of processing a single operation (e.g., a scalar operation) in a single clock cycle. Further, computing system 130 may also include a communications interface, such as one or more wireless transceivers, coupled to the one or more processors for accommodating wired or wireless internet communication with other computing systems and devices operating within environment 100 in accordance with any of the exemplary communications protocols described herein.

Further, in some instances, each of developer system 102 and computing system 130 may be incorporated into a respective, discrete computing system. In additional, or alternate, instances, one or more of developer system 102 and computing system 130 may correspond to a distributed computing system having a plurality of interconnected, computing components distributed across an appropriate computing network, such as communications network 120 of FIG. 1. For example, computing system 130 may correspond to a distributed or cloud-based computing cluster associated with, and maintained by, the organization or enterprise. Although, in other examples computing system 130 may correspond to a publicly accessible, distributed or cloud-based computing cluster, such as a computing cluster maintained by Microsoft Azure™, Amazon Web Services™, Google Cloud™, or another third-party provider.

In some instances, computing system 130 may include a plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed or cloud-based computing components of computing system 130 may perform any of the exemplary processes described herein to implement a generalized and modular computational framework that facilitates an end-to-end training, validation, and deployment of a machine-learning process based on a sequential execution of application engines in accordance with established, and in some instances, configurable, pipeline-specific scripts.

The executable, and configurable, pipeline-specific scripts may include, but are not limited to, executable scripts that establish a training pipeline of a sequentially executed first subset of the application engines (e.g., a training pipeline script), an inferencing pipeline of a sequentially executed second subset of the application engines (e.g., an inferencing pipeline script), and a target-generation pipeline of a sequentially executed third subset of the application engines (e.g., a target-generation pipeline script). By way of example, the one or more processors of computing system 130 may execute one or more application programs, such as an orchestration engine 144, that establish the training pipeline and trigger a sequential execution of each of the first subset of the application engines in accordance with the training pipeline script, which may cause the distributed computing components of computing system 130 to perform any of the exemplary processes described herein to adaptively train a machine-learning process.

The executed orchestration engine may also establish the inferencing pipeline and trigger a sequential execution of each of the second subset of the application engines in accordance with inferencing pipeline script, which may cause the one or more processors of computing system 130 to apply a trained machine-learning process to an input dataset consistent with one or more customized feature-engineering operations, and to generate elements of post-processed, predictive output customized to reflect a particular user-case of interest to developer 103. The executed orchestration engine may also perform operations that establish the target-generation pipeline and trigger a sequential execution of each of the third subset of the application engines in accordance with the target-generation pipeline script, which may cause the one or more processors of computing system 130 to perform any of the exemplary processes described herein to generate a value of a target, ground-truth label for each element of an indexed dataframe, such as, but not limited to, datasets or dataframes associated with prior inferencing operations involving forward-in-time machine-learning processes.

To facilitate a performance of one or more of these exemplary processes, computing system 130 may maintain, within the one or more tangible, non-transitory memories, a data repository 132 that includes a source data store 134, a script data store 136, a component data store 138, a configuration data store 140, and an artifact data store 142. Further, and to facilitate a performance of one or more of these exemplary processes, computing system 130 may also maintain, within data repository 132, orchestration engine 144, an artifact management engine 146, and a programmatic web service 148, each of which may be executed by the one or more processors of computing system 130 (e.g., by the distributed computing components of computing system 130).

By way of example, source data store 134 may include one or more elements of data identifying and characterizing one or more users (e.g., users of the distributed computing components of computing system 130, customers of the financial institution, etc.), and interactions of these users with various organizations, computing systems operated by these organizations, or other users across one or more prior temporal intervals. The elements of data may be maintained within source data store 134 in one or more tabular data structures (e.g., as one or more source data tables), and each of the tabular data structures may be associated with a corresponding, and unique, identifier (e.g., an alphanumeric table identifier, a file path within the one or more tangible, non-transitory memories of computing system 130), a corresponding primary key (or a corresponding composite primary key) and in some instances, a corresponding index. In some instances, distributed computing components of computing system 130 may perform operations (not illustrated in FIG. 1) that programmatically obtain (e.g., “ingest”) one or more of the elements of data from corresponding data repositories maintained at computing systems associated with or operated by various organizations, or by one or more governmental or reporting entities (e.g., a credit bureau) in accordance with a predetermined or dynamically determined schedule. Examples of the primary keys associated with each of the source data tables may include, but are not limited to, a unique, alphanumeric identifier assigned to each user and a timestamp or other temporal data associated with the source data table, e.g., an ingestion date of the source data table or an event date associated with the elements of data within the source data table.

In some instances, script data store 136 may include a plurality of configurable, pipeline-specific scripts that, upon execution by the one or more processors of computing system 130, facilitate the end-to-end training, validation, and deployment of a machine-learning process based on a sequential execution of one or more subsets of the discrete executable application engines maintained within component data store 138 in accordance with corresponding elements of engine-specific configuration data maintained within configuration data store 140. Each of the executable, pipeline-specific scripts, including training pipeline script 150, inferencing pipeline script 152, and target-generation pipeline script 154, may be maintained in Python™ format and in a portion of a data repository accessible to the one or more computing systems of the organization or enterprise, e.g., within a partition of a Hadoop™ distributed file system (e.g., a HDFS) accessible to developer system 102. Further, each of the elements of engine-specific configuration data may be structured and formatted in a human-readable data-serialization language, such as, but not limited to, a YAML™ data-serialization language or an extensible markup language (XML). In some instances, and through a performance of any of the exemplary processes described herein, developer system 102 may modify, update, or “customize” one or more of training pipeline script 150, inferencing pipeline script 152, and target-generation pipeline script 154, and additionally, or alternatively, one or more of the elements of engine-specific configuration data, to reflect a particular use-case of interest to developer 103.

Component data store 138 may include a plurality of discrete application engines associated with the end-to-end training, validation, and deployment of one or more machine-learning processes, and each of the discrete application engines may also be associated with corresponding elements of configuration data, which may be maintained within configuration data store 140. For examples, the executable application engines maintained within component data store 138 may include, among other things, a retrieval engine 156, a preprocessing engine 158, an indexing engine 160, a target-generation engine 162, a time-series splitting engine 164, a time-series featurizer engine 166, a training engine 168, an inferencing engine 170, and a reporting engine 172. As described herein, each of these application engines may be associated with a corresponding programmatic interface that may invoked (or called) within respective ones of the training pipeline script 150, inferencing pipeline script 152, and target-generation pipeline script 154.

In some instances, each of the application engines maintained within component data store 138 may be associated with, and perform operations consistent with, corresponding elements of the engine-specific configuration data maintained within configuration data store 140. By way of example, as illustrated in FIG. 1, configuration data store 140 may include elements of retrieval configuration data 157 (e.g., associated with retrieval engine 156), preprocessing configuration data 159 (e.g., associated with preprocessing engine 158), indexing configuration data 161 (e.g., associated with indexing engine 160), target-generation configuration data 163 (e.g., associated with target-generation engine 162), featurizer configuration data 167 (e.g., associated with time-series featurizer engine 166), training configuration data 169 (e.g., associated with training engine 168), inferencing configuration data 171 (e.g., associated with inferencing engine 170), and reporting configuration data 173 (e.g., associated with reporting engine 172).

When executed by the one or more processors of computing system 130 within a corresponding one of the training, inferencing, or target-generation pipelines (e.g., in accordance with training pipeline script 150, inferencing pipeline script 152, or target-generation pipeline script 154), each of the application engines maintained within component data store 138 may ingest corresponding elements of the engine-specific configuration data and one or more additional elements of input data (e.g., engine-specific “input artifacts”), perform one or more operations consistent with the corresponding elements of engine-specific configuration data, and generate one or more elements of output data (e.g., engine-specific “output artifacts”). In some instances, the engine-specific configuration data may specify, for the corresponding ones of the application engines, an identity, structure, or composition of the input artifacts, the one or more operations (e.g., as helper scripts executable in the namespace of the corresponding one of the application engines), a value of one or more parameters characterizing the operations, and an identity, structure, or composition of the output artifacts.

In some instances, and prior to the performance of the operations consistent with the engine-specific configuration data, each or a subset of the executed application engines may perform additional operations that enforce engine- or pipeline-specific constraints imposed on the executed application engines by an external governmental or regulatory entity, or imposed internally by the organization or enterprise. By way of example, to support an enforcement of these imposed engine- or pipeline-specific constraints at each sequential step of the training, inferencing, and target-generation pipelines described herein, the programmatic interface associated with each of the executed application engines may parse the ingested engine-specific input artifacts (e.g., the elements of engine-specific configuration data) and establish a consistency of the engine-specific input artifacts with the engine- and pipeline-specific operational constraints imposed on the executed application engine.

If the programmatic interface of the executed application engine were to establish an inconsistency between the imposed, engine- and pipeline-specific operational constraints and at least one of the engine-specific input artifacts, the executed application engine may generate an output artifact characterizing the established inconsistency and further, generate a failure in an execution of the corresponding one of the training, inferencing, and target-generation pipelines, as described herein. In some instances, the executed application engine may provision the output artifact to artifact management engine 146, which may be executed by the one or more processors of computing system 130. Executed artifact management engine 146 may store the output artifact and a unique component identifier of the corresponding executed application engine within a data record of artifact data store 142, the data record associated with the corresponding one of the training, inferencing, or target-generation pipelines. Further, the one or more processors of computing system 130 may cease the execution of the corresponding one of the training, inferencing, or target-generation pipelines. Alternatively, if the programmatic interface of the executed application engine were to deem the engine-specific input artifacts consistent with the imposed, engine- and pipeline-specific operational constraints, the executed application engine may perform the one or more operations consistent with the corresponding elements of engine-specific configuration data, and generate the one or more engine-specific output artifacts within the corresponding one of the default training, inferencing, or target-generation pipelines.

Further, when executed by the one or more processors of computing system 130, each of the configurable, pipeline-specific scripts maintained within script data store 136 may establish a “default” pipeline of a sequentially executed subset of the application engines maintained within component data store 138. In some instances, each of the default pipelines may be associated with a default execution flow, which specifies an order in which the one or more processors of computing system 130 execute sequentially the corresponding subset of the application engines. By way of example, when executed by the one or more processors of computing system 130, training pipeline script 150 may establish a default training pipeline of a sequentially ordered subset of the application engines that includes, but is not limited to, retrieval engine 156, preprocessing engine 158, indexing engine 160, target-generation engine 162, time-series splitting engine 164, time-series featurizer engine 166, training engine 168, and reporting engine 172. Further, in some examples, when executed by the one or more processors of computing system 130, inferencing pipeline script 152 may establish a default inferencing pipeline of a sequentially ordered subset of the application engines that includes, but is not limited to, retrieval engine 156, preprocessing engine 158, indexing engine 160, time-series featurizer engine 166, inferencing engine 170, and reporting engine 172.

Additionally, when executed by the one or more processors of computing system 130, target-generation pipeline script 154 may establish a default target-generation pipeline of a sequentially ordered subset of the application engines that includes, but is not limited to, retrieval engine 156, preprocessing engine 158, target-generation engine 162, and reporting engine 172. In some instances, and through a performance of any of the exemplary processes described herein, developer system 102 may modify, update, or “customize” one or more of a composition of the sequentially ordered subset of the application engines associated with corresponding ones of the default training pipeline, the default inferencing pipeline, and the default target-generation pipeline, and additionally, or alternatively, the execution flow of sequentially executed application engines within corresponding ones of the default training pipeline, the default inferencing pipeline, and the default target-generation pipeline, to reflect a particular use-case of interest to developer 103.

By way of example, upon execution by the one or more processors of computing system 130, executed orchestration engine 144 may access script data store 136, and perform operations that trigger an execution of a corresponding one of training pipeline script 150, inferencing pipeline script 152, and target-generation pipeline script 154, which establishes or initiates of a current implementation, or “run,” of a corresponding one of the default training pipeline, the default inferencing pipeline, and the default target-generation pipeline. In some instances, executed orchestration engine 144 may assign a unique, alphanumeric identifier to the current run of the corresponding one of the default training pipeline, the default inferencing pipeline, and the default target-generation pipeline (e.g., a “run identifier”) and may generate a temporal identifier characterizing an initiation date of the current run of the corresponding one of the default training pipeline, the default inferencing pipeline, and the default target-generation pipeline. Further, and based on programmatic communications with artifact management engine 146 (e.g., executed by the one or more processors of computing system 130), executed orchestration engine 144 may perform operations, described herein, that store the run and temporal identifiers within a data record of artifact data store 142 associated with the current run of the corresponding one of the default training pipeline, the default inferencing pipeline, and the default target-generation pipeline, i.e., a run- and pipeline-specific data record within artifact data store 142.

Further, and during a sequential execution of the application engines within a current run of a corresponding one of the default training, inferencing pipeline, and target-generation pipelines, executed orchestration engine 144 may perform any of the exemplary processes described herein to provision the one or more input artifacts (including the elements of engine-specific configuration data) to each of the sequentially executed application engines, and to obtain the output artifacts generated each of the sequentially executed application engines. By way of example, upon execution by the one or more processors of computing system 130 within the corresponding one of the default training, inferencing, or target-generation pipelines, executed retrieval engine 156 may ingest the elements of retrieval configuration data 157 (e.g., as corresponding input artifacts), and perform operations consistent with the ingested elements of retrieval configuration data 157 that access one or more data repositories (e.g., source data store 134, etc.) and obtain one or more source data tables associated with the particular use-case of interest to developer 103, e.g., as corresponding output artifacts.

Upon execution by the one or more processors of computing system 130 within the corresponding one of the default training, inferencing, or target-generation pipelines, executed preprocessing engine 158 may ingest the elements of preprocessing configuration data 159 and the one or more source data tables associated with the particular use-case (e.g., as corresponding input artifacts), and may perform any of the exemplary processes described herein, consistent with the retrieved elements of preprocessing configuration data 159, to generate one or more preprocessed source data tables based on an application of a default preprocessing operation to corresponding ones of the obtained source data tables (e.g., as corresponding output artifacts). Further, upon execution by the one or more processors of computing system 130 within the corresponding one of the default training or inferencing pipelines, executed indexing engine 160 may ingest the elements of indexing configuration data 161 and the one or more preprocessed source data tables (e.g., as corresponding input artifacts), and may perform any of the exemplary processes described herein, consistent with the retrieved elements of indexing configuration data 161, to generate an indexed dataframe that includes columns of the preprocessed source data tables associated with corresponding primary keys or composite primary keys (e.g., as corresponding output artifacts).

Further, upon execution by the one or more processors of computing system 130 within the default training pipeline, executed target-generation engine 162 may ingest, as input artifacts, the elements of target-generation configuration data 163, the one or more preprocessed data tables generated by executed preprocessing engine 158, and the indexed dataframe generated by executed indexing engine 160. In some instances, within the default training pipeline, executed target-generation engine 162 may perform any of the exemplary processes described herein, based on the ingested elements of target-generation configuration data 163, to determine a corresponding ground-truth label for each element (e.g., row) of the indexed dataframe and to generate elements of a labelled dataframe that associate each element of the indexed dataframe with the corresponding ground-truth label (e.g., as corresponding output artifacts).

Additionally, or alternatively, executed target-generation engine 162 may also perform operations within the default target-generation pipeline that ingest, as input artifacts, the elements of target-generation configuration data 163, the one or more preprocessed data tables generated by executed preprocessing engine 158, and elements of predictive output generated through a prior application of the forward-in-time machine-learning process to customer-specific feature values within during a prior run of the default inferencing pipeline. Executed target-generation engine 162 may perform any of the exemplary processes described herein, consistent with target-generation engine 162, to determine a corresponding ground-truth label for each element of the predictive output and that generate elements of an additional labelled dataframe that associates each element of the predictive output with the corresponding ground-truth label (e.g., as additional output artifacts). In some instances, the generation of target, ground-truth labels associated with forward-in-time predicted output generated during one, or more, prior runs of the default inferencing pipeline may facilitate an ongoing monitoring or assessment of an accuracy of these forward-in-time predictions during future temporal intervals.

In some instances, upon execution by the one or more processors of computing system 130 during the current run of the default training pipeline, executed time-series splitting engine 164 may ingest, as input artifacts, the elements of splitting configuration data 165 and a labelled, indexed dataframe generated by executed target-generation engine 162. Executed time-series splitting engine 164 may perform any of the exemplary processes described herein, consistent with the ingested elements of splitting configuration data 165, to apply one or more default time-series splitting processes to the labelled, indexed dataframe, and to partition initially the labelled, indexed dataframe into corresponding in-time and out-of-time partitioned dataframes based on a temporal splitting point, and to partition further each of the in-time and out-of-time partitioned dataframes into corresponding in-sample and out-of-sample partitions based on corresponding in-sample and out-of-sample population sizes.

As described herein, the rows of the labelled, indexed dataframe associated with the in-time, and in-sample, partition may establish a training dataframe for the forward-in-time machine-learning process, the rows of the labelled, indexed dataframe associated with the in-time, and out-of-sample, partition may establish a validation dataframe for the forward-in-time machine-learning process, and the rows of the labelled, indexed dataframe associated with the out-of-time, and in-sample, partition, and the out-of-time, and out-of-sample, partition may collectively establish a testing dataframe for the forward-in-time machine-learning process. In some instances, executed time-series splitting engine 164 may perform operations that output the training, validation, and testing dataframes for the forward-in-time machine-learning process, and splitting data characterizing the temporal splitting point and the in-sample and out-of-sample population sizes, as corresponding output artifacts.

Additionally, and upon execution by the one or more processors of computing system 130 within the default training pipeline, executed time-series featurizer engine 166 may ingest, as input artifacts, the elements of featurizer configuration data 167 and the indexed training, validation, and testing dataframes for the forward-in-time machine-learning process (e.g., generated by executed indexing engine 160 and time-series splitting engine 164), and in some instances, the preprocessed data tables generated by executed preprocessing engine 158. Executed time-series featurizer engine 166 may perform any of the exemplary processes described herein, consistent with the ingested elements of featurizer configuration data 167, that generate, for each customer-specific element of the training, validation, and testing dataframes, a corresponding feature vector of discrete feature values based upon, among other things, an application of one or more aggregation operations (e.g., “backwards-in-time” aggregation operations, etc.) to corresponding elements of the preprocessed source data tables associated with a prior, temporal “lookback” interval (e.g., within a corresponding “featurizer pipeline” established by executed time-series featurizer engine 166 within the default training pipeline).

Within the default training pipeline, executed time-series featurizer engine 166 may output vectorized training, validation, and testing dataframes that associate respective ones of the training, validation, and testing dataframes with corresponding ones of the generated feature vectors. As described herein, the vectorized training, validation, and testing dataframes may correspond to output artifacts of executed time-series featurizer engine 166, which may be provisioned to executed artifact management engine 146. Further, in some instances, executed time-series featurizer engine 166 may also perform operations, within the default training pipeline, that generate programmatically an executable script. The executable script, upon execution by the one or more processors of computing system 130, causes the one or more processors to apply sequentially each of the backwards-looking aggregation operations to a corresponding, preprocessed data table (or data tables), and to generate each of the discrete feature values within a corresponding feature vector. As described herein, executed time-series featurizer engine 166 may also provision the programmatically generated script (e.g., a “featurizer pipeline script”) as an additional output artifact to executed artifact management engine 146.

Further, and upon execution by the one or more processors of computing system 130 within the default inferencing pipeline, executed time-series featurizer engine 166 may ingest, as input artifacts, the elements of featurizer configuration data 167, an indexed dataframe generated by executed indexing engine 160, the featurizer pipeline script (e.g., generated by time-series featurizer engine 166 within the default training pipeline), and additionally, or alternatively, one or more of the preprocessed data tables generated by executed preprocessing engine 158. Executed time-series featurizer engine 166 may perform any of the exemplary processes described herein, consistent with the elements of featurizer configuration data 167, that, for each customer-specific element of the indexed dataframe, apply sequentially each of the backwards-looking aggregation operations to the one or more preprocessed data tables within the prior, temporal lookback interval based on an execution of the featurizer pipeline script, and generate the discrete feature values within a corresponding, customer-specific feature vector based on the sequential application of the backwards-looking aggregation operations to the one or more preprocessed data tables. As described herein, executed time-series featurizer engine 166 may perform operations, within the default inferencing pipeline, that output a vectorized inferencing dataframe, the inferencing dataframe associating each element of the ingested, indexed dataframe with the corresponding feature vector as output artifacts, which may be provisioned to executed artifact management engine 146.

Upon execution by the one or more processors of computing system 130 within the default training pipeline, executed training engine 160 may ingest, as input artifacts, the elements of training configuration data 169 and each of the vectorized training, validation, and testing dataframes (e.g., as generated within the default training pipeline by executed time-series featurizer engine 166). In some instances, executed training engine 168 may perform any of the exemplary processes described herein, consistent with the elements of training configuration data 169, that apply the forward-in-time machine-learning process (e.g., the gradient-boosted, decision-tree processes described herein, etc.) to the customer-specific feature vectors within corresponding ones of the vectorized training, validation, and testing dataframes, those exemplary processes further generating corresponding elements of training output data, validation output data, and testing output data based on the application of the forward-in-time machine-learning process to each feature vector of respective ones of the vectorized training, validation, and testing dataframes. Executed training engine 168 may perform any of the exemplary processes described herein, within the default training pipeline, that output the elements of training output data, validation output data, and testing output data, as well as elements of log data characterizing the application of the forward-in-time machine-learning process to each feature vector of respective ones of the vectorized training, validation, and testing dataframes, as output artifacts, which may be provisioned to executed artifact management engine 146.

Further, and upon execution by the one or more processors of computing system 130 within the default inferencing pipeline, executed inferencing engine 170 may ingest, as input artifacts, the elements of inferencing configuration data 171, the vectorized inferencing dataframe (e.g., as generated by executed time-series featurizer engine 166 within the default inferencing pipeline), and in some instances, elements of process data that include, among other things, values of one or more process parameters associated with the trained, forward-in-time machine-learning process. Executed inferencing engine 170 may perform any of the exemplary processes described herein, consistent with the elements of inferencing configuration data 171, to instantiate the trained, forward-in-time machine-learning process in accordance with the process parameter values, to apply the trained, forward-in-time machine-learning process to each of the feature vectors within the vectorized inferencing dataframe, and to generate a corresponding element of predictive output based on the application of the trained, forward-in-time machine-learning process to each of the feature vectors. In some instances, executed inferencing engine 170 may perform any of the exemplary processes described herein, within the default inferencing pipeline, that output the elements of predictive output and elements of log data characterizing the application of the forward-in-time machine-learning process to each feature vector of the vectorized inferencing dataframe as output artifacts, which may be provisioned to executed artifact management engine 146.

Further, when executed by the one or more processors of computing system 130 within a corresponding one of the default training, inferencing, or target-generation pipelines, executed reporting engine 172 may perform any of the exemplary processes described herein, consistent with the elements of reporting configuration data 173, to generate elements of pipeline reporting data that characterize an operation and a performance of the discrete, modular components executed by the one or more processors of computing system 130 within the corresponding ones of the default training, inferencing, or target-generation pipelines. Executed reporting engine 172 may also perform operations, described herein, that structure the generated elements of pipeline reporting data in accordance with the elements of reporting configuration data 173 (e.g., in DOCX format, in PDF format, etc.) and that output the elements of pipeline reporting data as corresponding output artifacts, which may be provisioned to executed artifact management engine 146.

Based on programmatic communications with executed artifact management engine 146, orchestration engine 144 may perform any of the exemplary processes described herein, in conjunction with executed artifact management engine 146, that store the engine-specific output artifacts (and in some instances, the engine-specific input artifacts) in the corresponding one of the run- and pipeline-specific data records of artifact data store 142, along with unique identifiers of the corresponding, sequentially executed application engines. The association, within the run- and pipeline-specific data records of artifact data store 142, of the engine-specific input and/or output artifacts with corresponding run identifiers, corresponding component identifiers, and corresponding temporal identifiers, may establish an artifact lineage that facilitates an audit of a provenance of each artifact ingested by the corresponding one of the executed application engines during the current run, or during a prior run, of the default training, inferencing, and target-generation pipelines, and that facilitates a recursive tracking of the generation or ingestion of that artifact across the current or prior runs of the default training, inferencing, and target-generation pipelines.

B. Configurable Pipelines for Training Forward-In-Time Machine-Learning Processes in Distributed Computing Environments without Data Leakage

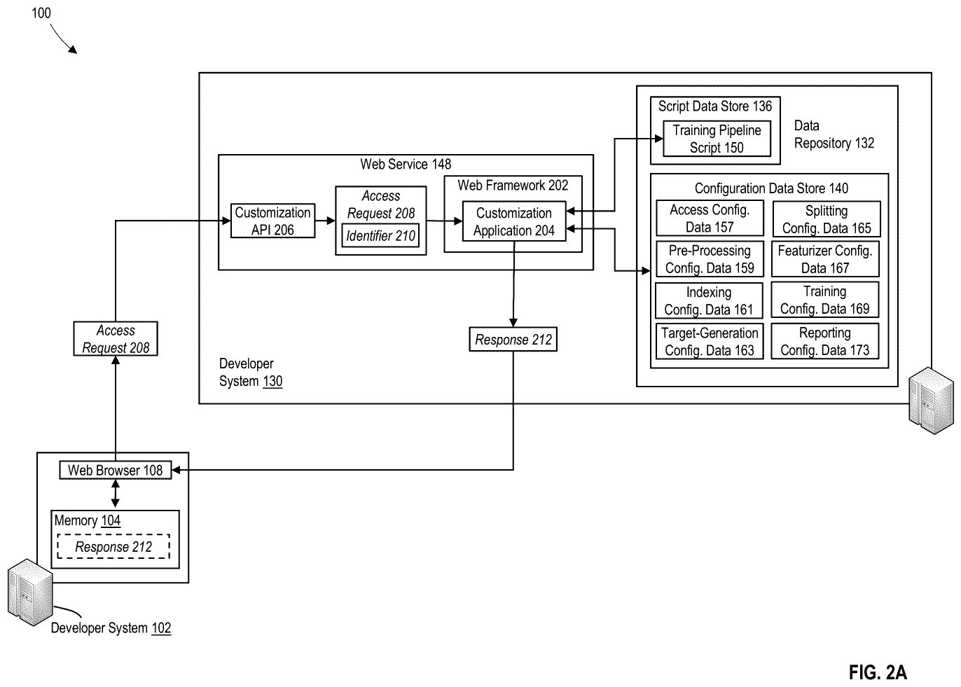

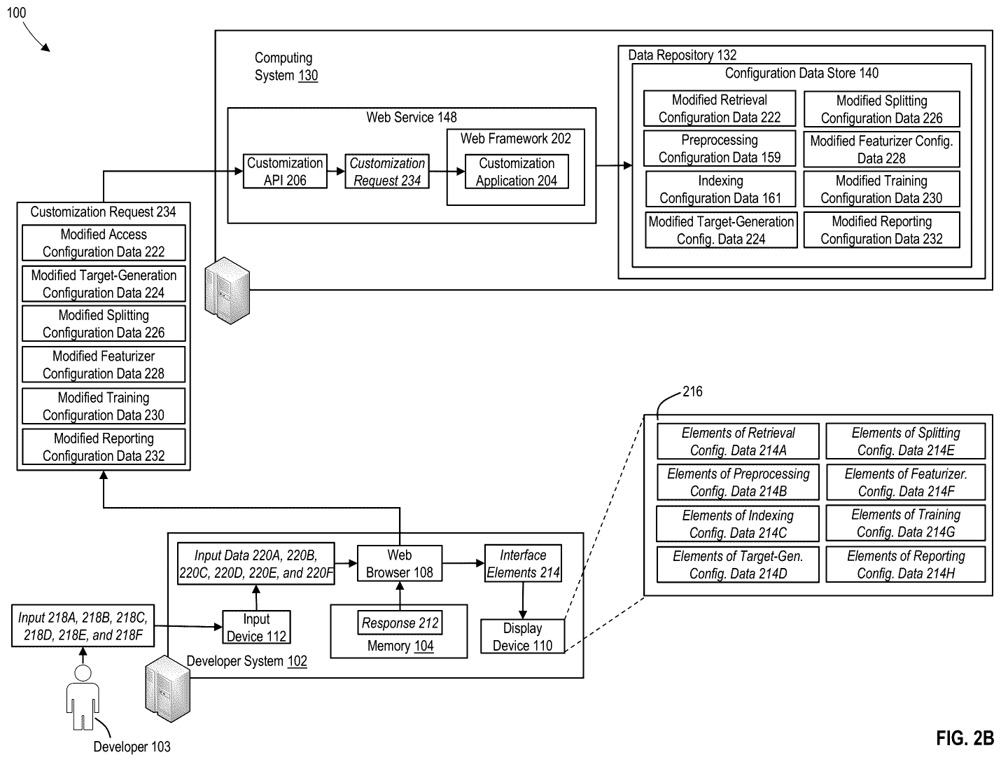

Referring to FIG. 2A, developer system 102 may perform operations that establish a secure, programmatic channel of communications across communications network 120 with one or more of the distributed computing components of computing system 130. For example, developer system 102 may execute web browser 108, which causes developer system 102 to exchange data with a web server executed by the one or more processors of computing system 130, such as executed programmatic web service 148. Developer system 102 also establishes the secure, programmatic channel of communications with executed programmatic web service 148 in accordance with one or more appropriate communications protocols, such as but not limited to a hypertext transfer protocol (HTTP), a transmission control protocol (TCP), or an internet protocol (IP). As described herein, executed programmatic web service 148 may perform operations that establish a corresponding web framework 202, which may orchestrate an execution of one or more application programs such as, but not limited to, a customization application 204, where such application programs may establish and maintain a programmatic interface associated with customization application 204, such as, but not limited to, a customization application programming interface (API) 206.

In some instances, and responsive to a request received from developer system 102 (or from other computing systems associated with corresponding business units of the organization or enterprise), customization API 206 and executed customization application 204 may perform operations, described herein, that enable developer system 102, via executed web browser 108, to access to one or more of the elements of configuration data associated with corresponding ones of the configuration application engines executed sequentially within one, or more, of the default target-generation, training, and inferencing pipelines (e.g., as maintained within configuration data store 140). The performed operations may also update, modify, or “customize” the one or more of the accessed elements of configuration data to reflect one or more data preprocessing, indexing and splitting, target-generation, feature-engineering, training, inferencing, and/or post-processing preferences associated with a particular use-case of interest to developer 103. As described herein, the modification of the accessed elements of configuration data by developer system 102 may enable developer system 102 to customize the sequential execution of the application engines within a corresponding one of the target-generation, training and inference pipelines to reflect the particular use-case without modification to the underlying code of the application engines or to corresponding ones of the pipeline-specific scripts executed by the distributed computing components of computing system 130, and while maintaining compliance with the one or more process-validation operations or requirements and with the one or more governmental or regulatory requirements.

By way of example, consistent with the particular use-case, developer 103 may elect to train adaptively a forward-in-time machine-learning process, such as, but not limited to, the gradient-boosted, decision-tree process described herein (e.g., an XGBoost process), to predict, during a current temporal interval, a likelihood of an occurrence of a targeted event during a targeted, future temporal interval using training, validation, and testing datasets. For instance, the current temporal interval may be characterized by a prediction date, and developer 103 may elect to train adaptively the forward-in-time machine-learning process to predict the likelihood of the occurrences of the targeted events during the targeted future temporal interval, e.g., a target temporal interval, based on input datasets associated with a corresponding prior extraction interval, e.g., a prior lookback interval. In some instances, the prediction date may represent an initial temporal boundary of the target temporal interval, although in other examples, the target temporal interval may be separated temporally from the prediction date by a corresponding buffer interval. The target temporal interval may, for example, be characterized by a predetermined duration, such as, but not limited to, three months, six months, nine months or twelve months, and the prior lookback interval may be characterized by a corresponding, predetermined duration, such as, but not limited to, one month, three months, or six months. Further, in some examples, the buffer interval may also be associated with a predetermined duration, such as, but not limited to, one month or three months.

Referring back to FIG. 2A, and to facilitate a customization of the sequential execution of the application engines within the default training pipeline in accordance with the particular use-case, executed web browser 108 may perform operations that generate a request 208 to access the elements of configuration data associated with all, or a selected subset, of the application engines sequentially executed within the default training pipeline. By way of example, and as described herein, the training pipeline may be established by the sequential execution of retrieval engine 156, preprocessing engine 158, indexing engine 160, target-generation engine 162, time-series splitting engine 164, time-series featurizer engine 166, training engine 168, and reporting engine 172, in accordance with training pipeline script 150, and each of these sequentially executed application engines may be associated with a corresponding one of retrieval configuration data 157, preprocessing configuration data 159, indexing configuration data 161, target-generation configuration data 163, splitting configuration data 165, featurizer configuration data 167, training configuration data 169, inferencing configuration data 171, and reporting configuration data 173.

For example, access request 208 may include, among other things, one or more identifiers of developer system 102 or executed web browser 108, such as, but not limited to, an IP address of developer system 102, a media access control (MAC) address assigned to developer system 102, or a digital token or application cryptogram identifying executed web browser 108 (e.g., a digital token or application cryptogram generated or received while establishing the secure, programmatic channel of communications with executed programmatic web service 148). Access request 208 may also include data that identifies the default training pipeline relevant to the particular use case, e.g., a unique, alphanumeric identifier 210 of the training pipeline. Executed web browser 108 may perform operations that cause developer system 102 to transmit access request 208 across communications network 120 to computing system 130, e.g., via the established, secure, programmatic channel of communications using an appropriate communications protocol.

In some instances, customization API 206 of executed customization application 204 may receive access request 208, and perform operations that determine whether computing system 130 permits a source of access request 208, e.g., developer system 102 or executed web browser 108, to access the elements of configuration data maintained within configuration data store 140. For example, customization API 206 may obtain, from access request 208, the one or more identifiers of developer system 102 or executed web browser 108, such as, but not limited to, the IP or MAC address of developer system 102 or the digital token or application cryptogram identifying executed web browser 108, Customization API 206 may also perform operations that determine, based on the one or more identifiers of developer system 102 or executed web browser 108, whether computing system 130 grants developer system 102 or executed web browser 108 permission to access the elements of configuration data maintained within configuration data store 140 (e.g., based on a comparison of the one or more identifiers against a compiled list of blocked computing devices, computing systems, or application programs). If customization API 206 were to establish that computing system 130 fails to grant developer system 102, or executed web browser 108, permission to access the elements of module-specific configuration data maintained within configuration data store 140, customization API 206 may discard access request 208 and computing system 130 may transmit an error message to developer system 102.

Alternatively, if customization API 206 were to establish that computing system 130 grants developer system 102 and/or executed web browser 108, permission to access the elements of configuration data maintained within configuration data store 140, customization API 206 may route access request 208 to executed customization application 204. In some instances, executed customization application 204 may obtain an identifier 210 of the training pipeline from access request 208, and based on identifier 210, customization application 204 may access script data store 136 and obtain training pipeline script 150, which upon execution by the one or more processors of computing system 130, triggers the sequential execution of retrieval engine 156, preprocessing engine 158, indexing engine 160, target-generation engine 162, time-series splitting engine 164, time-series featurizer engine 166, training engine 168, and reporting engine 172 within the established training pipeline.

As described herein, training pipeline script 150 may call, or invoke, a programmatic interface associated with each of the sequentially executed application engines within the default training pipeline, and the programmatic interfaces may ingest, among other things, input artifacts that include elements of configuration data associated with corresponding ones of the sequentially executed application engines and in some instances, output artifacts generated by one or more previously executed application engines within the default training pipeline. Executed customization application 204 may obtain, from training pipeline script 150, identifiers of the elements of configuration data associated with corresponding ones of retrieval engine 156, preprocessing engine 158, indexing engine 160, target-generation engine 162, time-series splitting engine 164, time-series featurizer engine 166, training engine 168, and reporting engine 172. Based on the obtained identifiers, executed customization application 204 may access configuration data store 140 maintained within data repository 132, obtain one or more of the elements of retrieval configuration data 157, preprocessing configuration data 159, indexing configuration data 161, target-generation configuration data 163, splitting configuration data 165, featurizer configuration data 167, training configuration data 169, inferencing configuration data 171, and reporting configuration data 173, and package these obtained elements into response 212 to access request 208.

Executed customization application 204 may perform operations that cause computing system 130 to transmit response 212, including the requested elements of engine-specific configuration data, across communications network 120 to developer system 102. In some instances, executed web browser 108 may receive response 212 and store response 212 within a corresponding portion of a tangible, non-transitory memory, such as within a portion of memory 104.

Referring to FIG. 2B, executed web browser 108 may access response 212 within memory 104, and may obtain the one or more requested elements of retrieval configuration data 157, preprocessing configuration data 159, indexing configuration data 161, target-generation configuration data 163, splitting configuration data 165, featurizer configuration data 167, training configuration data 169, and reporting configuration data 173 from response 212. In some instances, executed web browser 108 may perform operations that process these requested elements of configuration data and generate corresponding interface elements 214, which executed web browser 108 may route to display device 110 of developer system 102.

Display device 110 may, for example, receive interface elements 214, which provide a graphical representation of the requested elements of configuration data associated with the default training pipeline, as described herein, and may render all, or a selected portion, of interface elements 214 for presentation within one or more display screens of digital interface 216. As illustrated in FIG. 2B, the one or more display screens of digital interface 216 may present interface elements 214A, which provide a graphical representation of the requested elements of retrieval configuration data 157, interface elements 214B, which provide a graphical representation of the requested elements of preprocessing configuration data 159, interface elements 214C, which provide a graphical representation of the requested elements of indexing configuration data 161, and interface elements 214D, which provide a graphical representation of the requested elements of target-generation configuration data 163. Further, the one or more display screens of digital interface 216 may present interface elements 214E, which provide a graphical representation of the requested elements of splitting configuration data 165, interface elements 214F, which provide a graphical representation of the requested elements of featurizer configuration data 167, interface elements 214G, which provide a graphical, and editable, representation of the requested elements of training configuration data 169, and interface elements 214H, which provide a graphical, and editable, representation of the requested elements of reporting configuration data 173.

As described herein, the elements of retrieval configuration data 157, preprocessing configuration data 159, indexing configuration data 161, target-generation configuration data 163, splitting configuration data 165, featurizer configuration data 167, training configuration data 169, and reporting configuration data 173 may specify one or more default or standardized operations performed by corresponding ones of the sequentially executed application engines within the default training pipeline, along with corresponding default values of one or more parameters for these default or standardized operations. In some instances, and based on input perceived from developer 103 via input device 112, developer system 102 may perform operations that update, modify, or customize corresponding portions of the elements of retrieval configuration data 157, preprocessing configuration data 159, indexing configuration data 161, target-generation configuration data 163, splitting configuration data 165, featurizer configuration data 167, training configuration data 169, and reporting configuration data 173 to reflect the particular use-case of interest to developer 103, e.g., the adaptive training of the forward-in-time machine-learning process (e.g., the gradient-boosted, decision-tree process described herein) to predict, at the prediction date within the current temporal interval, the likelihood of the occurrence of the targeted event during the target temporal interval, which in some instances, may be separated from the prediction date by the buffer interval.

To facilitate the modification and customization of the elements of retrieval configuration data 157 to reflect the particular use-case, developer 103 may review interface elements 214A and may provide, to input device 112, elements of developer input 218A that, among other things, specify a unique identifier of each source data table that supports the adaptive training of the forward-in-time machine-learning process in accordance with the particular use-case, a primary key or composite primary key of each of the source data tables, and a network address of an accessible data repository that maintains each of the source data tables, e.g., a file path or an IP address of source data store 134, etc. As described herein, the elements of data maintained within each of the source data tables may identify and characterize the user (e.g., customers of the financial institution, etc.) across one or more temporal intervals, and in some instances, the elements of developer input 218A may also specify, among other things, a range of the prior temporal intervals associated with the particular use-case of interest to developer 103 and additionally, or alternatively, temporal boundaries that establish the range of the prior temporal intervals. Input device 112 may, for example, receive developer input 218A, and route corresponding elements of input data 220A to executed web browser 108, which may modify the elements of retrieval configuration data 157 to reflect input data 220A and generate corresponding elements of modified retrieval configuration data 222.

Further, upon reviewing interface elements 214B and 214C of digital interface 216, developer 103 may not elect to modify any of the elements of preprocessing configuration data 159 or indexing configuration data 161. Instead, developer 103 may elect to rely on the default preprocessing and data-indexing operations performed by corresponding ones of preprocessing engine 158 and indexing engine 160 within the default training pipeline, and on the default values for the one or more parameters of these application engines specified within corresponding ones of the elements of preprocessing engine 158, indexing engine 160.

In some instances, upon review of interface elements 214D of digital interface 216, developer 103 may elect to modify and customize one or more of the elements of target-generation configuration data 163 associated with target-generation engine 162 to reflect the particular use-case of interest to developer 103. For example, to customize the elements of target-generation configuration data 163, developer 103 may provide to input device 112, elements of developer input 218B that include, among other things, a duration of the target temporal interval associated with the particular use-case (e.g., six months and three months, respectively, etc.) and in some instances, of the corresponding buffer interval. The elements of developer input 218B may also include logic that defines the targeted event for the particular use-case and facilitates a detection of the targeted event when applied to elements of the preprocessed source data tables, such logic as, but not limited to, one or more helper scripts executable in the namespace of executed target-generation engine 162 within the default training pipeline, etc.

Further, upon review of interface elements 214E of digital interface 216, developer 103 may also elect to modify and customize one or more of the elements of splitting configuration data 165 associated with time-series splitting engine 164 to reflect the particular use-case of interest to developer 103. As described herein, developer 103 may elect to train adaptively a forward-in-time machine-learning process (e.g., a gradient-boosted, decision-tree process, such as an XGBoost process, etc.) to predict, at the prediction date within the current temporal interval, the likelihood of the occurrence of the targeted event during the target temporal interval, which in some instances, may be separated from the prediction date by the buffer interval. To support of the adaptive training of the forward-in-time machine-learning process, executed time-series splitting engine 164 may perform operations that apply a default, time-series splitting process to a labelled, indexed dataframe in accordance with the elements of splitting configuration data 165, and based on the application of the default, time-series splitting process to the labelled, indexed dataframe, executed time-series splitting engine 164 any of the exemplary processes described herein to partition initially the labelled, indexed dataframe into corresponding in-time and out-of-time partitioned dataframes based on a temporal splitting point, and to partition further each of the in-time and out-of-time partitioned dataframes into corresponding in-sample and out-of-sample partitions based on corresponding in-sample and out-of-sample population sizes.

By way of example, to customize the elements of splitting configuration data 165 associated with time-series splitting engine 164, developer 103 may provide, to input device 112, elements of developer input 218C that, among other things, specify an identifier of a labeled, indexed dataframe ingested by executed time-series splitting engine 164 (e.g., an input artifact) and one or more primary indexing keys of the labeled, indexed dataframe. In some instances, the identifier of a labeled, indexed dataframe may include, but is not limited to, an alphanumeric file name, a file path of the labelled, an indexed dataframe within artifact data store 142, or other information that enables executed orchestration engine 144 and/or executed artifact management engine 146 to access the labeled, indexed dataframe (e.g., an indexed dataframe within artifact data store 142) and to provision the labelled, indexed dataframe to executed time-series splitting engine 164 as an input artifact.

The elements of developer input 218C may also include a value of one or more parameters of the default, time-series splitting process that include, but are not limited to, a temporal splitting point (e.g., Jan. 1, 2023, etc.) as well as data specifying populations of in-sample and out-partitions of the labelled, indexed dataframe ingested by executed time-series splitting engine 164. By way of example, the data specifying the populations of in-sample and out-partitions of the labelled, indexed dataframe may include, but is not limited to, a first percentage of the rows of a labelled, indexed dataframe that represent “in-sample” rows and as such, an “in-sample” partition of the labelled, indexed dataframe, and a second percentage of the rows of the labelled, indexed dataframe that represent “out-of-sample” rows and as such, an “out-of-sample” partition of the labelled, indexed dataframe.

Further, in some instances, developer 103 may elect to stratify the rows of the labelled, indexed dataframe based on the corresponding ground-truth labels during the application of the default, time-series splitting process to the labelled, indexed dataframe (e.g., via a performance of target-stratified sampling operations during the application of the default, time-series splitting process), and the elements of developer input 218C may include additional data that, when processed by executed time-series splitting engine 164, causes executed time-series splitting engine 164 to implement the target-stratified sampling operations during the application of the default, time-series splitting process (e.g., an alphanumeric stratification flag, such as “true,” etc.) or alternatively, to apply the default, time-series splitting process to the labelled, indexed dataframe without target-stratified sampling (e.g., an additional alphanumeric stratification flag, such as “false,” etc.). The elements of developer input 218C may also include, in addition to the alphanumeric stratification flag of “true,” data that specifies the target-stratified sampling operations (e.g., elements in helper scripts callable in the namespace of executed time-series splitting engine 164) and a value of one or more parameters of the target-stratified sampling operations. As illustrated in FIG. 2B, input device 112 may receive developer input 218C, and may route corresponding elements of input data 220C to executed web browser 108, which may modify the elements of splitting configuration data 165 to reflect input data 220C and generate elements of modified splitting configuration data 226.

Upon review of interface elements 214F of digital interface 216, developer 103 may provide, to input device 112, additional elements of developer input 218D that modify and customize one or more of the elements of featurizer configuration data 167 associated with time-series featurizer engine 166. In some instances, and as described herein, the elements of featurizer configuration data 167 may specify one or more preprocessing operations that, when applied to one or more source data tables ingested by executed time-series featurizer engine 166, generate one or more processed data tables that support the adaptive training, validation, and testing of the forward-in-time machine-learning process. Examples of these preprocessing operations may include, but are not limited to, one or more temporal filtration operations, one or more filtration operations specific to elements of the ingested source data tables (e.g., user- or data-specific filtration operations), one or more join operations (e.g., an inner- or outer-join operations, etc.), operations that establish a presence or absence of columns associated with each of the primary keys within the ingested source data tables (e.g., the primary keys within the labelled, indexed dataframe), and operations that partition the preprocessed source data tables into corresponding partitioned data tables associated with the training, validation, and testing of the forward-in-time machine-learning process (e.g., the corresponding training, validation, and testing feature data tables described herein).

In some instances, developer 103 may provide, to input device 112, elements of developer input 218D that specify one or more of the preprocessing operations appropriate to the ingested source data tables and to the particular use-case of interest to developer 103, e.g., elements as helper scripts executable in the namespace of executed time-series featurizer engine 166. Further, the elements of developer input 218D may also include data identifying one or more primary keys of each of the ingested source data tables (e.g., alphanumeric identifiers of columns within corresponding ones of the ingested source data tables that maintain temporal data or user identifiers, etc.), data identifying and characterizing one or more inputs or outputs each of the specified preprocessing operations and additionally, or alternatively, a value of one or more parameters of each of the specified preprocessing operations. By way of example, one or more of the specified preprocessing operations may correspond to a “default” preprocessing operation associated with, and available to, executed time-series featurizer engine 166, which may be customized to reflect the particular use-case of interest to developer 103 using any of the exemplary processes described herein. In other examples, one or more of the specified preprocessing operations may represent a customized preprocessing operation consistent with the engine- and pipeline-specific operational constraints imposed on executed time-series featurizer engine 166 (e.g., and implemented through an execution of corresponding elements of executable code generated by developer 103).

Further, and as described herein, the elements of featurizer configuration data 167 may also establish, and maintain, a plurality of developer-specified groups of discrete features associated with the adaptive training, validation, and testing of the forward-in-time machine-learning process within the default training pipeline. In some instances, each of the feature groups may be associated with a corresponding one of the processed data tables that support the adaptive training, validation, and testing of the forward-in-time machine-learning process, and may include one or more of the discrete features associated with the adaptive training, validation, and testing of the forward-in-time machine-learning process. By way of example, and for each of the feature groups, executed time-series featurizer engine 166 may perform operations that generate a corresponding value of each of the one or more of the discrete features based on: (i) an application of a group-specific aggregation operation to elements of the corresponding one of the processed data tables (e.g., to entries maintained within a particular, feature-specific column, etc.) during a group-specific prior temporal interval, such as, such not limited to, a prior lookback interval specified by developer 103; and in some instances, (ii) an application of a group-specific post-processing operation to the output of the group-specific aggregation operation.

Developer 103 may provide, to input device 112, additional elements of developer input 218D that declare one or more of the feature groups, and that specify, for each of the declared feature groups, each of the one or more discrete features associated with the declared feature group, the corresponding one of the processed data tables, the duration of the prior lookback interval and the group-specific aggregation operation, and additionally, or alternatively, the group-specific post-processing operation. By way of example, and for a corresponding one of the declared feature groups, the additional elements of developer input 218D may include, but are not limited to, a group identifier (e.g., an alphanumeric group name, etc.) and a feature identifier of each of the discrete features associated with the corresponding one of the declared feature groups (e.g., an alphanumeric feature name, etc.). Further, the additional elements of developer input 218D associated with the corresponding one of the declared feature groups may include an identifier of the corresponding one of the processed data tables (e.g., an alphanumeric table name, a file path, etc.), and additionally or alternatively an identifier of a column within the corresponding one of the processed data tables that maintains temporal data characterizing each of the user-specific rows (e.g., an alphanumeric column name, etc.).

The additional elements of developer input 218D associated with the corresponding one of the declared feature groups may also include, but are not limited to, a duration of the group-specific, prior lookback interval (e.g., temporal boundaries of the group-specific, prior lookback interval, a number of days, etc.), an identifier of the group-specific aggregation operation (e.g., an alphanumeric identifier of an aggregation function, etc.), and an identifier of the group-specific post-processing operation (e.g., an alphanumeric identifier of an post-processing function, etc.), and a value of one or more parameters of the group-specific aggregation operation and/or the group-specific post-processing operation. As described herein, each of the group-specific aggregation operation and the group-specific post-processing operation may each represent stateless operations implemented by executed time-series featurizer engine 166, e.g., based on a call to the corresponding one of the aggregation and post-processing functions within the default training pipeline, and the aggregation and post-processing functions may be maintained within a function library accessible to executed time-series featurizer engine 166.

By way of example, the prior lookback interval may include a prior thirty-day interval, a prior forty-five-day interval, a prior six-month interval, or a prior one-year interval, and the group-specific aggregation operation may include a default aggregation operation, such as, but not limited to, an operation that computes an average value of a parameter across the prior lookback interval (e.g., an arithmetic mean, a geometric mean, etc.), an operation that determines a maximum or a minimum value of a parameter across the prior lookback interval, and an operation that determines a value of the parameter at a particular point within the prior lookback interval (e.g., the value of the parameter at an end of the prior lookback interval, etc.). Further, examples of the group-specific post-processing operations may include, but are not limited to, a one-hot-encoding operation, a label-encoding operation, a scaling operation (e.g., based on minimum, maximum, or average values, etc.), or other statistical processes applied to the output of the group-specific aggregation operation.

In some instances, through the declaration of each of the feature groups, and the specification of the one or more discrete features associated with the each of the declared feature group within the elements of developer input 218D, developer 103 may establish, and customize, a sequential order of feature values within a corresponding feature vector to reflect the particular use-case of interest to developer 103. Further, and through the application of the group-specific aggregation operations and the group-specific post-processing operations to the corresponding ones of the processed data tables during the group-specific, prior lookback interval (e.g., in accordance with the elements of developer input 218D), executed time-series featurizer engine 166 may perform any of the exemplary processes described herein to generate a feature vector for each row of an in-time and in-sample partition, an in-time and out-of-sample partition, and an out-of-time partition of a labelled, indexed dataframe, and without the data leakage associated with, and characterizing, many processes that train adaptively forward-in-time machine-learning processes. Input device 112 may, for example, receive developer input 218D, and may route corresponding elements of input data 220D to executed web browser 108, which may modify the elements of featurizer configuration data 167 to reflect input data 220D and generate corresponding elements of modified featurizer configuration data 228.

Referring back to FIG. 2B, and upon review of interface elements 214G and interface elements 214H of digital interface 216, developer 103 may elect to modify and customize one or more of the elements of training configuration data 169 and reporting configuration data 173 to reflect the particular use-case. By way of example, developer 103 may provide to input device 112 elements of developer input 218E that, among other things, specify a forward-in-time machine-learning process available for training by executed training engine 168 within the default training pipeline, which may be interest to developer 103 and of relevance the particular use case. Further, developer 103 may also provide additional elements of developer input 218E to input device 112 that establish a value or, or modify a default value of, one or more parameters of the specified forward-in-time machine-learning processes (or alternatively, an identifier and location of an ingestible artifact specifying the one or more parameter values).

In some instances, the elements of developer input 218E provisioned by developer 103 to developer system 102 (e.g., via input device 112) may include data that identifies the gradient-boosted, decision-tree process (e.g., via a corresponding default script callable within the namespace of training engine 168, via a corresponding file system path, etc.), and a value of one or more parameters of the gradient-boosted, decision-tree process, which may facilitate an instantiation of the gradient-boosted, decision-tree process within the training pipeline (e.g., by executed training engine 168). Examples of these parameter values for the specified gradient-boosted, decision-tree process may include, but are not limited to, a learning rate, a number of discrete decision trees (e.g., the “n_estimator” for the trained, gradient-boosted, decision-tree process), a tree depth characterizing a depth of each of the discrete decision trees, a minimum number of observations in terminal nodes of the decision trees, and/or values of one or more hyperparameters that reduce potential model overfitting. Further, in some instances, the elements of developer input 218E may also specify a structure of format of the elements of predictive output, and a structure of format of the generated inferencing logs (e.g., as an output file having a corresponding file format accessible at developer system 102, such as a PDF or a DOCX file). Input device 112 may, for example, receive developer input 218E, and may route corresponding elements of input data 220E to executed web browser 108, which may modify the elements of training configuration data 169 to reflect input data 220E and generate corresponding elements of modified training configuration data 230.

Further, as described herein, the elements of reporting configuration data 173 may specify a default composition and structure of the elements of pipeline monitoring data (e.g., one that characterizes a successful or failed application of each of the application engines within the established training pipeline) and the elements of pipeline validation data (e.g., ones that characterize the adaptive training, validation, and machine-learning process within the established training pipeline) generated by reporting engine 172 upon execution within the default training pipeline. In some instances, upon review interface elements 214H of digital interface 216, developer 103 may elect not to modify the default composition of either of the pipeline monitoring data or the pipeline explainability data, but developer 103 may also provide, to input device 112, elements of developer input 218F that, among other things, specify that reporting engine 172 generate the pipeline monitoring data and pipeline validation data in DOCX format. Input device 112 may receive developer input 218F, and may route corresponding elements of input data 220F to executed web browser 108, which may perform operations that modify the elements of training configuration data 169 to reflect input data 220F and generate elements of modified reporting configuration data 232.

Executed web browser 108 may package the elements of modified retrieval configuration data 222, modified target-generation configuration data 224, modified splitting configuration data 226, modified featurizer configuration data 228, modified training configuration data 230, and modified reporting configuration data 232 into corresponding portions of a customization request 234. In some instances, executed web browser 108 may also package into an additional portion of customization request 234, identifier 210 of the default training pipeline, the one or more identifiers of developer system 102 or executed web browser 108 such as but not limited to the IP or MAC address of developer system 102, or the digital token or application cryptogram identifying executed web browser 108. Executed web browser 108 may also perform operations that cause developer system 102 to transmit customization request 234 across communications network 120 to computing system 130.

In some instances, customization API 206 of executed customization application 204 may receive customization request 234, and perform any of the exemplary processes described herein to determine whether computing system 130 permits a source of customization request 234, e.g., developer system 102 or executed web browser 108, to modify or customize the elements of configuration data maintained within configuration data store 140. If, for example customization API 206 were to establish that computing system 130 fails to grant developer system 102, or executed web browser 108, permission to modify or customize the elements of configuration data maintained within configuration data store 140, customization API 206 may discard customization request 234 and computing system 130 may transmit a corresponding error message to developer system 102. Alternatively, if customization API 206 were to establish that computing system 130 grants developer system 102 and/or executed web browser 108 permission to modify or customize the elements of configuration data maintained within configuration data store 140, customization API 206 may route customization request 234 to executed customization application 204.

Executed customization application 204 may obtain, from customization request 234, identifier 210 and the elements of modified retrieval configuration data 222, modified target-generation configuration data 224, modified splitting configuration data 226, modified featurizer configuration data 228, modified training configuration data 230, and modified reporting configuration data 232, which reflect a customization of the default elements of engine-specific configuration data associated with the default training pipeline. Based on identifier 210, executed customization application 204 may access the elements of engine-specific configuration data maintained within configuration data store 140, and perform operations that replace or modify the elements of engine-specific configuration data based on corresponding ones of the elements of modified retrieval configuration data 222, modified target-generation configuration data 224, modified splitting configuration data 226, modified featurizer configuration data 228, modified training configuration data 230, and modified reporting configuration data 232.

Through a modification of one or more of the elements of engine-specific configuration data in accordance with the particular use-case of interest to developer 103, the exemplary processes described herein may enable developer system 102 to customize the sequential, pipelined execution of the application engines within the default training pipeline to reflect the particular use-case without any modification, by developer system 102, to training pipeline script 150, or to the underlying code of any of the application engines executed sequentially within the default training pipeline by the distributed computing components of computing system 130. Further, the one or more processors of computing system 130 (e.g., the distributed computing components of computing system 130) may perform operations, described herein, that establish the default training pipeline, and sequentially execute the application engines within the default training pipeline in accordance with the elements of engine-specific configuration data, which may be customized to reflect the particular use-case of interest to developer 103 using any of the exemplary processes described herein. In some instances, through a sequential execution of the application engines in accordance with the customized elements of engine-specific configuration data within the default training pipeline, one or more of the exemplary processes described herein may facilitate an adaptive training of the forward-in-time, machine-learning process of relevance to the particular use-case without requiring modification to any underlying code of the application engines or modification to an execution flow of the default training pipeline and further, without the data leakage and corresponding process overfitting associated with many computer-implemented techniques for training adaptively forward-in-time, machine-learning processes.

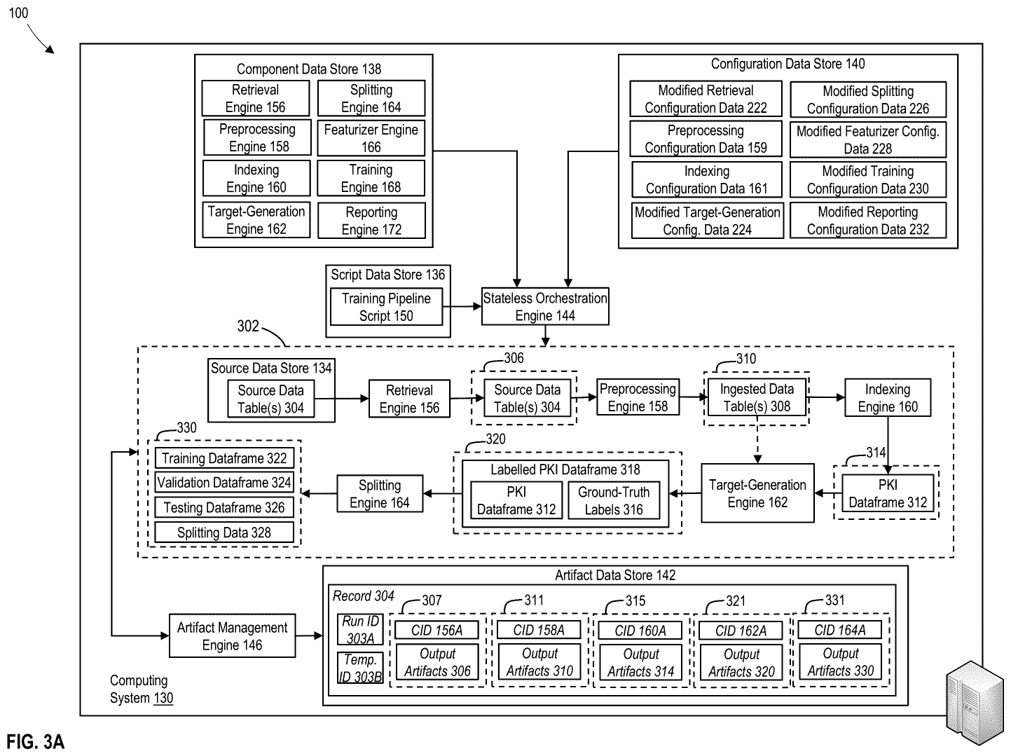

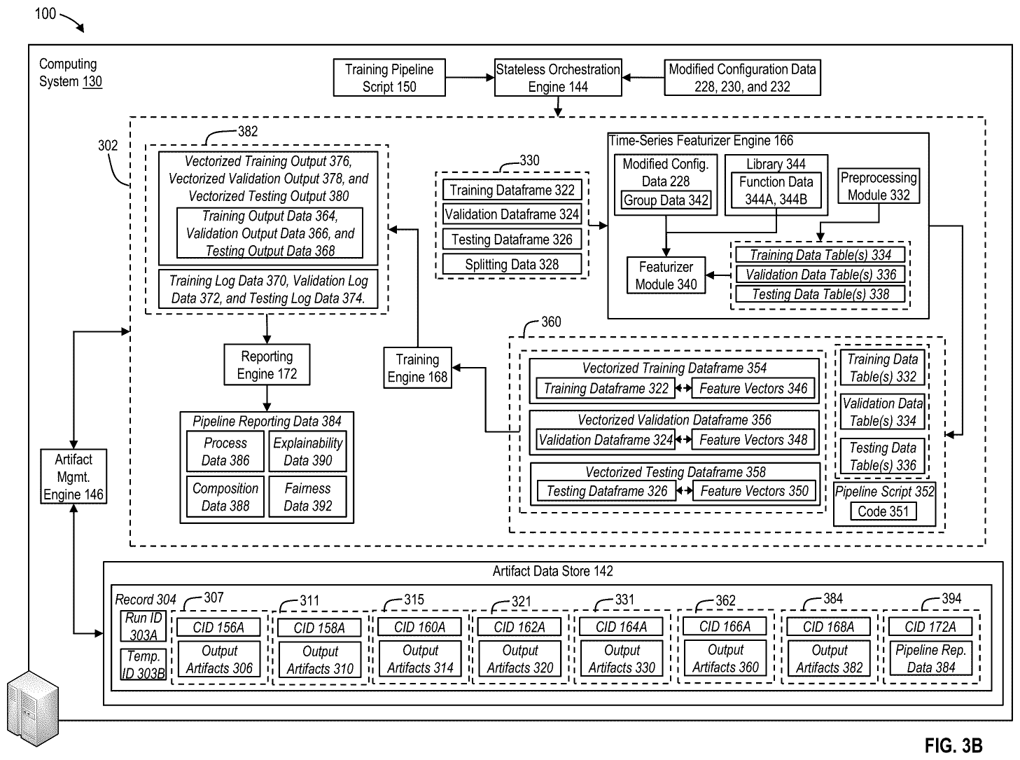

Referring to FIG. 3A, the one or more processors of computing system 130 may execute orchestration engine 144, which may access script data store 136 and obtain training pipeline script 150. As described herein, training pipeline script 150 may specify the execution flow of the default training pipeline (e.g., an order of sequential execution of each of the application engines within the default training pipeline) and may include, for each of the sequentially executed application engines, data identifying corresponding elements of engine-specific configuration data, one or more input artifacts ingested by the sequentially executed application engine, and additionally, or alternatively, one or more output artifacts generated by the sequentially executed application engines. By way of example, the default training pipeline may include retrieval engine 156, preprocessing engine 158, indexing engine 160, target-generation engine 162, time-series splitting engine 164, time-series featurizer engine 166, training engine 168, and reporting engine 172, which may be executed sequentially by the one or more processors in accordance with the execution flow of the default training pipeline.

In some instances, executed orchestration engine 144 may trigger an execution of training pipeline script 150 by the one or more processors of computing system 130, which may establish the default training pipeline, e.g., default training pipeline 302. Upon execution of training pipeline script 150, and establishment of default training pipeline 302, executed orchestration engine 144 may generate a unique, alphanumeric identifier, e.g., run identifier 303A, for a current implementation, or “run,” of default training pipeline 302, and executed orchestration engine 144 may provision run identifier 303A to artifact management engine 146, e.g., via a corresponding programmatic interface, such as an artifact application programming interface (API). Upon execution by the one or more processors of computing system 130, artifact management engine 146 may perform operations that, based on run identifier 303A, associate a data record 304 of artifact data store 142 with the current run of default training pipeline 302, and that store run identifier 303A within data record 304 along with a temporal identifier 303B indicative of a date om which executed orchestration engine 144 established default training pipeline 302 (e.g., on Oct. Jun. 1, 2024)

As described herein, upon execution by the one or more processors of computing system 130, each of retrieval engine 156, preprocessing engine 158, indexing engine 160, target-generation engine 162, time-series splitting engine 164, time-series featurizer engine 166, training engine 168, and reporting engine 172 may ingest one or more input artifacts and corresponding elements of configuration data specified within executed training pipeline script 150, and may generate one or more output artifacts. In some instances, executed artifact management engine 146 may obtain the output artifacts generated by corresponding ones of executed retrieval engine 156, preprocessing engine 158, indexing engine 160, target-generation engine 162, time-series splitting engine 164, time-series featurizer engine 166, training engine 168, and reporting engine 172, and store the obtained output artifacts within portions of data record 304, e.g., in conjunction within a unique, alphanumeric component identifier of a corresponding one of the executed application engines.

Further, in some instances, executed artifact management engine 146 may also maintain, in conjunction with the component identifier and corresponding output artifacts within data record 304, data characterizing input artifacts ingested by one, or more, of executed retrieval engine 156, preprocessing engine 158, indexing engine 160, target-generation engine 162, time-series splitting engine 164, time-series featurizer engine 166, training engine 168, and reporting engine 172. The inclusion of the data characterizing the input artifacts ingested by a corresponding one of these executed application engines within default training pipeline 302, and the association of the data characterizing the ingested input artifacts with the corresponding component identifier and run identifier 303A, may establish an artifact lineage that facilitates an audit of a provenance of an artifact ingested by the corresponding one of the executed application engines during the current implementation of run of default training pipeline 302 (e.g., associated with run identifier 303A), and recursive tracking of the generation or ingestion of that artifact across the current run of default training pipeline 302 (e.g., associated with run identifier 303A) and one or more prior runs of default training pipeline 302 (or of the default inferencing and target-generation pipelines described herein).

Referring back to FIG. 3A, executed training pipeline script 150 may trigger an execution of retrieval engine 156 by the one or more one or more processors of computing system 130, and orchestration engine 144 may provision one or more the elements of modified retrieval configuration data 222 to a programmatic interface associated with executed retrieval engine 156 (e.g., as input artifacts). In some instances, the programmatic interface may perform any of the exemplary processes described herein to establish a consistency of the ingested input artifacts with the engine- and pipeline-specific operational constraints imposed on executed retrieval engine 156. Based on an established consistency of the input artifacts with the imposed engine- and pipeline-specific operational constraints, executed retrieval engine 156 may obtain, from the elements of modified retrieval configuration data 222, the unique identifier of each of the one or more source data tables, the primary key or composite primary key of each of the source data tables, and the network address of an accessible data repository that maintains each of the source data tables, such as, but not limited to, source data store 134. Executed retrieval engine 156 may access source data store 134, and obtain one or more of source data table(s) 304 associated with the particular use-case, based on the obtained identifiers of the source data tables and on the network address of source data store 134.

In some instances, executed retrieval engine 156 may perform operations that provision source data table(s) 304, or an identifier of source data table(s) 304 (e.g., an alphanumeric file name or a file path, etc.) to executed artifact management engine 146, e.g., as output artifacts 306 of executed retrieval engine 156. Executed artifact management engine 146 may receive each of output artifacts 306 via the artifact API, and may package each of output artifacts 306 into a corresponding portion of retrieval artifact data 307, along with a unique, alphanumeric component identifier 156A of executed retrieval engine 156, and executed artifact management engine 146 may store retrieval artifact data 307 within a corresponding portion of artifact data store 142, e.g., within data record 304 associated with default training pipeline 302 and run identifier 303A. Further, although not illustrated in FIG. 3A, executed artifact management engine 146 may also package, into a corresponding portion of retrieval artifact data 307, additional data identifying and characterizing one or more of the input artifacts ingested by executed retrieval engine 156, such as, but not limited to, the elements of modified retrieval configuration data 222.

Further, and in accordance with default training pipeline 302, executed retrieval engine 156 may provide output artifacts 306, including source data table(s) 304, as inputs to preprocessing engine 158 executed by the one or more processors of computing system 130, and executed orchestration engine 144 may provision one or more of the elements of preprocessing configuration data 159 maintained within configuration data store 140 to executed preprocessing engine 158, e.g., in accordance with executed training pipeline script 150. A programmatic interface associated with executed preprocessing engine 158 may, for example, ingest each of source data table(s) 304 and the elements of preprocessing configuration data 159 (e.g., as corresponding input artifacts), and may perform any of the exemplary processes described herein to establish a consistency of the corresponding input artifacts with the engine- and pipeline-specific operational constraints imposed on executed preprocessing engine 158.

Based on an established consistency of the input artifacts with the imposed engine- and pipeline-specific operational constraints, executed preprocessing engine 158 may perform operations that apply each of the default preprocessing operations to corresponding ones of source data table(s) 304 in accordance with the elements of preprocessing configuration data 159 (e.g., through an execution or invocation of each of the helper scripts within the namespace of executed preprocessing engine 158, etc.). Examples of these default preprocessing operations may include, but are not limited to, a default temporal or user-specific filtration operation, a default table flattening or de-normalizing operation, and a default table joining operation (e.g., an inner- or outer-join operations, etc.). Further, and based on the application of each of the default preprocessing operations to source data table(s) 304, executed preprocessing engine 158 may also generate ingested data table(s) 308 having identifiers, and structures or formats, consistent with the default identifiers, and default structures or formats, specified within the elements of preprocessing configuration data 159.

Executed preprocessing engine 158 may perform operations that provision ingested data table(s) 308 to executed artifact management engine 146, e.g., as output artifacts 310 of executed preprocessing engine 158. In some instances, executed artifact management engine 146 may receive each of output artifacts 310 via the artifact API, may package each of output artifacts 310 into a corresponding portion of preprocessing artifact data 311, along with a unique, alphanumeric, component identifier 158A of executed preprocessing engine 158, and may store preprocessing artifact data 311 within a corresponding portion of artifact data store 142, e.g., within data record 304 associated with default training pipeline 302 and run identifier 303A. Further, although not illustrated in FIG. 3A, executed artifact management engine 146 may also package, into a corresponding portion of preprocessing artifact data 311, additional data identifying and characterizing the input artifacts ingested by executed preprocessing engine 158, such as, but not limited to, the elements of preprocessing configuration data 159 and source data table(s) 304 (or the corresponding identifiers, etc.).

Further, and in accordance with default training pipeline 302, executed preprocessing engine 158 may provide output artifacts 310, including ingested data table(s) 310, as inputs to indexing engine 160 executed by the one or more processors of computing system 130, and executed orchestration engine 144 may provision one or more elements of indexing configuration data 161 maintained within configuration data store 140 to executed indexing engine 160. As described herein, the elements of indexing configuration data 161 may include, among other things, an identifier of each of the ingested data table(s) 308, the primary key or composite primary key of each of each of the ingested data table(s) 308, data characterizing a structure, format, or storage location of an element of output artifact data generated by executed indexing engine 160, such as the public key infrastructure (PKI) dataframe described herein, and one or more constraints imposed on the element of output artifact data, such as, but not limited to, the uniqueness constraints imposed on the generated PKI dataframe.

In some instances, a programmatic interface associated with executed indexing engine 160 may receive ingested data table(s) 310 and the elements of indexing configuration data 161 (e.g., as corresponding input artifacts), and may perform any of the exemplary processes described herein to establish a consistency of the corresponding input artifacts with the engine- and pipeline-specific operational constraints imposed on executed indexing engine 160. Based on an established consistency of the input artifacts with the imposed engine- and pipeline-specific operational constraints, executed indexing engine 160 may perform operations, consistent with the elements of indexing configuration data 161, that access each of ingested data table(s) 308, select one or more columns from each of the each of ingested data table(s) 308 that are consistent with the corresponding primary key (or composite primary key), and generate a dataframe, e.g., PKI dataframe 312, that includes the entries of each of the selected columns.

PKI dataframe 312 may, for example, include a plurality of discrete rows populated with corresponding ones of the entries of each of the selected columns, e.g., the values of corresponding ones of the primary keys (or composite primary keys) obtained from each of ingested data table(s) 308. Examples of these primary keys (or composite primary keys) may include, but are not limited to, a unique, alphanumeric identifier assigned to corresponding users by the organization or enterprise, and temporal data, such as a timestamp, associated with a corresponding one of ingested data table(s) 308. In some instances, the entries maintained within PKI dataframe 312 may represent a base population for one or of the exemplary target-generation, feature-generation, and adaptive training processes performed by the one or more processors of computing system 130 within default training pipeline 302 (e.g., in accordance with executed training pipeline script 150) and further, the entries maintained within PKI dataframe 312 may establish an index set for ingested data table(s) 308 subject to one, or more, column-specific uniqueness constraints, such as, but not limited to, a SQL UNIQUE constraint.

Executed indexing engine 160 may perform operations that provision PKI dataframe 312 to executed artifact management engine 146, e.g., as an output artifact 314 of executed indexing engine 160. In some instances, executed artifact management engine 146 may receive output artifact 314 via the artifact API, and may package output artifacts 314 into a corresponding portion of indexing artifact data 315, along with a unique component identifier 160A of executed indexing engine 160, and that store indexing artifact data 315 within a corresponding portion of artifact data store 142, e.g., within data record 304 associated with default training pipeline 302 and run identifier 303A. Further, although not illustrated in FIG. 3A, executed artifact management engine 146 may also package, into a corresponding portion of indexing artifact data 315, additional data identifying and characterizing one or more of the input artifacts ingested by executed indexing engine 160, such as, but not limited to, ingested data table(s) 308 and the elements of indexing configuration data 161.

Further, and in accordance with default training pipeline 302, executed indexing engine 160 may provide output artifact 314, including PKI dataframe 312 as inputs to target-generation engine 162 executed by the one or more processors of computing system 130, and executed orchestration engine 144 may provision the elements of modified target-generation configuration data 224 maintained within configuration data store 140 to target-generation engine 162. Based on programmatic communications within executed artifact management engine 146, executed orchestration engine 144 may also provision output artifacts 310, including ingested data table(s) 308, as further inputs to target-generation engine 162. As described herein, the elements of modified target-generation configuration data 224 may include, among other things, data specifying a logic and a value of one or more corresponding parameters for constructing the ground-truth label for each row of PKI dataframe 312, which may be customized to reflect the particular use-case of interest to developer 103 using any of the exemplary processes described herein.

By way of example, the ground-truth labels may support an adaptive training of a forward-in-time machine-learning process (such as, but not limited to, a gradient-boosted, decision-tree process, e.g., an XGBoost process), which may facilitate a prediction, at a prediction date, of a likelihood of an occurrence, or a non-occurrence, of a targeted event during a future, target temporal interval. In some instances, described herein, the future, target temporal interval may be separated from the prediction date by a corresponding buffer interval. To facilitate the generation of the ground-truth labels by executed target-generation engine 162, the elements of modified target-generation configuration data 224 may include values specifying a duration of the future, target temporal interval (and in some instances, a duration of the corresponding buffer interval), along with logic that defines the corresponding target event and that facilitates the detection of the corresponding target event when applied to elements of ingested data table(s) 308. As described herein, the specified logic and the specified values may each be customized to reflect the particular use-case of interest to developer 103 using any of the exemplary processes described herein.

In some instances, a programmatic interface associated with executed target-generation engine 162 may receive each of ingested data table(s) 308, PKI dataframe 312, and the elements of modified target-generation configuration data 224 (e.g., as input artifacts), and may perform any of the exemplary processes described herein to establish a consistency of the corresponding input artifacts with the engine- and pipeline-specific operational constraints imposed on executed target-generation engine 162. Based on an established consistency of the input artifacts with the imposed engine- and pipeline-specific operational constraints, executed target-generation engine 162 may perform operations that, consistent with the elements of modified target-generation configuration data 224, generate a corresponding one of ground-truth labels 316 for each row of PKI dataframe 312. By way of example, each row of PKI dataframe 312 may be associated with, among other things, a corresponding user (e.g., via a user identifier, etc.) and corresponding temporal data (e.g., a timestamp, etc.), which may establish the prediction date for the generation of the corresponding one of ground-truth labels 316.

By way of example, executed target-generation engine 162 may perform operations that, for each row of PKI dataframe 312, obtain a user identifier associated with a corresponding user (e.g., an alphanumeric customer identifier, as described herein) from each row of PKI dataframe 312, access portions of ingested data table(s) 308 associated with the corresponding customer based on the customer identifier, and apply the logic maintained within the elements of modified target-generation configuration data 224 to the accessed portions of ingested data table(s) 308 in accordance with the specified parameter values. Based on the application of the logic to the accessed portions of ingested data table(s) 308, executed target-generation engine 162 may determine the occurrence, or non-occurrence, of the corresponding targeted event involving each of the corresponding customers during the future, the target temporal interval, which may be disposed subsequent to the prediction date. Further, executed target-generation engine 162 may also may generate, for each row of PKI dataframe 312, the corresponding one of ground-truth labels 316 indicative of a determined occurrence of the targeted event involving the corresponding customer during the future, prediction date the target temporal interval (e.g., a “positive” target associated with a ground-truth label of unity) or alternatively, a determined non-occurrence of the corresponding targeted event involving the corresponding customer during the future, the target temporal interval (e.g., a “negative” target associated with a ground-truth label of zero).

Executed target-generation engine 162 may also append each of generated ground-truth labels 316 to the corresponding row of PKI dataframe 312, and generate elements of a labelled PKI dataframe 318 that include each row of PKI dataframe 312 and the appended one of ground-truth labels 316. In some instances, executed target-generation engine 162 may provision labelled PKI dataframe 318 to executed artifact management engine 146, e.g., as output artifacts 320, and executed artifact management engine 146 may receive each of output artifacts 320 via the artifact API. Executed artifact management engine 146 may package each of output artifacts 320 into a corresponding portion of target-generation artifact data 321, along with a unique component identifier 162A of executed target-generation engine 162, and may store target-generation artifact data 321 within a corresponding portion of artifact data store 142, e.g., within data record 304 associated with default training pipeline 302 and run identifier 303A. Further, although not illustrated in FIG. 3A, executed artifact management engine 146 may also package, into a corresponding portion of target-generation artifact data 321, additional data identifying and characterizing one or more of the input artifacts ingested by executed target-generation engine 162, such as, but not limited to, ingested data table(s) 308, PKI dataframe 312, and the elements of modified target-generation configuration data 224.

Executed target-generation engine 162 may provide output artifacts 320, including labelled PKI dataframe 318 (e.g., maintaining each the rows of PKI dataframe 312 and the appended ones of ground-truth labels 316) as inputs to time-series splitting engine 164 executed by the one or more processors of computing system 130. Additionally, in some instances, executed orchestration engine 144 may provision one or more elements of modified splitting configuration data 226 maintained within configuration data store 140 to executed time-series splitting engine 164 in accordance with default training pipeline 302.

As described herein, the elements of modified splitting configuration data 226 may include, among other things, an identifier of labelled PKI dataframe 318 (e.g., which may be ingested by executed time-series splitting engine 164 as an input artifact) and an identifier of one or more primary keys of labelled PKI dataframe 318, such as, but not limited to, an identifier of a column of labelled PKI dataframe 318 that maintains unique, alphanumeric user identifiers or temporal data, e.g., timestamps. In some instances, the identifier of labelled PKI dataframe 318 may include, but is not limited to, an alphanumeric file name or a file path of labelled PKI dataframe 318 within artifact data store 142. Further, and as described herein, the elements of modified splitting configuration data 226 may include a value of one or more parameters of the default, time-series splitting process that include, but are not limited to, a temporal splitting point (e.g., Jan. 1, 2023, etc.) and data specifying populations of in-sample and out-partitions of the labelled, indexed dataframe ingested by executed time-series splitting engine 164. In some instances, the data specifying the populations of in-sample and out-partitions of the labelled, indexed dataframe may include, but is not limited to, a first percentage of the rows of a labelled, indexed dataframe that represent “in-sample” rows and as such, an “in-sample” partition of the labelled, indexed dataframe, and a second percentage of the rows of the labelled, indexed dataframe that represent “out-of-sample” rows and as such, an “out-of-sample” partition of the labelled, indexed dataframe. Examples of the first predetermined percentage include, include, but are not limited to, 50%, 75%, or 80%, and corresponding examples of the second predetermined percentage include, but are not limited to, 50%, 25%, or 20% (e.g., a difference between 100% and the corresponding first predetermined percentage).

A programmatic interface associated with executed time-series splitting engine 164 may receive labelled PKI dataframe 318 and the elements of modified splitting configuration data 226 (e.g., as corresponding input artifacts), and may perform any of the exemplary processes described herein to establish a consistency of the corresponding input artifacts with the engine- and pipeline-specific operational constraints imposed on executed time-series splitting engine 164. Based on an established consistency of the input artifacts with the imposed engine- and pipeline-specific operational constraints, executed time-series splitting engine 164 may perform operations that, consistent with the elements of modified splitting configuration data 226, partition labelled PKI dataframe 318 into a plurality of partitioned dataframes suitable for training, validating, and testing the forward-in-time machine-learning process within default training pipeline 302. As described herein, each of the partitioned dataframes may include a partition-specific subset of the rows of labelled PKI dataframe 318, each of which include a corresponding row of PKI dataframe 312 and the appended one of ground-truth labels 316.

By way of example, and based the elements of modified splitting configuration data 226, executed time-series splitting engine 164 may apply the default time-series splitting process to labelled PKI dataframe 318, and based on the application of the default time-series splitting process to the rows of labelled PKI dataframe 318, executed time-series splitting engine 164 may partition the rows of labelled PKI dataframe 318 into a distinct training dataframe 322, a distinct validation dataframe 324, and a distinct testing dataframe 326 appropriate to train, validate, and subsequently test the forward-in-time machine-learning process (e.g., the gradient-boosted, decision-tree process, such as the XGBoost process) using any of the exemplary processes described herein. Each of the rows of labelled PKI dataframe 318 may include, among other things, a unique, alphanumeric user identifier and an element of temporal data, such as a corresponding timestamp. In some instances, and based on a comparison between the corresponding timestamp and the temporal splitting point (e.g., Jan. 1, 2023) maintained within the elements of modified splitting configuration data 226, executed time-series splitting engine 164 may assign each of the rows of labelled PKI dataframe 318 to an intermediate, in-time partitioned dataframe (e.g., based on a determination that the corresponding timestamp is disposed prior to, or concurrent with, the temporal splitting point of Jan. 1, 2023) or to an intermediate, out-of-time partitioned dataframe (e.g., based on a determination that the corresponding timestamp is disposed subsequent to the temporal splitting point of Jan. 1, 2023).

Executed time-series splitting engine 164 may also perform operations, consistent with the elements of modified splitting configuration data 226, that further partition the intermediate, in-time partitioned dataframe into corresponding ones of an in-time, and in-sample, partitioned dataframe and an in-time, and out-of-sample, partitioned dataframe. For instance, and as described herein, the elements of modified splitting configuration data 226 may include sampling data characterizing populations of the in-sample and out-partitions for the default time-series splitting process (e.g., the first percentage of the rows of a temporally partitioned dataframe represent “in-sample” rows, and the second percentage of the rows of the temporally partitioned dataframe represent “out-of-sample” rows, etc.). Based on the elements of sampling data, executed time-series splitting engine 164 may allocate, to the in-time and in-sample partitioned dataframe, the first predetermined percentage of the rows of labelled PKI dataframe 318 assigned to the intermediate, in-time partitioned dataframe, and may allocate to the in-time and out-of-sample partitioned dataframe, the second predetermined percentage of the rows of labelled PKI dataframe 318 assigned to the intermediate, in-time partitioned dataframe. In some instances, the rows of labelled PKI dataframe 318 allocated to the in-time and in-sample partitioned dataframe may establish training dataframe 322, the rows of labelled PKI dataframe 318 allocated to the in-time and out-of-sample partitioned dataframe may establish validation dataframe 324, and the rows of labelled PKI dataframe 318 assigned to the intermediate, out-of-time partitioned dataframe (e.g., including both in-sample and out-of-sample rows) may establish testing dataframe 326.

Further, and as described herein, the elements of modified splitting configuration data 226 may include additional data that, when processed by executed time-series splitting engine 164, causes executed time-series splitting engine 164 to implement target-stratified sampling operations during, or prior to, the application of the default, time-series splitting processes described herein to labelled PKI dataframe 318 (e.g., an alphanumeric stratification flag, such as “true,” etc.) or alternatively, to apply the default, time-series splitting processes described herein to labelled PKI dataframe 318 without target-stratified sampling (e.g., an additional alphanumeric stratification flag, such as “false,” etc.). In some instances, executed time-series splitting engine 164 may parse the elements of modified splitting configuration data 226, and may obtain the alphanumeric stratification flag from the elements of modified splitting configuration data 226. Based on a value of the alphanumeric stratification flag (e.g., a value of “true,” etc.), executed time-series splitting engine 164 may perform operations that implement the target-stratified sampling operations in accordance with the specified, stratification parameters values (e.g., by calling or invoking the corresponding helper scripts specified within the elements of modified splitting configuration data 226), which may stratify the rows of labelled PKI dataframe 318 based on corresponding ones of ground-truth labels 316 prior to, or during, the application of the default, time-series splitting process to the labelled PKI dataframe 318 described herein.

In some instances, executed time-series splitting engine 164 may perform operations that provision training dataframe 322, validation dataframe 324, and testing dataframe 326, and elements of splitting data 328 that characterize the temporal splitting point and the in-sample and out-of-sample populations of the default time-series splitting process, to executed artifact management engine 146, e.g., as output artifacts 330. In some instances, executed artifact management engine 146 may receive each of output artifacts 330 via the artifact API, and may perform operations that package each of output artifacts 330 into a corresponding portion of splitting artifact data 331, along with a unique component identifier 164A of executed time-series splitting engine 164, and that store splitting artifact data 331 within a corresponding portion of artifact data store 142, e.g., within data record 304 associated with default training pipeline 302 and run identifier 303A. Further, although not illustrated in FIG. 3A, executed artifact management engine 146 may also package, into a corresponding portion of splitting artifact data 331, additional data identifying and characterizing one or more of the input artifacts ingested by executed time-series splitting engine 164, such as, but not limited to, labelled PKI dataframe 318 the elements of modified splitting configuration data 226.

In accordance with default training pipeline 302, executed time-series splitting engine 164 may provide output artifacts 330, including training dataframe 322, validation dataframe 324, and testing dataframe 326, and the elements of splitting data 328, as inputs to time-series featurizer engine 166 executed by the one or more processors of computing system 130. Further, within the default training pipeline 302, executed orchestration engine 144 may provision the elements of modified featurizer configuration data 228 maintained within configuration data store 140 to executed time-series featurizer engine 166, and based on programmatic communications with executed artifact management engine 146, may provision ingested data table(s) 308 maintained within data record 304 of artifact data store 142 to executed time-series featurizer engine 166.

In some instances, a programmatic interface of executed time-series featurizer engine 166 may receive training dataframe 322, validation dataframe 324, testing dataframe 326, the elements of splitting data 328, each of ingested data table(s) 308, and the elements of modified featurizer configuration data 228 (e.g., as corresponding input artifacts), and may perform any of the exemplary processes described herein to establish a consistency of the corresponding input artifacts with the engine- and pipeline-specific operational constraints imposed on executed time-series featurizer engine 166. Based on an established consistency of the input artifacts with the imposed engine- and pipeline-specific operational constraints, executed time-series featurizer engine 166 may perform one or more of the exemplary processes described herein that, consistent with the elements of modified featurizer configuration data 228, generate a feature vector of corresponding feature values for each row of training dataframe 322, validation dataframe 324, and testing dataframe 326 based on, among other things, an application of the group-specific aggregation operations and the group-specific post-processing operations to processed partitions of ingested data table(s) 308 associated with each of training dataframe 322, validation dataframe 324, and testing dataframe 326 during corresponding ones of the group-specific, prior lookback intervals. The feature vectors associated with the rows of training dataframe 322, validation dataframe 324, and testing dataframe 326 may, in some instances, be ingested by one or more additional executable application engines within default training pipeline 302 (e.g., training engine 168), and may facilitate an adaptive training of the forward-in-time machine-learning process (e.g., the gradient-boosted, decision-tree process described herein, such as the XGBoost process) without the data leakage, and associated process overfitting, associated with many computer-implemented techniques for training forward-in-time machine-learning processes.

By way of example, and within default training pipeline 302, a preprocessing module 332 of executed time-series featurizer engine 166 may obtain each of ingested data table(s) 308, and may apply sequentially one or more of the preprocessing operations to selected ones of ingested data table(s) 308 in accordance with the elements of modified featurizer configuration data 228. Examples of the specified preprocessing operations may include, but are not limited to, one or more temporal filtration operations, one or more user- or data-specific filtration operations, and one or more join operations (e.g., an inner- or outer-join operations, etc.) applied to a subset of ingested data table(s) 308. Further, in applying the join operation to the subset of the subset of ingested data table(s) 308, executed time-series featurizer engine 166 may perform operations, described herein, that establish a presence or absence within each of subset of ingested data table(s) 308 of columns associated with each of the primary keys within labelled PKI dataframe 318 (e.g., the customer identifier and timestamp described herein, etc.). In some instances, and based on an established absence of a column associated with one of the primary keys within at least one of ingested data table(s) 308 subject to the join operation, executed preprocessing module 332 may perform operations that augment the at least one of ingested data table(s) 308 to include an additional column associated with the absent primary key, e.g., based on an application of a “fuzzy join” operation based on fuzzy string matching.

Executed preprocessing module 332 may generate one or more preprocessed data tables based on an application of the preprocessing operations to corresponding ones of ingested data table(s) 308 in accordance with the modified elements of featurizer configuration data 228, and may perform operations, consistent with the splitting data 328 and with the elements of featurizer configuration data 228, that partition each of the preprocessed source data tables into a corresponding partition associated with training dataframe 322 (e.g., a corresponding one of training data table(s) 334), a corresponding partition associated with validation dataframe 324 (e.g., a corresponding one of validation data table(s) 336), and a corresponding partition associated with testing dataframe 326 (e.g., a corresponding one of testing data table(s) 338). As described herein, each row of training dataframe 322, validation dataframe 324, and testing dataframe 326 may include values of one or more primary keys of PKI dataframe 312 (e.g., user identifier, timestamp, etc.) and a corresponding one of ground-truth labels 316, and in some instances, each row of training dataframe 322, validation dataframe 324, and testing dataframe 326 may be associated with a corresponding user and a corresponding temporal interval.

Based on the values of the one or more primary keys, executed time-series featurizer engine 166 may perform operations, consistent with the elements of modified featurizer configuration data 228, that map subsets of the rows of each of the preprocessed source tables to corresponding ones of the training, validation, and testing partitions, and assign the mapped subsets of the rows to corresponding ones of training data table(s) 334, validation data table(s) 336, and testing data table(s) 338. In some examples, the rows of the preprocessed data tables assigned to training data table(s) 334, validation data table(s) 336, and testing data table(s) 338 may facilitate a generation, using any of the exemplary processes described herein, of a feature vector of specified, or adaptively determined, feature values for each row of a corresponding one of training dataframe 322, validation dataframe 324, and testing dataframe 326. Further, in some instances, each of, or a subset of the operations that facilitate mapping of the subsets of the rows of each of the preprocessed source tables to corresponding ones of the training partition, the validation partition, and the testing partition, and the assignment of the mapped subsets of the rows to corresponding ones of training data table(s) 334, validation data table(s) 336, and testing data table(s) 338, such operations may be specified within the elements of modified featurizer configuration data 228 (e.g., in scripts callable in a namespace of executed time-series featurizer engine 166), which may customized to reflect the particular use-case of interest to developer 103 using any of the exemplary processes described herein.

In some instances, the elements of modified featurizer configuration data 228 may also identify and specify one or more feature groups of discrete features, which may be declared by developer 103 using any of the exemplary processes described herein. By way of example, the discrete features associated with a corresponding one of the feature group may each be associated with, and generated by, an application of a corresponding, group-specific aggregation operation to corresponding elements of training, validation, or testing data across a corresponding, group-specific, prior lookback interval. Further, in some instances, the discrete features associated with the corresponding feature group may also be associated with a corresponding, group-specific post-processing operation, which executed time-series featurizer engine 166 may apply to the outputs of the group-specific aggregation operation using any of the exemplary processes described herein. Through declaration of each of the feature groups, and the specification of the one or more discrete features associated with the each of the declared feature groups (and the corresponding, group-specific aggregation operation, the corresponding, group-specific, prior lookback interval, and/or the corresponding, group-specific post-processing operation), developer 103 may establish a sequential order of feature values within a corresponding feature vector for each row within training dataframe 322, validation dataframe 324, and testing dataframe 326, and each of the feature groups may be associated with at least one of training data table(s) 334, at least one of validation data table(s) 336, and at least one of testing data table(s) 338, e.g., as specified within the elements of modified featurizer configuration data 228 associated with corresponding ones of the feature groups.

By way of example, and for each of the declared feature groups, the elements of modified featurizer configuration data 228 may include, among other things, a corresponding group identifier (e.g., an alphanumeric group name, etc.), an identifier of the corresponding ones of training data table(s) 334, validation data table(s) 336, and testing data table(s) associated with the declared feature group, a feature identifier of each of the discrete features associated with the declared feature groups, and an identifier of a column within the corresponding ones of training data table(s) 334, validation data table(s) 336, and testing data table(s) that maintains temporal data characterizing each of the customer-specific rows (e.g., an alphanumeric column name, etc.). Further, and as described herein, the elements of modified featurizer configuration data 228 may include, for each of the declared feature groups, a duration of a group-specific, prior lookback interval (e.g., temporal boundaries of the group-specific, prior lookback interval, a number of days, etc.), an identifier of a group-specific aggregation operation (e.g., an alphanumeric identifier of an aggregation function, etc.), an identifier of a group-specific post-processing operation (e.g., an alphanumeric identifier of an post-processing function, etc.), and a value of one or more parameters of the group-specific aggregation operation and/or the group-specific post-processing operation.

As described herein, the group-specific aggregation operation may include a default aggregation operation, such as, but not limited to, an operation that computes an average value of a parameter across the corresponding prior lookback interval (e.g., an arithmetic mean, a geometric mean, etc.), an operation that determines a maximum or a minimum value of a parameter across the corresponding prior lookback interval, and an operation that determines a value of the parameter at a particular point within the corresponding prior lookback interval (e.g., the value of the parameter at an end of the prior lookback interval, etc.). Further, examples of the group-specific post-processing operations may include, but are not limited to, a one-hot-encoding operation, a label-encoding operation, a scaling operation (e.g., based on minimum, maximum, or average values, etc.), or other statistical processes applied to the output of the group-specific aggregation operation. In some instances, corresponding ones of the aggregation and/or post-processing operations may be specified within the elements of modified featurizer configuration data 228 as helper scripts capable of invocation within the namespace of executed time-series featurizer engine 166 and arguments or configuration parameters that facilitate the invocation of corresponding ones of the helper scripts.

Referring to FIG. 3B, executed time-series featurizer engine 166 may perform any of the exemplary processes described herein to: (i) generate a corresponding feature value for each of the associated, discrete features based on an application of the group-specific aggregation operation to feature-specific elements within each row of training data table(s) 334 (e.g., on a row-by-row basis) during the group-specific, prior lookback interval, and in some instances, based on an application of the group-specific post-processing operation to the outputs of the group-specific aggregation operation; and (ii) package the determined feature values associated with each row of training data table(s) 334 into a sequential position with a feature vector associated with the corresponding row of training dataframe 322, e.g., a corresponding one of feature vectors 346. Further, executed time-series featurizer engine 166 may perform any of the exemplary processes described herein to generate a feature vector associated with each row of validation dataframe 324 (e.g., a corresponding one of feature vectors 348) and a feature vector associated with each row of testing dataframe 326 (e.g., a corresponding one of feature vectors 350). In some instances, feature-specific elements may, for example, include elements of confidential, customer data maintained within a corresponding, feature-specific column of each of training data table(s) 334, validation data table(s) 336, and testing data table(s) 338, and for each of the declared feature groups, the elements of modified featurizer configuration data 228 may also associate each of the feature identifiers with a corresponding identifier of the feature-specific column, such as, but not limited to, an alphanumeric column name.

By way of example, a featurizer module 340 of executed time-series featurizer engine 166 may access modified featurizer configuration data 228, e.g., as ingested by executed time-series featurizer engine 166. For each of the declared feature groups, executed featurizer module 340 may obtain, from a corresponding portion of modified featurizer configuration data 228, the table identifier of the corresponding ones of training data table(s) 334, validation data table(s) 336, and testing data table(s) associated with the declared feature group, the column identifier of a column within each of training data table(s) 334, validation data table(s) 336, and testing data table(s) that maintains the temporal data (e.g., an alphanumeric column name, etc.), the feature identifier of each of the discrete features associated with the declared feature group, and the column identifier of the feature-specific column of training data table(s) 334, validation data table(s) 336, and testing data table(s) 338 associated with each of the discrete features.

Further, and for each of the declared feature groups, executed featurizer module 340 may also obtain, from the corresponding portion of modified featurizer configuration data 228, data specifying the duration of a group-specific, prior lookback interval (e.g., the temporal boundaries, etc.) associated with the declared feature groups, the identifier of a group-specific aggregation operation associated with each of the declared feature groups, and in some instances, the data includes the identifier of a group-specific post-processing operation associated with one or more of the declared feature groups. In some instances, and based on the elements of group-specific data obtained from the corresponding portions of modified featurizer configuration data 228, executed featurizer module 340 may perform one or more of the exemplary processes described herein to generate a feature vector of the feature values for each row within corresponding ones of training dataframe 322, validation dataframe 324, and testing dataframe 326, e.g., based on an application of corresponding group-specific aggregation operations, and in some instances, group-specific post-processing operations, to elements of feature-specific data maintained within subsets of rows of the training data table(s) 334, validation data table(s) 336, and testing data table(s) 338 having effective dates disposed within corresponding, group-specific specific prior lookback intervals. Each of the feature values may be associated with a corresponding one of the discrete features specified by the declared feature groups, and a sequential order of the feature values within the feature vector may be consistent with, and established by, a sequential order in which modified featurizer configuration data 228 maintains each of the discrete feature within the corresponding declared, and sequentially ordered, feature groups.

By way of example, executed featurizer module 340 may obtain, from a corresponding portion of modified featurizer configuration data 228, elements of group data 342 associated with an initial one of the declared feature groups specified within modified featurizer configuration data 228. By way of example, the initial one of the declared feature groups may include an alphanumeric identifier of the initial one of the declared feature groups, a table identifier of the corresponding ones of training data table(s) 334, validation data table(s) 336, and testing data table(s) associated with the initial one of the declared feature groups, and a column identifier of a column within each of training data table(s) 334, validation data table(s) 336, and testing data table(s) that maintains the temporal data (e.g., a column name of “effective_date”). Further, the elements of group data 342 may also include a feature identifier of each of the one or more discrete features associated with the initial one of the declared feature groups, and a column identifier of the feature-specific column of training data table(s) 334, validation data table(s) 336, and testing data table(s) 338 associated with each of the one or more discrete features. For instance, the one or more discrete features may include, but are not limited to, an average balance of a credit-card account, and the elements of group data 342 may include a corresponding feature identifier of the average balance of a credit-card account (e.g., an alphanumeric feature name, such as “avg_bal_cc,” etc.) and a column identifier of a feature-specific column of training data table(s) 334, validation data table(s) 336, and testing data table(s) 338 that maintains the balance of the credit card account (e.g., an alphanumeric column name, such as “cc_bal,” etc.).

Further, in some examples, the initial one of the declared feature groups may be associated with a group-specific, prior lookback interval of sixty days, a group-specific averaging operation that averages a daily balance of a credit-card account across the group-specific, prior lookback interval, and a group-specific post-processing operation that scales the output of the group-specific averaging operation in accordance with a maximum value across the sampled rows of training data table(s) 334, validation data table(s) 336, and testing data table(s). In some instances, the elements of group data 342 may include data that specifies the sixty-day duration of the group-specific, prior lookback interval, an alphanumeric identifier of the specified averaging operation (e.g., an alphanumeric function name, such as “avg,” etc.), and an alphanumeric identifier of the specified, post-processing scaling operation (e.g., an alphanumeric function name, such as “max-scaling,” etc.). The disclosed embodiments are not limited to these exemplary, group-specific features, columns identifiers, prior lookback intervals, and aggregation and post-processing operations, and in other instances, the initial one of the declared feature groups may include any additional, or alternate, group-specific features, columns identifiers, prior lookback intervals, and aggregation and post-processing operations (including an absence of any post-processing operations) that would be appropriate to the particular use-case of interest to developer 103.

Executed featurizer module 340 may also access a library 344 that maintains and characterizes one or more default (or previously customized) stateless aggregation and post-processing functions, such as, but not limited to, functions that, upon execution, perform exemplary aggregation and post-processing operations described herein. In some instances, library 344 may associate each of the default (or previously customized) stateless aggregation and post-processing function with a corresponding identifier (e.g., an alphanumeric function name, etc.), with corresponding input arguments and output data, and in some instances, with a value of one or more configuration parameters. In some instances, executed featurizer module 340 may obtain the alphanumeric function names of the specified averaging operation (e.g., “avg”) and the specified, post-processing scaling operation (e.g., “max-scaling”) from the elements of group data 342, and may perform operations that map the alphanumeric function names of the specified averaging and post-processing scaling operations to corresponding ones of the default (or previously customized) stateless aggregation and post-processing functions maintained within library 344, e.g., to a default averaging function and to a default scaling function, respectively.

Based on the mapping operations, executed featurizer module 340 may obtain, from library 344, elements of function data 344A associated the mapped, default averaging function and elements of function data 344B associated with the mapped, default scaling function. The elements of function data 344A and 344B may, for example, specify input arguments and output data associated with corresponding ones of the mapped, default averaging function and the mapped, default scaling function, and in some instances, a value of one or more configuration parameters of corresponding ones of the mapped, default averaging function and the mapped, default operation.

In some instances, based on the elements of function data 344A and 344B, executed featurizer module 340 perform operations, described herein, that generate a feature value for each of the discrete features associated with the initial one of the declared feature groups for each row of training dataframe 322, validation dataframe 324, and testing dataframe 326, based on: (i) an application of the group-specific aggregation function (e.g., the averaging operation described herein) to parameter values maintained within the rows of respective ones of training data table(s) 334, validation data table(s) 336, and testing data table(s) 338 in accordance with the elements of function data 344A; and (ii) an application of the group-specific post-processing function to each element of aggregated output in accordance with the elements of function data 344B.

As described herein, each row of training dataframe 322, validation dataframe 324, and testing dataframe 326 may include, among other things, a unique, alphanumeric customer identifier and elements of temporal data associated with the row, such as, but not limited to, a timestamp, which may correspond to the prediction date described herein. Further, each row of training data table(s) 334, validation data table(s) 336, and testing data table(s) 338 may maintain additional temporal data within a corresponding column (e.g., associated with column name “effective_date,” etc.), and the additional temporal data maintained within the corresponding column of each row of training data table(s) 334, validation data table(s) 336, and testing data table(s) 338 may represent an “effective date” characterizing the elements of data maintained within the row of training data table(s) 334, validation data table(s) 336, and testing data table(s) 338. In some instances, the timestamp (e.g., the prediction date) maintained within each row of training dataframe 322, validation dataframe 324, and testing dataframe 326 represent a temporal boundary for the sixty-date, prior lookback interval associated within the initial one of the declared feature groups, which may be established sixty days prior to the row-specific prediction date, and which may extend through, and include, the row-specific prediction date.

In some examples, for each row of training dataframe 322, validation dataframe 324, and testing dataframe 326, executed featurizer module 340 may identify the row-specific prediction date, establish a row-specific, sixty-date, prior lookback interval, and identify a subset of the rows of each of training data table(s) 334, validation data table(s) 336, and testing data table(s) 338 having effective dates disposed within the row-specific, sixty-date, prior lookback interval, e.g., which represent respective ones of a training subset, a validation subset, and a testing subset. Further, and for each row of training dataframe 322, validation dataframe 324, and testing dataframe 326, executed featurizer module 340 may also perform operations that generate a feature value for each of the discrete features associated with the initial one of the declared feature groups based on: (i) an application of the group-specific aggregation function (e.g., the averaging operation described herein) to parameter values maintained within the rows of respective ones of the training, validation, and testing subsets, and disposed within the corresponding one of the feature-specific columns, in accordance with the elements of function data 344A; and (ii) an application of the group-specific post-processing function to each element of the aggregated output (e.g., the scaling operation that scales the aggregated output based on a maximum value, etc.) in accordance with the elements of function data 344B.

For each row of training dataframe 322, executed featurizer module 340 to package the generated feature values associated with the initial one of the declared feature groups into corresponding, feature-specific positions within a row-specific one of feature vectors 346, which may be associated with training dataframe 322. Further, the executed featurizer module 340 may also perform operations that, for each row of validation dataframe 324, package the generated feature values associated with the initial one of the declared feature groups into corresponding, feature-specific positions within a row-specific one of feature vectors 348 (e.g., associated with validation dataframe 324), and that, for each row of testing dataframe 326, package the generated feature values associated with the initial one of the declared feature groups into corresponding, feature-specific positions within a row-specific one of feature vectors 350 (e.g., associated with testing dataframe 326). As described herein, a composition of feature vectors 346, 348, and 350, and a sequential order of the feature values within feature vectors 346, 348, and 350, may be consistent with, and established by, a sequential order in which modified featurizer configuration data 228 maintains each of the discrete features within the corresponding declared, and sequentially ordered, feature groups.

Further, and based on input data that includes, among other things, the elements of function data 344A and 344B (e.g., associated with the respective ones of the mapped, default averaging and scaling functions), the feature and table identifiers, the column identifier associated with the temporal data within training data table(s) 334, validation data table(s) 336, and testing data table(s) 338, the column identifier of each feature-specific column of training data table(s) 334, validation data table(s) 336, and testing data table(s) 338, and the duration of the group-specific, prior lookback interval (e.g., sixty days), executed featurizer module 340 may perform operations that generate elements of group-specific executable code 351 that, upon execution by the one or more processors of computing system 130, cause computing system 130 to perform any of the exemplary processes described herein to generate the feature value for each of the discrete features associated with the initial one of the declared feature groups for each row of training dataframe 322, validation dataframe 324, and testing dataframe 326, and to package the feature values generated for each row of training dataframe 322, validation dataframe 324, and testing dataframe 326 into row-specific ones of feature vectors 346, 348, and 350 (e.g., associated with respective ones of training dataframe 322, validation dataframe 324, and testing dataframe 326). For example, the elements of group-specific executable code 351 may be generated through an application, by executed featurizer module 340, of a generative artificial-intelligence process to all, or a selected portion, of the input data described herein, and in some instances, the elements of group-specific executable code 351 may be executed by featurizer module 340 to generate the feature values of the initial one of the declared feature groups during a future training run of default training pipeline 302, or during a future inferencing run of an inferencing pipeline.

In some instances, executed featurizer module 340 may obtain, from corresponding portions of modified featurizer configuration data 228, additional elements of group data associated with each of the additional, or alternate, ones of the declared feature groups specified within modified featurizer configuration data 228. As described herein, each of the additional elements of group data may include an alphanumeric identifier of a corresponding one of the additional, or alternate, declared feature groups, a table identifier of the corresponding ones of training data table(s) 334, validation data table(s) 336, and testing data table(s) associated with the additional, or alternate, declared feature group, and a column identifier of a column within each of training data table(s) 334, validation data table(s) 336, and testing data table(s) that maintains the temporal data. Further, each of the additional elements of group data may also include a feature identifier of each of the one or more additional discrete features associated with the additional, or alternate, declared feature group, and a column identifier of the feature-specific column of training data table(s) 334, validation data table(s) 336, and testing data table(s) 338 associated with each of the one or more additional discrete features.

In some instances, based on the additional elements of group data, executed featurizer module 340 may perform any of the exemplary processes described herein to generate, for each of the rows of training dataframe 322, validation dataframe 324, and testing dataframe 326, the one or more additional, discrete feature values associated with each of the additional, or alternate, declared feature groups, and to package corresponding ones of the one or more additional, discrete feature values into feature-specific, sequential positions within a corresponding, row-specific one of feature vectors 346, 348, and 350 (e.g., in accordance with the elements of modified featurizer configuration data 228). Further, although not illustrated in FIG. 3B, executed featurizer module 340 may perform any of the exemplary processes described herein to generate additional elements of group-specific executable code that, upon execution by the one or more processors of computing system 130, cause computing system 130 to generate the additional discrete feature values associated with corresponding ones of the additional, or alternate, ones of the declared feature groups for each row of training dataframe 322, validation dataframe 324, and testing dataframe 326, and to package the additional, discrete feature values row-specific ones of feature vectors 346, 358, and 350.

Executed featurizer module 340 may also perform operations that combine, or concentrate, programmatically the elements of group-specific executable code 351 and each of the additional elements of group-specific executable code associated with corresponding ones of the declared feature groups, and generate a corresponding script, e.g., featurizer pipeline script 352 executable by the one or more processors of computing system 130. By way of example, when executed by the one or more processors of computing system 130, executed featurizer pipeline script 352 may establish a “featurizer pipeline” of sequentially executed ones of the mapped, default stateless aggregation and post-processing operations, which, upon application to the rows of corresponding ones of training data table(s) 334, validation data table(s) 336, and testing data table(s) 338 (e.g., upon “ingestion” of these tables by the established featurizer pipelined), generate a feature vector of sequentially ordered feature values for corresponding ones of the rows of training dataframe 322, validation dataframe 324, and testing dataframe 326. In some instances, computing system 130 may maintain featurizer pipeline script 352 in Python™ format, and in some instances, executed featurizer module 340 may apply one or more Python™-compatible optimization or profiling processes to the elements of executable code maintained within featurizer pipeline script 352, which may reduce inefficiencies within the executed elements of code, and improve or optimize a speed at which the distributed computing components of computing system 130 execute featurizer pipeline script 352 and/or a use of available memory by featurizer pipeline script 352.

Executed featurizer module 340 may also perform operations that append each of feature vectors 346 to a corresponding row of training dataframe 322, which includes a row of labelled PKI dataframe 318 (e.g., a corresponding row of PKI dataframe 312 and the appended one of ground-truth labels 316). Executed featurizer module 340 may also perform operations that append each of feature vectors 348 to a corresponding row of validation dataframe 324, which includes an additional row of labelled PKI dataframe 318 (e.g., an additional row of PKI dataframe 312 and the appended one of ground-truth labels 316), and that append each of feature vectors 350 to a corresponding row of testing dataframe 326, which includes a further row of labelled PKI dataframe 318. As illustrated in FIG. 3B, executed featurizer module 340 may generate elements of a vectorized training dataframe 354 that include the rows of training dataframe 322 and the appended ones of feature vectors 346, elements of a vectorized validation dataframe 356 that include the rows of validation dataframe 324 and the appended ones of feature vectors 348, and elements of a vectorized testing dataframe 358 that include rows of testing dataframe 326 and the appended ones of feature vectors 350.

Further, executed featurizer module 340 may perform operations that provision training data table(s) 334, validation data table(s) 336, and testing data table(s) 324, vectorized training dataframe 354, vectorized validation dataframe 356, and vectorized testing dataframe 358, and featurizer pipeline script 352 to executed artifact management engine 146, e.g., as output artifacts 360 within default training pipeline 302. In some instances, executed artifact management engine 146 may receive each of output artifacts 360, and may perform operations that package each of output artifacts 360 into a corresponding portion of featurizer artifact data 362, along with a unique component identifier 166A of executed time-series featurizer engine 166, and that store featurizer artifact data 362 within a corresponding portion of artifact data store 142, e.g., within data record 304 associated with default training pipeline 302 and run identifier 303A. Further, although not illustrated in FIG. 3B, executed artifact management engine 146 may also package, into a corresponding portion of featurizer artifact data 362, additional data identifying and characterizing one or more of the input artifacts ingested by executed time-series featurizer engine 166, such as, but not limited to, training dataframe 322, validation dataframe 324, testing dataframe 326, and splitting data 328.

In some instances, and in accordance with default training pipeline 302, executed time-series featurizer engine 166 may provide vectorized training dataframe 354, vectorized validation dataframe 356, and vectorized testing dataframe 358 as inputs to training engine 168 executed by the one or more processors of computing system 130, e.g., in accordance with executed training pipeline script 150. Executed orchestration engine 144 may also provision, to executed training engine 168, the elements of modified training configuration data 230, and a programmatic interface associated with executed training engine 168 may receive, as corresponding input artifacts, the elements of modified training configuration data 230, and vectorized training dataframe 354, vectorized validation dataframe 356, and vectorized testing dataframe 358, and the programmatic interface of executed training engine 168 may perform operations any of the exemplary processes described herein that establish a consistency of these input artifacts with the engine- and pipeline-specific operational constraints imposed on executed training engine 168.

Based on an established consistency of the input artifacts with the imposed engine- and pipeline-specific operational constraints, executed training engine 168 may cause the one or more processors of computing system 130 to perform, through an implementation of one or more parallelized, fault-tolerant distributed computing and analytical processes described herein, operations that instantiate the machine-learning process in accordance with the value of the one or more parameters of the forward-in-time machine-learning process, e.g., as specified within the elements of modified training configuration data 230. Further, and through the implementation of one or more parallelized, fault-tolerant distributed computing and analytical processes described herein, the one or more processors of computing system 130 may perform further operations that apply the instantiated machine-learning process to: (i) each row of vectorized training dataframe 354 (e.g., the corresponding row of PKI dataframe 312, the appended one of ground-truth labels 316, and the appended one of feature vectors 346); (ii) each row of vectorized validation dataframe 356 (e.g., the additional row of PKI dataframe 312, the appended one of ground-truth labels 316, and the appended one of feature vectors 348); and (iii) each row of vectorized testing dataframe 358 (e.g., the further row of PKI dataframe 312, the appended one of ground-truth labels 316, and the appended one of feature vectors 350).

By way of example, and as described herein, developer 103 may elect to train a gradient-boosted, decision-tree process (e.g., an XGBoost process), to predict a likelihood of an occurrence, or a non-occurrence, of a targeted event involving one or more user associated with the organization or enterprise during a future, target temporal interval. In some instances, the elements of modified training configuration data 230 may include data that identifies the gradient-boosted, decision-tree process (e.g., a helper class or script associated with the XGBoost process and capable of invocation within the namespace of executed training engine 168) and a value of one or more default parameters of the gradient-boosted, decision-tree process.

In some instances, executed training engine 168 may cause the one or more processors of computing system 130 to instantiate the gradient-boosted, decision-tree process (e.g., the XGBoost process) in accordance with the default parameter values within the elements of modified training configuration data 230, and to apply the instantiated, gradient-boosted, decision-tree process to each row of vectorized training dataframe 354, each row of vectorized validation dataframe 356, to each row of vectorized testing dataframe 358. By way of example, executed training engine 168 may cause the one or more processors of computing system 130 may perform operations that establish a plurality of nodes and a plurality of decision trees for the gradient-boosted, decision-tree process, each of which receive, as inputs, corresponding rows of vectorized training dataframe 354 (e.g., the corresponding row of PKI dataframe 312, the appended one of ground-truth labels 316, and the appended one of feature vectors 346); corresponding rows of vectorized validation dataframe 356 (e.g., the additional row of PKI dataframe 312, the appended one of ground-truth labels 316, and the appended one of feature vectors 348); and corresponding rows of vectorized testing dataframe 358 (e.g., the further row of PKI dataframe 312, the appended one of ground-truth labels 316, and the appended one of feature vectors 350).

Based on the application of the instantiated, forward-in-time machine-learning process (e.g., the gradient-boosted, decision-tree process described herein, etc.) to the each row of vectorized training dataframe 354, executed training engine 168 may generate corresponding elements of training output data 364 and one or more elements of training log data 370 that characterize the application of the instantiated machine-learning process to the each row of vectorized training dataframe 354. Executed training engine 168 may append each of the generated elements of training output data 364 to the corresponding row of vectorized training dataframe 354, and generate elements of vectorized training output 376 that include each row of vectorized training dataframe 354 and the appended element of training output data 364.

Further, based on the application of the instantiated, forward-in-time machine-learning process (e.g., the gradient-boosted, decision-tree process described herein) to the each row of vectorized validation dataframe 356, and to each row of vectorized testing dataframe 358, executed training engine 168 may generate corresponding elements of validation output data 366 and testing output data 368, and one or more elements of validation log data 372 and testing log data 374 that characterize the application of the instantiated machine-learning process to the each row of a respective one of vectorized validation dataframe 356 and vectorized testing dataframe 358. Executed training engine 168 may append each of the generated elements of validation output data 366 to the corresponding row of vectorized validation dataframe 356, and append each of the generated elements of testing output data 368 to the corresponding row of vectorized testing dataframe 358. In some instances, executed training engine 168 may also generate elements of vectorized validation output 378 that include each row of vectorized validation dataframe 356 and the appended element of validation output data 366, and generate elements of vectorized testing output 380 that include each row of vectorized testing dataframe 358 and the appended element of testing output data 368.

The elements of training output 364, validation output data 366, and testing output data 368 may each indicate, for the values of the primary keys within each of respective ones of vectorized training dataframe 354, vectorized validation dataframe 356, and vectorized testing dataframe 358 (e.g., the alphanumeric, customer identifier and the timestamp, as described herein), an element of output data indicative of the predicted likelihood of the occurrence, or non-occurrence, of the targeted, developer-specified event within the future target temporal interval, e.g., subsequent to the corresponding, row-specific timestamp. Further, and by way of example, the elements of training log data 370, validation log data 372, and testing log data 374 may characterize a success, or alternatively, a failure, in the application of the instantiated machine-learning process to the rows of corresponding ones of vectorized training dataframe 354, vectorized validation dataframe 356, and vectorized testing dataframe 358, and may include, among other things, run identifier 303A, one or more identifiers of respective ones of vectorized training dataframe 354 and vectorized training output 376, of vectorized validation dataframe 356 and vectorized validation output 378, and of vectorized testing dataframe 358 and vectorized testing output 380, performance data (e.g., execution times, memory or processor usage, etc.), and the values of the processes parameters associated with the instantiated, forward-in-time machine-learning process, as described herein.

Referring back to FIG. 3B, executed training engine 168 may provision vectorized training output 376 (e.g., including the rows of vectorized training dataframe 354 and the appended elements of training output 364), vectorized validation output 378 (e.g., including the rows of vectorized validation dataframe 356 and the appended elements of validation output data 366), and vectorized testing output 380 (e.g., including the rows of vectorized testing dataframe 358 and the appended elements of testing output data 368), and the elements of training log data 370, validation log data 372, and testing log data 374, to executed artifact management engine 146, e.g., as output artifacts 382. In some instances, executed artifact management engine 146 may receive each of output artifacts 382, and may package each of output artifacts 382 into a corresponding portion of training artifact data 383, along with a unique, alphanumeric identifier 168A of executed training engine 168, and that store training artifact data 383 within a corresponding portion of artifact data store 142, e.g., within data record 304 associated with default training pipeline 302 and run identifier 303A. Further, although not illustrated in FIG. 3B, executed artifact management engine 146 may also package, into a corresponding portion of training artifact data 383, additional data identifying and characterizing one or more of the input artifacts ingested by executed training engine 168, such as, but not limited to, vectorized training dataframe 354, vectorized validation dataframe 356, and vectorized testing dataframe 358.

Further, and in accordance with default training pipeline 302, executed training engine 168 may provide output artifacts 382, including vectorized training output 376, vectorized validation output 378, and vectorized testing output 380, and the elements of training log data 370, validation log data 372, and testing log data 374, as inputs to reporting engine 172 executed by the one or more processors of computing system 130, e.g., in accordance with executed training pipeline script 150. In some instances, executed orchestration engine 144 may also provision, to executed reporting engine 172, output artifacts generated by respective ones of retrieval engine 156, preprocessing engine 158, indexing engine 160, target-generation engine 162, time-series splitting engine 164, time-series featurizer engine 166, and training engine 168, such as, but not limited to, output artifacts 306, 310, 314, 320, 330, and 360 maintained within artifact data store 142 (e.g., based on a request provisioned to executed artifact management engine 146, etc.). Executed orchestration engine 144 may also provision elements of modified reporting configuration data 232 to executed reporting engine 172,

As described herein, programmatic interface of executed reporting engine 172 perform operations that establish a consistency of each of the input artifacts with the engine- and pipeline-specific operational constraints imposed on executed reporting engine 172. Based on an established consistency of the input artifacts with the imposed engine- and pipeline-specific operational constraints, executed reporting engine 172 may perform operations, consistent with the elements of reporting configuration data 232, that generate elements of pipeline reporting data 384 characterizing an operation and a performance of the discrete, modular components executed by the one or more processors of computing system 130 within default training pipeline 302, and that characterize the predictive performance and accuracy of the machine-learning process during application to corresponding ones of vectorized training dataframe 354, vectorized validation dataframe 356, and vectorized testing dataframe 358. As described herein, the elements of modified reporting configuration data 232 may specify a default composition of pipeline reporting data 384 and a customized format of pipeline reporting data 384, e.g., DOCX format.

By way of example, and based on corresponding ones of output artifacts 306, 310, 314, 320, 330, and 360, executed reporting engine 172 may perform operations that establish a successful, or failed, execution of corresponding ones of application engines executed sequentially within default training pipeline 302, e.g., by confirming that each of the generated elements of artifact data are consistent, or inconsistent, with corresponding ones of the operational constraints imposed on corresponding ones of executed application engines. In some instances, executed reporting engine 172 may generate one or more elements of pipeline reporting data 384 indicative of the successful execution of the application engines within default training pipeline 302 (and a successful execution of default training pipeline 302) or alternatively, an established failure in an execution of one, or more, of the application engines within default training pipeline 302 (e.g., and a corresponding failure of default training pipeline 302).

In some instances, based on output artifacts 382 generated by executed training engine 168 (e.g., within default training pipeline 302), executed reporting engine 172 may package, into portions of pipeline reporting data 384, elements of process data 386 that include the values of one or more process parameters associated with the instantiated, forward-in-time machine-learning process (e.g., as specified within the elements of modified training configuration data 230) and elements of composition data 388 that specify a composition of, and sequential ordering of the feature values within, corresponding ones of feature vectors 346, 348, and 350. For example, elements of composition data 388 may include may include an ordered set or list of the feature identifiers associated with the sequentially ordered feature values within corresponding ones of feature vectors 346, 348, and 350, and the ordered set or list of feature identifiers (e.g., the alphanumeric feature names described herein, which may be declared within the elements of modified featurizer configuration data 228, etc.) may establish the composition of feature vectors 346, 348, and 350.

Executed reporting engine 172 may also access the elements of vectorized training output 376, vectorized validation output 378, and vectorized testing output 380, and the elements of training log data 370, validation log data 372, and testing log data 374 (e.g., that include the values of the processes parameters associated with the forward-in-time machine-learning process, as described herein). In some instances, and consistent with the elements of modified reporting configuration data 232, executed reporting engine 172 may perform operations that generate one or more elements of explainability data 390, which characterize the predictive performance and accuracy of the forward-in-time machine-learning process during application to a respective one of vectorized training dataframe 354, vectorized validation dataframe 356, and vectorized testing dataframe 358. As illustrated in FIG. 3B, executed reporting engine 172 may perform operations that package the elements of explainability data 390 into a corresponding portion of pipeline reporting data 384.

By way of example, the elements of explainability data 390 may include one or more Shapley values that characterize a relative importance of each of the discrete features of the feature vectors within respective ones of vectorized training dataframe 354, vectorized validation dataframe 356, and vectorized testing dataframe 358, and that characterize a relative contribution of each of the discrete features to the predictive output of the forward-in-time, machine-learning process and/or a reliance of the forward-in-time, machine-learning process on a pairwise interactions between the discrete features (e.g., upon application to the feature vectors maintained within the respective one of vectorized training dataframe 354, vectorized validation dataframe 356, and vectorized testing dataframe 358). Further, the elements of explainability data 390 may associate each of the feature-specific Shapley values with a corresponding feature identifier, such as, but not limited to, the alphanumeric feature name described herein.

By way of example, the forward-in-time, machine-learning process may include a gradient-boosted, decision-tree process, such as an XGBoost process, and executed reporting engine 172 may generate the Shapley values in accordance with one or more Shapley Additive explanations (SHAP) processes, such as, but not limited to, a KernelSHAP process or a TreeShap process. The disclosed embodiments are, however, not limited to these exemplary algorithms or processes, and in other instances, executed reporting engine 172 may generate the Shapley values associated with the discrete features of the feature vectors maintained within each vectorized training dataframe 354, vectorized validation dataframe 356, and vectorized testing dataframe 358 using any additional, or alternate, process appropriate the forward-in-time, machine-learning process, such as, but not limited to, an integrated gradient algorithm associated with a deep neural-network model.

Further, and in addition to, or as an alternate to, the Shapley values, the elements of explainability data 390 (e.g., as generated by executed reporting engine 172) may also include values of one or more deterministic or probabilistic metrics that characterize further the relative importance of the each of the discrete features of the feature vectors maintained within respective ones of vectorized training dataframe 354, vectorized validation dataframe 356, and vectorized testing dataframe 358, and the relative contribution of each of the discrete features to the predictive output of the forward-in-time, machine-learning process upon application to the feature vectors maintained within respective ones of vectorized training dataframe 354, vectorized validation dataframe 356, and vectorized testing dataframe 358. By way of example, the elements of explainability data maintained within each of training log data 370, validation log data 372, and testing log data 374 may also include, for one or more of the discrete features, data establishing a feature-specific individual conditional expectation (ICE) curve and/or data specifying a feature-specific partial dependency plot (PDP), and the elements of explainability data may associated each of the data specifying the feature-specific ICE curves and/or the feature-specific PDPs with a corresponding feature identifier, such as, but not limited to, the alphanumeric feature name described herein.

In some instances, the elements of explainability data 390 (e.g., as generated by executed reporting engine 172) may include values of one or more additional, deterministic or probabilistic metrics that characterize the predictive performance and accuracy of the forward-in-time machine-learning process during application to a respective one of vectorized training dataframe 354, vectorized validation dataframe 356, and vectorized testing dataframe 358. Examples of these additional, deterministic or probabilistic metric values may include, but are not limited to, computed precision values, computed recall values, computed areas under curve (AUCs) for receiver operating characteristic (ROC) curves or precision-recall (PR) curves, and/or computed multiclass, one-versus-all areas under curve (MAUCs) for ROC curves. The disclosed embodiments are, however, not limited to, these exemplary elements of training log data 370, validation log data 372, and testing log data 374, and in other examples, executed reporting engine 172 may perform operations, consistent with the elements of modified reporting configuration data 232, that generate any additional, or alternate, elements of data characterizing the application of the instantiated, forward-in-time machine-learning process to the rows of corresponding ones of vectorized training dataframe 354, vectorized validation dataframe 356, and vectorized testing dataframe 358 within default training pipeline 302.

Further, and based on one or more of output artifacts 306, 310, 314, 320, 330, and 360, executed reporting engine 172 may perform operations that generate values of metrics characterizing a bias or a fairness of the machine-learning process and additionally, or alternatively, at a bias or a fairness associated with the calculations performed at all, or a selected subset, of the discrete steps of the execution flow established by default training pipeline 302, e.g., the sequential execution of retrieval engine 156, preprocessing engine 158, indexing engine 160, target-generation engine 162, time-series splitting engine 164, time-series featurizer engine 166, and training engine 168 within default training pipeline 302. Examples of these metric values may include, but are not limited to a value of an area under a ROC curve across one or more stratified segments of the ingested data samples characterized by a common value of one, or more demographic parameters of relevance to developer 103 or to the particular use case (e.g., “binned” segments of the ingested data samples charactering customers of a common gender, orientation, or age range, etc.), and the metrics generated reporting engine 172 may be established internally by the organization, or may be associated with one or more external, governmental or regulatory entities. In some instances, executed reporting engine may package the generated metric values into fairness data 392, which may be maintained within a corresponding portion of pipeline reporting data 384.

Executed reporting engine 172 may perform operations that structure pipeline reporting data 384, including the elements of process data 386, composition data 388, explainability data 390, and fairness data 392, in accordance with a format specified within the elements of modified reporting configuration data 232, such as, but not limited to, a PDF or a DOCX format. Executed reporting engine 172 may also provide pipeline reporting data 384 to executed artifact management engine 146, e.g., as output artifacts of executed reporting engine 172 within default training pipeline 302. In some instances, executed artifact management engine 146 may receive each of the output artifacts of executed reporting engine 172, e.g., the elements of pipeline reporting data 384, and may perform operations that package the elements of pipeline reporting data 384 into a corresponding portion of reporting artifact data 394, along with a unique, alphanumeric identifier 172A of executed reporting engine 172, and that store reporting artifact data 394 within a corresponding portion of artifact data store 142, e.g., within data record 304 associated with default training pipeline 302 and run identifier 303A. Further, although not illustrated in FIG. 3B, executed artifact management engine 146 may also package, into a corresponding portion of reporting artifact data 394, additional data identifying and characterizing the input artifacts ingested by executed reporting engine 172.

Through a performance of one or more of the exemplary processes described herein, the one or more processors of computing system 130 may facilitate a customization of a plurality of sequentially executed, default application engines within default training pipeline 302 to reflect a particular use-case of interest to developer 103 without requiring any modification to the elements of executable code of these default application engines, any modification to the executable scripts (e.g., executed training pipeline script 150) that establish default training pipeline 302, or to any execution flow of the default application engines within default training pipeline 302. Certain of these exemplary processes, which leverage engine-specific elements of configuration data formatted and structured in a human-readable data-serialization language (e.g., a YAML™ data-serialization language, etc.) and accessible, and modifiable, using a browser-based interface, may enable analysts, data scientists, and developers of various familiarities with machine-learning processes, and associated with various skill levels in coding and scripting, to incorporate forward-in-time machine-learning processes into user-facing or back-end decisioning operations across various organizations, and to train adaptively these forward-in-time machine-learning processes through default pipelines customized to reflect these decisioning processes and without the data leakage that characterizes feature generation in many existing processes that train forward-in-time machine-learning processes

By way of example, the elements of engine-specific artifact data maintained within data record 304 of artifact data store 142 may be associated with the current run of default training pipeline 302 initiated on Jun. 1, 2024, in accordance with the engine-specific elements of configuration data, which may be customized by developer 103 may customize in accordance with the particular use-case using any of the exemplary processes described herein. In some instances, data record 304 may associate the elements of engine-specific artifact data with the current implementation, or run, of default training pipeline 302 (e.g., via run identifier 303A) and with the Jun. 1, 2024, initiation of default training pipeline 302 (e.g., via temporal identifier 303B). Further, and as described herein, each of the elements of engine-specific artifact data maintained within data record 304 may associate one or more output artifacts within a corresponding one of the component identifiers of the application engines sequentially executed within default training pipeline 302.

In some instances, the current implementation of default training pipeline 302, which executed orchestration engine 144 initiated on Jun. 1, 2024, may represent an initial (or an intermediate) one of plurality of sequential runs of default training pipeline 302 that train adaptively, and iteratively, a machine-learning process to generate predictive output of relevance to the particular use-case based on elements of engine-specific configuration data customized and modified by developer 103 using any of the exemplary processes described herein. For example, upon successful completion of the current run of default training pipeline 302, the one or more processors of computing system 130 may perform operations that provision each, or a selected subset, of the elements of engine-specific artifact data generated during the June 1st run of default training pipeline 302, which may be maintained within data record 304 of artifact data repository, to developer system 102.

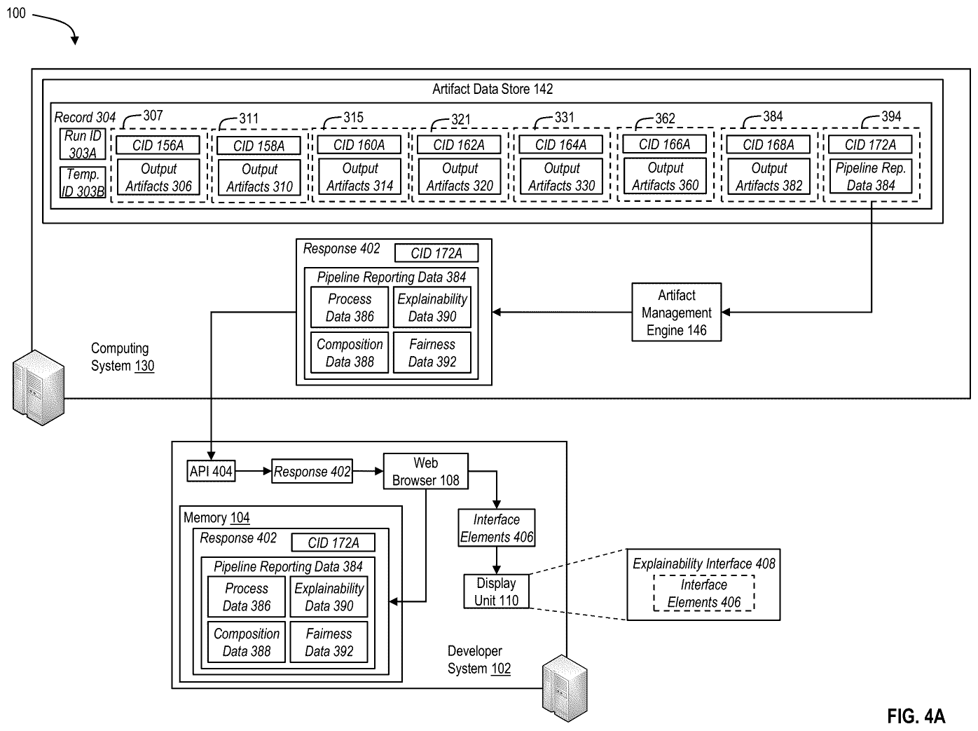

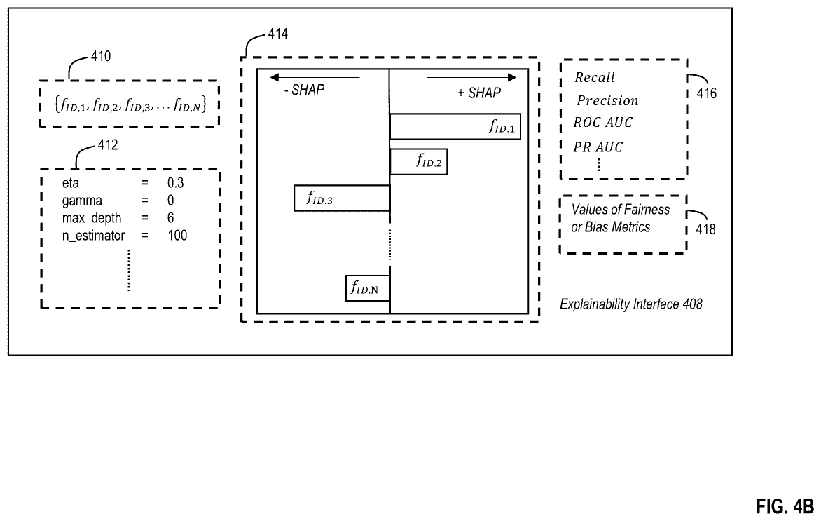

For example, referring to FIG. 4A, executed orchestration engine 144 may obtain portions of reporting artifact data 394, including identifier 172A and pipeline reporting data 384. As described herein, pipeline reporting data 384 may include the elements of process data 386, composition data 388, explainability data 390, and fairness data 392 (e.g., as maintained within), and in some instances, executed orchestration engine 144 may generate a response 402 to customization request 234 that includes the obtained portions of reporting artifact data 394, and may perform operations that cause computing system 130 to transmit response 402 across network 120 to computing system 130, e.g., via the secure, programmatic channel of communications established between executed programmatic web service 148 of computing system 130 and executed web browser 108 of developer system 102. A programmatic interface established and maintained by developer system 102, such as an application programming interface 404 associated with web browser 108, may receive response 402 (e.g., identifier 172A and the portions of pipeline reporting data 384) from computing system 130, and may route response 402 to web browser 108, which may be executed by the one or more processors of developer system 102. In some instances, executed web browser 108 may store response 402 within a portion of memory 104, and may process portions of response 402 and generate interface elements 406 representative of portions of pipeline reporting data 384, such as, but not limited to, corresponding portions of the elements of process data 386, composition data 388, explainability data 390, and fairness data 392 described herein. Executed web browser 108 may provide all, or a selected portion, of interface elements 406 to display device 110, which may render interface elements 406 within one or more portions or display screens of a digital interface, such as, but not limited to, explainability interface 408.

As illustrated in FIG. 4B, explainability interface 408 may include one or more portions 410 that present the feature identifiers associated with each of the identifiers associated with the sequentially ordered feature values within corresponding ones of feature vectors 346, 348, and 350 (e.g., the alphanumeric feature identifiers f_{ID,1}, f_{ID,2}, f_{ID,3}, . . . f_{ID,N} specified within composition data 388 (e.g., for N feature values within corresponding ones of feature vectors 346, 348, and 350)), and one or more portions 412 that present each, or a subset, of the values of the process parameters associated with the forward-in-time machine-learning process (e.g., as maintained within process data 386). For example, the presented values of the process parameters may include, but are not limited to, a value of the learning rate, eta, of the forward-in-time machine-learning process (e.g., a default value of 0.3, etc.), a value of a minimum loss reduction, gamma, of the forward-in-time machine-learning process (e.g., a default value of 0, etc.), a value of a maximum tree depth of the forward-in-time machine-learning process (e.g., a default value of 6, etc.), and a number of discrete decision trees associated with the forward-in-time machine-learning process (e.g., a default, n_estimator value of 100, etc.). The disclosed embodiments are, however, not limited to these exemplary process parameters or corresponding values, and in other instances, portion 412 of explainability interface 408 may present values of any additional, or alternate parameter appropriate to the forward-in-time machine-learning process and maintained within process data 386 and further, any additional, or alternate, value of the exemplary process parameters described herein (e.g., as specified within modified training configuration data 230.

Further, as illustrated in FIG. 4B, portion 414 of explainability interface 408 may provide a graphical representation of a magnitude of the Shapely feature value characterizing each of the features of the forward-in-time machine-learning process, e.g., as maintained within explainability data 390. As described herein, explainability data 390 may associate the feature identifier of each of the features within a corresponding one of the Shapley values, which may characterize a relative importance of that feature, and a relative contribution of that feature, to the predictive output of the forward-in-time, machine-learning process. For example, as illustrated in FIG. 4B, portion 414 may indicate that the first and third of the sequential features (e.g., associated with respective ones of feature identifiers f_{ID,1} and f_{ID,3}) represent important, or impactful, features associated with corresponding Shapley values having magnitudes that exceed the Shapley values characterizing the relative importance of the second and N^{TH} features (e.g., associated with respective ones of feature identifiers f_{ID,2} and f_{ID,N}).

In some instances, as illustrated in the graphical representation of the Shapley values within portion 414 of explainability interface 408, a positive (or alternatively, negative) change in the value of a respective one of the first and third of the sequential features may be correlated with a corresponding, positive (or alternatively, negative) change in the predictive output of the forward-in-time machine-learning process, and magnitude of the corresponding, positive (or alternatively, negative) change in the predictive output may be proportional to the magnitude of the respective one of the first and third of the sequential features. Similarly, and based on the graphical representation of the Shapley values within portion 414 of explainability interface 408, a positive (or alternatively, negative) change in the value of a respective one of the second and N^{TH} ones of the sequential features may be correlated with a corresponding, inverse change in the predictive output of the forward-in-time machine-learning process, and magnitude of the corresponding, inverse change in the predictive output may be proportional to the magnitude of the respective one of the second and N^{TH} ones of the sequential features.

In some examples, explainability interface 408 may include a portion 416 that present values of each, or a selected subset, of the deterministic or probabilistic metric values that characterize the predictive performance and accuracy of the forward-in-time machine-learning process, e.g., as maintained within explainability data 390. For example, as illustrated in FIG. 4B, portion 416 may present determined values of a recall and a precision of the forward-in-time machine-learning process, which characterize, respectively, a proportion of a number of ingested data samples correctly identified as a positive targets by the forward-in-time machine-learning process (e.g., a ratio of a number of predicted true positives to a sum of the predicted true positives and predicted false negatives across all, or a selected portion, of the predicted output) and a proportion of a number of the ingested data samples identified as positive targets by the forward-in-time machine-learning process that represent true positives (e.g., a ratio of a number of the predicted true positives to a sum of the predicted true and false across all, or a selected portion, of the predicted output).

Further, portion 416 of explainability interface 408 may also include a value of an area under a receiver operating curve (ROC) for the forward-in-time machine-learning process (e.g., “ROC AUC”) and value of an area under a precision recall (PR) curve for the forward-in-time machine-learning process. The disclosed embodiments are, however, not limited to these exemplary deterministic or probabilistic metric values, and portion 416 may present a value of any additional or alternate deterministic or probabilistic metric that characterizes the predictive performance and accuracy of the forward-in-time machine-learning process, that is maintained within explainability data 390, and that is capable of computation by executed training engine 168 and/or executed reporting engine 172.

Explainability interface 408 may also include a portion 418 that presents values of the one or more metric values that characterize a determined fairness or bias of the forward-in-time machine-learning process, e.g., as maintained within fairness data 392. As described herein, the metric values that characterize the fairness or bias of the forward-in-time machine-learning process may, for example, include a value of an area under a receiver operating curve (ROC) of the forward-in-time machine-learning process across one or more stratified segments of the ingested data samples characterized by a common value of one, or more demographic parameters of relevance to developer 103 or to the particular use case (e.g., “binned” segments of the ingested data samples charactering customers of a common gender, orientation, or age range, etc.). In some instances, the elements of fairness data 392 may also include, for one or more of the binned segments, aggregated output data indicating an average number of the ingested data samples characterized by the predicted output of the forward-in-time machine-learning process as a positive or negative target (e.g., for a binary classification process, etc.) or within corresponding classes of a multi-class classification process. Although not illustrated in FIG. 4B, developer system 102 may present may present a textual representation (e.g., in tabular form, etc.) or a graphical representation (e.g., a plot, etc.) of the value of the area under the ROC and additionally, or alternatively, corresponding portions of the aggregated output data for each, or a selected subset, of the binned segments within portion 418 of explainability interface 408.

In some instances, based on a review of portions 414, 416, and/or 418 of explainability interface 408, developer 103 may determine that the predictive capability, and an accuracy, of the forward-in-time, machine-learning process after the current, June 1st run of default training pipeline 302 fails to satisfy one or more threshold conditions for a deployment within an production environment and an application to confidential elements of customer data. The one or more threshold conditions may, for example, include a predetermined threshold value for the recall-based values, a predetermined threshold value for the computed precision-based values, and/or a predetermined threshold value for the areas under the ROC or PR curve, which may be presented within portion 416. Developer 103 may, for example, establish that one or more of the computed recall-based values, the computed precision-based values, or the computed areas under the ROC or PR curve are inconsistent with a corresponding one of the predetermined threshold values (e.g., exceed, or alternatively, fall below the corresponding one of the predetermined threshold values), and as such, that the forward-in-time machine-learning process is unsuitable for deployment within the production environment absent further adaptive training, testing, and validation.

Based on the determination that the machine-learning process is unsuitable for deployment within the production environment, developer 103 may, for example, view the graphical representation of a magnitude of the Shapely feature value characterizing one or more of the features of the forward-in-time machine-learning process (e.g., as presented within portion 414 of explainability interface 408), and developer 103 may elect to add one or more new features to feature vectors 346, 348, and 350, to subtract one or more previously specified features from feature vectors 346, 348, and 350 (e.g., non-contributing features associated with Shapley values having magnitudes that fail to exceed a threshold Shapley value) and additionally, or alternatively, to combine together previously specified features from feature vectors 346, 348, and 350 (e.g., to derive a composite feature, such as a sum of two existing features, etc.). Further, based on the graphical representation of the feature-specific Shapley values presented within portion 414, the deterministic or probabilistic metric values presented within portion 416, and additionally, or alternatively, the fairness or bias metric values presented within portion 418, developer 103 may also elect to modify one or more of the process parameter values of the machine-learning process instantiated during the current, March 1st run of default training pipeline 302.

In some instances, to facilitate a modification to the composition of the feature vectors, or to facilitate a modification to the process parameter values, developer 103 may provide further input to developer system 102 (e.g., via input device 112), which may cause executed web browser 108 to perform any of the exemplary processes described herein to request access to, and to receive from computing system 130, one or more elements of modified featurizer configuration data 228 and one or more elements of modified training configuration data 230 associated with default training pipeline 302 (e.g., as maintained within configuration data store 140). Although not illustrated in FIG. 4A or 4B, developer 103 may provide input to developer system 102 (e.g., via input device 112) that modifies further one or more of the elements of modified featurizer configuration data 228 to specify the one or more additional, new features, to subtract the one or more previously specified features, and additionally, or alternatively, to combine together the previously specified features (e.g., the composite features described herein, etc.). Further, in some instances, developer 103 may also provide input to developer system 102 (e.g., via input device 112) that modifies the elements of modified training configuration data 230 to reflect the further adjustment to the one or more process parameter values of the machine-learning process, e.g., an adjustment to one, or more, of the value of the learning rate, minimum loss reduction, maximum tree depth, or number of discrete decision trees associated with the forward-in-time machine-learning process described herein.

Executed web browser 108 may perform operations, described herein, that package input data characterizing the further modifications to the elements of modified featurizer configuration data 228 and additionally, or alternatively, to the elements of modified training configuration data 230, into corresponding portions of an additional customization request (e.g., along with the one or more identifiers of developer system 102 or executed web browser 108, such as, but not limited to, the IP or MAC address of developer system 102, or the digital token or application cryptogram identifying executed web browser 108), and executed web browser 108 may cause developer system 102 to transmit customization request 234 across communications network 120 to computing system 130. In some instances, customization API 206 of executed customization application 204 at computing system 130 may receive the additional customization request, and based on an established permission of developer system 102 to modify or customize the elements of configuration data maintained within configuration data store 140, executed customization application 204 may obtain the further modifications to the elements of modified featurizer configuration data 228 and/or the elements of modified training configuration data 230, and perform operations that store the further modifications to the elements of modified featurizer configuration data 228 and/or the elements of modified training configuration data 230 within configuration data store 140, e.g., to replace or update the previous modifications to these engine-specific elements of configuration data.

Executed orchestration engine 144 may also perform any of the exemplary processes described herein to access and execute training pipeline script 150, which may re-establish default training pipeline 302, and which may cause the one or more processors of computing system 130 to execute sequentially, during a subsequent training run of default training pipeline 302, each retrieval engine 156, preprocessing engine 158, indexing engine 160, target-generation engine 162, splitting engine 164, featurizer engine 166, training engine 168, and reporting engine 172 in accordance with respective ones of the engine-specific elements of configuration data, including but not limited to, the further modifications to the elements of modified featurizer configuration data 228 and/or modified training configuration data 230 described herein. In some instances, each of sequentially executed retrieval engine 156, preprocessing engine 158, indexing engine 160, target-generation engine 162, splitting engine 164, featurizer engine 166, training engine 168, and reporting engine 172 may generate one or more output artifacts, which executed artifact management engine 146 may store within one or more additional data records of artifact data store 142, e.g., in associated with a unique alphanumeric identifier of the subsequent training run of default training pipeline 302 and a temporal identifier characterizing an initiation date of the subsequent training run.

Upon completion of the subsequent training run of default training pipeline 302, the one or more processors of computing system 130 may perform any of the exemplary processes described herein to provision one or more of the generated output artifacts, including but not limited to additional pipeline reporting data generated by executed training engine 168 across network 120 to developer system 102. As described herein, the additional pipeline reporting data may include corresponding elements of additional process, composition, explainability, and fairness data (e.g., such as, but not limited to, those exemplary elements described herein), which characterize the predictive performance and accuracy of the machine-learning process during the subsequent training run of default training pipeline 302), and upon receipt by developer system 102, executed web browser 108 may perform any of the exemplary processes described herein to generate interface elements representative of the elements of additional pipeline reporting data, and to render those interface elements for presentation within corresponding portions, or display screens, of explainability interface 408, e.g., via display device 110.

In some instances, developer 103 may review, within explainability interface 408, all or a selected subset of the interface elements representative of the additional process, composition, explainability, and fairness data. As described herein, the presented representations of the additional explainability data may characterize the predictive performance and accuracy of the machine-learning process during the subsequent training run of default training pipeline 302, and based on the additional explainability data, developer 103 may determine whether the predictive capability, and an accuracy, of the forward-in-time machine-learning process after the subsequent training run of default training pipeline 302 satisfies one or more threshold conditions for deployment within a production environment and application to confidential elements of customer data.

For example, and based on a determination by developer 103 that the predictive capability and accuracy of the forward-in-time machine-learning process after the subsequent training run fails to satisfy one or more threshold conditions for deployment, developer system 102 and computing system 130 may perform any of the exemplary processes described herein, consistent with additional input from developer 103, to modify additionally a composition of the feature vectors ingested by the machine-learning process and/or one or more process parameter values of the forward-in-time machine-learning process, instantiated during the subsequent training run, and to initiate, and execute, a further training run of default training pipeline 302 in accordance with the additional modifications to composition of the feature vectors and additionally or alternatively, to the process parameters of the machine-learning process.

During the further training run of default training pipeline 302, the one or more processors of computing system 130 may perform operations, described herein, that execute sequentially each of retrieval engine 156, preprocessing engine 158, indexing engine 160, target-generation engine 162, time-series splitting engine 164, time-series featurizer engine 166, training engine 168, and reporting engine 172 in accordance with corresponding, engine-specific elements of configuration data, including but not limited to, the elements of modified featurizer configuration data 228 (e.g., that include the further modifications to the composition of the feature vectors) and the elements of modified training configuration data 230 (e.g., that include the further modifications to the process parameters). In some instances, one or more of these exemplary processes, which modify the composition of the feature vectors ingested by the machine-learning process, and/or the process parameter values of the machine-learning process, instantiated during a prior training run of default training pipeline 302, and which reestablish default training pipeline 302 during a further training run, may be repeated iteratively until the predictive capability and accuracy of the forward-in-time machine-learning process satisfies each of the threshold conditions for deployment.

By way of example, and through the iterative repetition of one or more of the exemplary processes described herein, the elements of explainability data generated as output artifacts by executed reporting engine 172 during a final training run of default training pipeline 302 may indicate the predictive capability and accuracy of the machine-learning process satisfy each of the threshold deployment conditions, and as such, the machine-learning process may be deemed sufficiently trained for deployment within an production environment and application to confidential elements of customer data. In some instances, and upon completion of the final training run of default training pipeline 302, executed artifact management engine 146 may perform operations, described herein, that maintain, within one or more additional data records of artifact data store 142, an archive of engine-specific elements of artifact data that include the output artifacts generated by each of sequentially executed application engines within the final training run of default training pipeline 302 (e.g., in association with a unique run identifier and a temporal identifier characterizing an initiation date of the final training run).

The engine-specific elements of artifact data generated during the final training run of training pipeline 302 may include, but is not limited to, elements of process data that specify the values of the one or more process parameters of the now-trained, forward-in-time machine-learning process. As described herein, the forward-in-time machine-learning process may include a gradient-boosted, decision-tree process, such as an XGBoost process, and examples of the process parameter values for the trained, gradient-boosted, decision-tree process may include a learning rate, a number of discrete decision trees (e.g., the “n_estimator” for the trained, gradient-boosted, decision-tree process), a tree depth characterizing a depth of each of the discrete decision trees, a minimum number of observations in terminal nodes of the decision trees, and/or values of one or more hyperparameters that reduce potential model overfitting.

The engine-specific elements of artifact data generated during the final training run of training pipeline 302 may also include, among other things, final elements of composition data that specify a composition of, and sequential ordering of, feature values of features within a feature vector for the now-trained, forward-in-time machine-learning process, along with additional a final featurizer pipeline script that establishes a final, featurizer pipeline of sequentially executed, default stateless transformations and default estimation operations that, upon execution by time-series featurizer engine 166, generates a feature vector having a composition and structure consistent with the final elements of composition data. In some instances, thorough a performance of one or more of the exemplary processes described herein, developer system 102 and computing system 130 may perform operations that select adaptively a set of stable, impactful features consistent with the particular use-case of interest to developer 103, and that, based on an execution of the final, featurizer pipeline script, generate one or more user-specific feature vectors suitable for ingestion by the trained, forward-in-time machine-learning process and without the data leakage characteristic of many existing processes for training adaptively forward-in-time machine-learning processes.

Further, in some instances, executed artifact management engine 146 may “copy” these output artifacts from a development environment (e.g., a development partition of the distributed computing components of computing system 130) to a production environment (e.g., a production partition of the distributed computing components of computing system 130), which may facilitate inferencing based on an application of the trained machine-learning process to feature vectors derived from elements of confidential customer data. For instance, the final featurizer pipeline script and the elements of process-parameter data may represent input artifacts for inferencing pipeline script 152, and one or more of these input artifacts may be ingested into a corresponding default inferencing pipeline established by inferencing pipeline script 152, e.g., upon execution of the one or more processors of computing system 130.

Through a performance of one or more of the exemplary processes described herein, the one or more processors of computing system 130 may facilitate a customization of a plurality of sequentially executed, default application engines within default training pipeline 302 to reflect a particular use-case of interest to developer 103 without requiring any modification to the elements of executable code of these default application engines, any modification to the executable scripts (e.g., executed training pipeline script 150) that establish default training pipeline 302, or to any execution flow of the default application engines within default training pipeline 302. Certain of these exemplary processes, which leverage engine-specific elements of configuration data formatted and structured in a human-readable data-serialization language (e.g., a YAML™ data-serialization language, etc.) and accessible, and modifiable, using a browser-based interface, may enable analysts, data scientists, and developers of various familiarities with machine-learning processes, and associated with various skill levels in coding and scripting, to incorporate forward-in-time machine-learning processes into various user-facing or back-end decisioning operations, and to train adaptively these forward-in-time machine-learning processes through default pipelines customized to reflect these decisioning processes and without the data leakage that characterizes feature generation in many existing processes that train forward-in-time machine-learning processes.

For example, and during an initial training run of default training pipeline 302, executed time-series featurizer engine 166 may perform operations, described herein, that generate feature vectors for corresponding rows of training, validation, and testing dataframes in accordance with elements of featurizer configuration data. Each of the generated feature vectors may be characterized by a common composition and structure, which may be established by developer 102 and specified within corresponding elements of featurizer configuration data, such as modified featurizer configuration data 228. Further, and during each of the subsequent training runs of default training pipeline 302, include the final training run, executed time-series featurizer engine 166 may perform one or more of the exemplary processes described herein to generate, for the corresponding rows of the training, validation, and testing dataframes, additional feature vectors characterized by a modified composition or structure that reflects an outcome of a prior training run of default training pipeline 302, and as described herein, the modified structure of composition of each of the run-specific, additional feature vectors may be established by developer 103 and may reflect a relative importance of the features associated with the prior training run, e.g., based on portion of explainability data 390.

As described herein, each of the initial, subsequent, and final training runs of default training pipeline 302 may associated with a sequential execution of each retrieval engine 156, preprocessing engine 158, indexing engine 160, target-generation engine 162, time-series splitting engine 164, time-series featurizer engine 166, training engine 168, and reporting engine 172 by the distributed computing components of computing system 130. The discrete computational operations that facilitate the sequential execution of these pipelines application engines within ten, or even hundreds of successive training runs of default training pipeline 302 may be consume, and require an allocation of, significant processing, memory, and network resources within a distributed computing environment, such as, but not limited to, a distributed computing environment established by the distributed computing components of computing system 130. Further, through modification to corresponding elements of featurizer configuration data (e.g., based on programmatic interactions between developer system 102 and executed customization application 204), developer 102 may elect to modify a composition of the feature vectors generated by executed time-series featurizer engine 166 upon completion of an initial, or one or more of the subsequent, training runs of default training pipeline 302.

For example, and upon completion of a corresponding one of the training runs of default training pipeline 302, developer system 102 and computing system 130 may perform operations, described herein, that modify elements of featurizer configuration data (e.g., the elements of modified featurizer configuration data 228, etc.) to reflect, among other things, a decision by developer 103 to add or delete a previously specified feature from one or more of the declared feature groups of the feature vectors generated by executed time-series featurizer engine 166 during a prior training run of default training pipeline 302 (e.g., based on the Shapley values presented within portion 414 of explainability interface 408), or to add, to the feature vectors generated by executed time-series featurizer engine 166 during a prior training run of default training pipeline 302, one or more additional, declared feature groups of discrete features, which may be associated with corresponding, stateless aggregation operations, corresponding temporal lookback intervals, and in some instances, corresponding post-processing operations. Further, upon completion of a corresponding one of the training runs of default training pipeline 302, developer system 102 and computing system 130 may also perform operations, described herein, that modify the elements of featurizer configuration data (e.g., the elements of modified featurizer configuration data 228, etc.) to reflect, among other things, a decision by developer 103 to modify a stateless aggregation or post-processing operation associated with a corresponding one of the declared feature groups, or to modify a duration of a corresponding temporal lookback interval (e.g., to increase the prior lookback interval of the initial one of the declared feature groups from sixty days to ninety days, or to reduce the prior lookback interval from sixty days to thirty days, etc.).

Although the implementation of these exemplary, modular and configurable, feature-generation and training processes within default training pipeline 302 may facilitate an adaptive selection of a set of stable, impactful features that are consistent with the particular use-case of interest to developer 103 without any modification to the execution flow of default training pipeline 302, or to the executable code of time-series featurizer engine 166 or to training engine 168, the sequential, and repetitive character of these processes may consume, and require an allocation of, significant processing, memory, and network resources within a distributed computing environment, especially if developer 103 were to regularly modify a composition or structure of the feature vectors between successive training runs of default training pipeline 302. In some examples, described herein, developer system 102 and the one or more processes of computing system 130 may perform operations that modify an execution flow of the sequentially executed default application engines within default training pipeline 302 to facilitate a generation, in parallel, of multiple sets of vectorized training, validation, and testing dataframes associated with corresponding feature vectors of differing composition or structure, which may be ingested by as input artifacts by corresponding, executed instances of time-series featurizer engine 166, and to facilitate an application, in parallel, of the machine-learning process to distinct sets of vectorized training, validation, and testing dataframes by corresponding, executed instances of training engine 168

In some instances, the sequentially execution of the default application engines in accordance with the modified execution flow (e.g., in parallel across the one or more processors of computing system 130 based on programmatic interaction with executed orchestration engine 144) may establish a customized training pipeline that facilitates the adaptive selection of a set of stable, impactful features that are consistent with the particular use-case of interest to developer 103, while maintaining compliance with the one or more process-validation operations or requirements and with the one or more governmental or regulatory requirements, and further, while facilitating a reduction in consumption of the processing, memory, network, and other computational resources associated with successive implementation of default training pipeline 302.

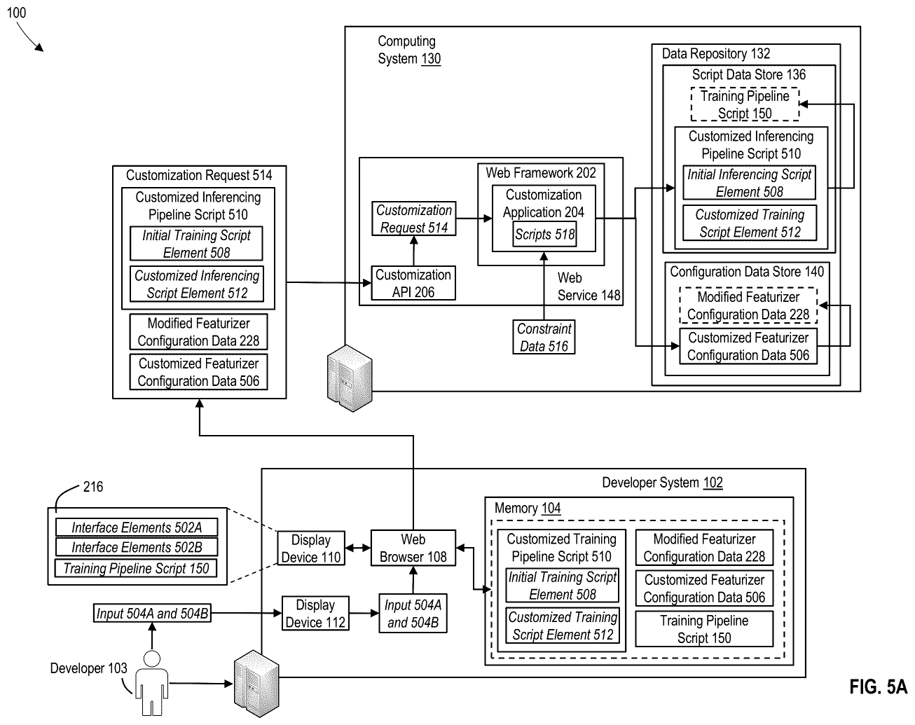

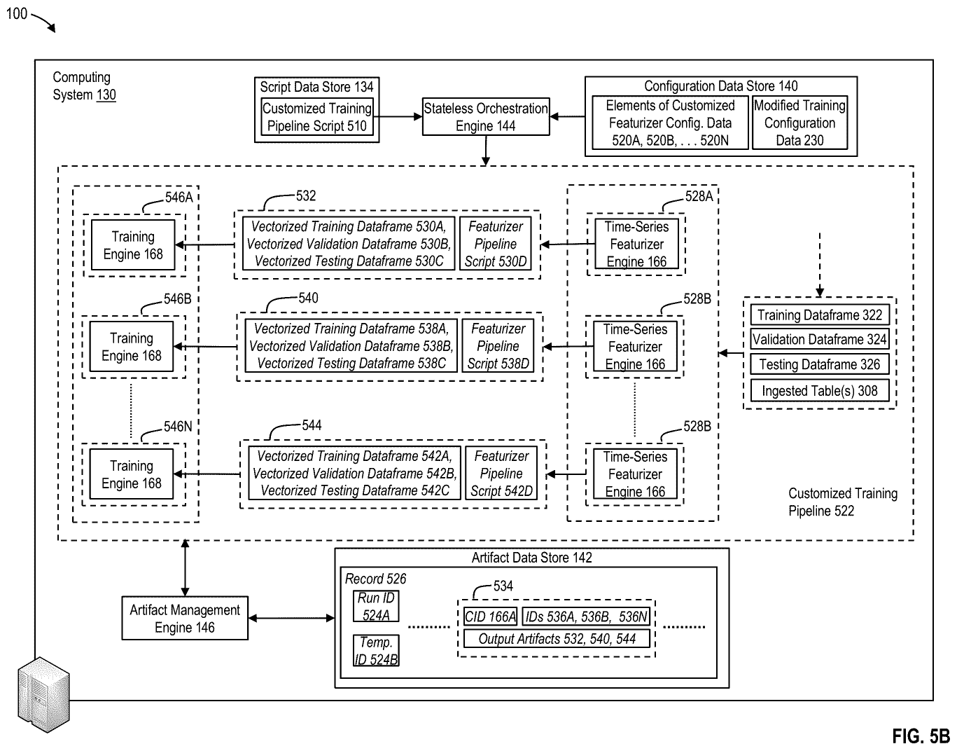

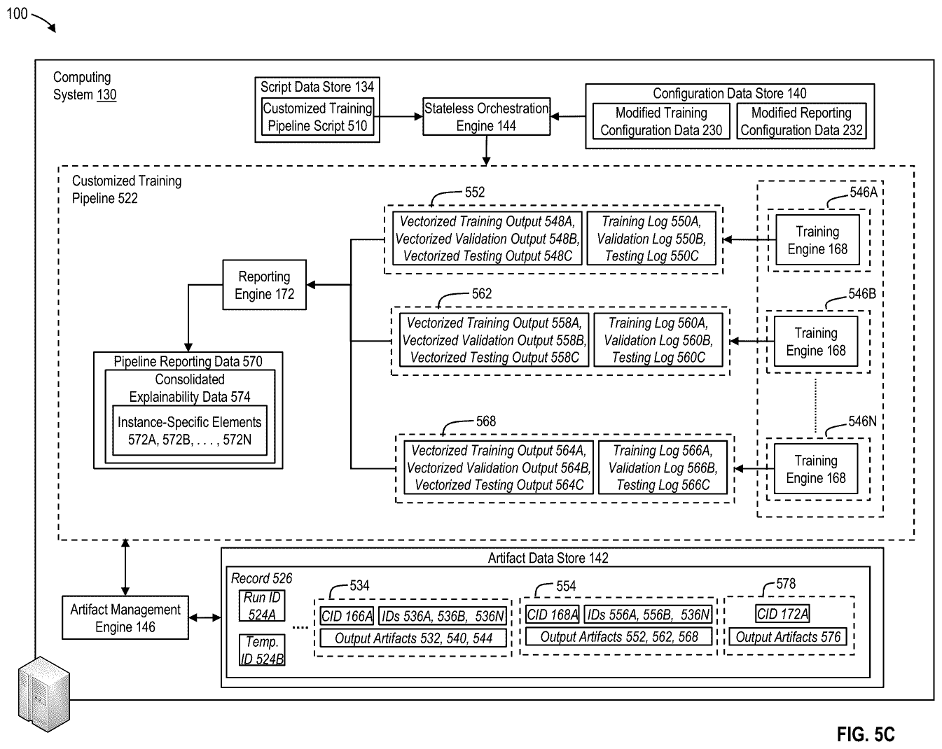

For example, based on input provisioned to computing system 130 by developer 103 (e.g., via display device 110), executed web browser 108 of developer system 102 may perform any of the exemplary processes described herein to access not only the elements of modified featurizer configuration data 228 maintained within configuration data store 140, but also to access training pipeline script 150 maintained within script data store 136, and to store locally (e.g., within memory 104) training pipeline script 150 and the elements of modified featurizer configuration data 228. Referring to FIG. 5A, executed web browser 108 may also perform operations, described herein, to present interface elements 502A, which provide a graphical representation of the elements of modified featurizer configuration data 228, and interface elements 502B, which provide a graphical representation of portions of training pipeline script 150, within one or more display screens of digital interface 216, e.g., via display device 110.

As described herein, the elements of modified featurizer configuration data 228 may specify a sequential order of feature values within a corresponding feature vector that reflects the particular use-case of interest to developer 103. For example, and as described herein, the elements of modified featurizer configuration data 228 may identify the one or more declared feature groups within the corresponding feature vector (and further, a sequential ordering of the declared feature groups within the corresponding feature vector), and for each of the declared feature groups, the elements of modified featurizer configuration data 228 may also identify each of the one or more discrete features associated with the declared feature group (and the sequential position of these featured within the declared feature group), the corresponding one of the processed data tables associated with the declared feature group, the duration of the prior lookback interval and the group-specific aggregation operation, and additionally, or alternatively, the group-specific post-processing operation, associated with the declared feature group. Further, training pipeline script 150 may specify the execution flow of default training pipeline 302, e.g., the sequential execution of retrieval engine 156, preprocessing engine 158, indexing engine 160, target-generation engine 162, time-series splitting engine 164, time-series featurizer engine 166, training engine 168, and reporting engine 172.

In some instances, and based on a review of interface elements 502A within the one or more display screens of digital interface 216, developer 103 may provide, to input device 112, elements of developer input 504A that modify and customize one or more of the elements of featurizer configuration data 167 to specify a composition and structure of not a single feature vector, but a plurality of discrete feature vectors having corresponding, and distinct, compositions and structures. By way of example, for each of the discrete feature vectors, the elements of developer input 218D may include a discrete identifier (e.g., a numeric identifier, an alphanumeric string that delimits each feature vector, etc.), and the data described herein that specifies each of the declared feature groups, the discrete features within each of the discrete feature groups, the corresponding, group-specific, prior lookback interval (e.g., the sixty-day prior lookback interval described herein), and the corresponding, group-specific aggregation and/or post-processing operations. In some instances, executed web browser 108 may store the customized elements of modified featurizer configuration data 228 in a portion of memory 104, e.g., modified featurizer configuration data 506.

Further, and based on a review of interface elements 502B across the one or more display screens of digital interface 216, developer 103 may determine that training pipeline script 150 includes a first portion, e.g., an initial training script element 508, associated with the sequential execution of retrieval engine 156, preprocessing engine 158, indexing engine 160, target-generation engine 162, and time-series splitting engine 164 within default training pipeline 302, and a second portion, e.g., a subsequent training script element, associated with the sequential execution of time-series featurizer engine 166, training engine 168, and reporting engine 172 within default training pipeline 302. In some instances, developer 103 may elect to maintain initial training script element 508 within a customized training pipeline script, and to provide additional input to input device 112, that causes developer system 102 to modify an execution flow of default training pipeline 302 and facilitate an implementation of one or more of the exemplary feature-generation and training processes across multiple, discrete feature vectors within a corresponding, customized training pipeline.

For example, and based on developer input 504B provisioned to input device 112 by developer 103, developer system 102 may generate, and store within memory 104, a customized training pipeline script 510 that includes initial training script element 508. Further, and based on portions of developer input 504B, developer system 102 may perform operations that generate a customized inferencing training element 512 implementation of one or more of the exemplary feature-generation and training processes across multiple, discrete feature vectors, and that insert customized inferencing training element 512 into a position within customized training pipeline script 510 subsequent to initial training script element 508. In some instances, upon execution by the one or more processors of computing system 130 (e.g., based on programmatic commands generated by executed orchestration engine 144), customized inferencing training element 512 may facilitate, within a customized training pipeline, an execution of multiple instances of time-series featurizer engine 166 (e.g., each of which ingest elements of configuration data characterizing a corresponding one of the discrete feature vectors as input artifacts, and each of which generate corresponding, vectorized training, validation, and testing dataframes as output artifacts), an execution of multiple instances of training engine 168 (e.g., each of which ingest vectorized training, validation, and testing dataframes associated with a corresponding one of the discrete feature vectors as input artifacts, and each of which generate elements of vectorized training, validation, and testing output as output artifacts associated with the corresponding one of the discrete feature vectors), and an execution of reporting engine 172, which ingests the elements of vectorized training, validation, and testing output associated with each of the discrete feature vectors, and generates corresponding elements of explainability data characterizing the relative importance of the features across the discrete feature vectors. Executed web browser 108 may perform operations that store customized training pipeline script 510, which includes initial training script element 508 and customized inferencing training element 512, within a portion of memory 104.

Web browser 108 may perform operations that packages modified featurizer configuration data 506 and customized training pipeline script 510, which includes initial training script element 508 and customized inferencing training element 512, into corresponding portions of a customization request 514, along with an identifier of default training pipeline 302. In some instances, executed web browser 108 may also package, into an additional portion of customization request 514, the one or more identifiers of developer system 102 or executed web browser 108, such as the exemplary identifiers described herein. Executed web browser 108 may also perform operations that cause developer system 102 to transmit customization request 514 across communications network 120 to computing system 130, e.g., via the secure, programmatic channel of communications established between executed web browser 108 and programmatic web service 148 executed by the one or more processors of computing system 130.

Customization API 206 of executed customization application 204 may receive customization request 514, and perform any of the exemplary processes described herein to determine that computing system 130 permits a source of customization request 514, e.g., developer system 102 or executed web browser 108, to customize the execution flow of default training pipeline 302 and to route customization request 514 to executed customization application 204. Executed customization application 204 may obtain the identifier of default training pipeline 302, modified featurizer configuration data 506 and customized training pipeline script 510, which includes initial training script element 508 and customized inferencing training element 512, from customization request 514. In some instances, based on the identifier, executed customization application 204 may obtain one or more elements of constraint data 516 that identify and characterize each of the engine-specific and pipeline-specific constraints imposed on, and associated with, the execution flow of default training pipeline 302, such as, but not limited to, the exemplary constraints described herein.

Based on constraint data 516, executed customization application 204 may perform operations that apply each of the engine-specific and pipeline-specific constraints associated with default training pipeline 302 to, among other things, the discrete executable script elements of customized training pipeline script 510. If, for example, executed customization application 204 were to determine an inconsistency between the discrete executable script elements of customized training pipeline script 510, and at least one of the imposed constraints (including the artifact constraints described herein), executed customization application 204 may decline to replace training pipeline script 150, which establishes default training pipeline 302, with customized training pipeline script 510. Executed customization application 204 may generate an error message indicating the detected inconsistency, and executed customization application 204 may cause computing system 130 to transmit the generated error message across network 120 to developer system 102, e.g., via the established, secure programmatic channel of communications described herein. Alternatively, if executed customization application 204 were to deem the discrete executable script elements of customized training pipeline script 510 consistent with each of the imposed constraints (including the artifact constraints described herein), executed customization application 204 may replace training pipeline script 150, which establishes default training pipeline 302, with customized training pipeline script 510 (including initial training script element 508 and customized inferencing training element 512) within script data store 136.

Further, in some instances, executed customization application 204 may also parse the elements of modified featurizer configuration data 506 and detect a presence of data characterizing multiple, discrete feature vectors, such as, but not limited to, the exemplary data elements described herein. In some examples, one or more scripts 518 executed programmatically by customization application 204 may determine a subset of the elements of modified featurizer configuration data 506 that identify and characterize each of the discrete feature vectors (e.g., based on the discrete vector identifiers, etc.), obtain each of the vector-specific element subsets from the elements of modified featurizer configuration data 506, and package the each of the vector-specific element subsets into a corresponding, vector-specific element of customized featurizer configuration data, e.g., a corresponding one of vector-specific elements 520A, 520B . . . 520N of customized featurizer configuration data.

In some instances, not illustrated in FIG. 5A, executed scripts 518 of customization application 204 may also perform operations that generate programmatically additional ones of vector-specific elements 520A, 520B. 520N of customized featurizer configuration data that characterize additional, or alternate, ones of the distinct feature operations. By way of example, executed scripts 518 may generate an additional one of the vector specific elements of customized featurizer configuration data by perturbing a prior lookback interval associated with a declared feature group within a corresponding one of vector-specific elements 520A, 520B . . . 520N, or may perform operations that generate an additional one of the vector specific elements of customized featurizer configuration data by combining elements of group-specific data extracted from a subset of vector-specific elements 520A, 520B 520N. Further, although not illustrated in FIG. 5A, executed customization application 204 may also perform any of the exemplary processes described herein to confirm that each of vector-specific elements 520A, 520B . . . 520N of customized featurizer configuration data are consistent with the engine-specific and pipeline-specific constraints associated with default training pipeline 302, and to replace the elements of modified featurizer configuration data 228 with vector-specific elements 520A, 520B . . . 520N of customized featurizer configuration data within configuration data store 140.

Referring to FIG. 5B, the one or more processors of computing system 130 may execute orchestration engine 144, which may access script data store 136 and obtain customized training pipeline script 510. Executed orchestration engine 144 may trigger an execution of customized training pipeline script 510 by the one or more processors of computing system 130, which may establish the customized training pipeline, e.g., default customized training pipeline 522. In some instances, upon execution of customized training pipeline script 510, executed orchestration engine 144 may generate a unique, alphanumeric identifier, e.g., run identifier 524A, for a current run of customized training pipeline 522 in accordance with the corresponding elements of engine-specific configuration data (e.g., which developer 103 may customize in accordance with the particular use-case of interest using any of the exemplary processes described herein), and executed orchestration engine 144 may provision run identifier 524A to artifact management engine 146 via artifact API. Executed artifact management engine 146 may perform operations that, based on run identifier 524A, associate data record 730 of artifact data store 142 with the current run of customized training pipeline 522, and that store run identifier 524A within data record 526 along with a corresponding temporal identifier 524B indicative of date at which executed orchestration engine 144 executed customized training pipeline script 510 and established customized training pipeline 522.

As described herein, customized training pipeline script 510 may include initial training script element 508 that calls or invokes sequentially retrieval engine 156, preprocessing engine 158, indexing engine 160, target-generation engine 162, and time-series splitting engine 164, and customized training script elements that calls or invokes the multiple instances of time-series featurizer engine 166 (e.g., in accordance with respective ones of vector-specific elements 520A, 520B . . . 520N of customized featurizer configuration data), the multiple instances of training engine 168 (e.g., in accordance with modified training configuration data 230), and that calls or invokes reporting engine 172 (e.g., in accordance with modified reporting configuration data 232). By way of example, executed orchestration engine 144 may trigger an execution of customized training pipeline script 510 (including initial training script element 508 and customized inferencing training element 512) by the one or more processors of computing system 130, which may establish customized training pipeline 522 that facilitates an implementation of one or more of the exemplary feature-generation and training processes across multiple, discrete feature vectors, and that reflects further use-case of interest to developer 103, while maintaining compliance with the one or more process-validation operations or requirements and with the one or more governmental or regulatory requirements, and further, while reducing the consumption of the processing, memory, network, and other computational resources associated with successive implementations of default training pipeline 302.

Consistent with executed customized training pipeline script 510, executed orchestration engine 144 may trigger a sequential execution, by the one or more processors of computing system 130, retrieval engine 156, preprocessing engine 158, indexing engine 160, target-generation engine 162, and time-series splitting engine 164 within a current implementation, or run, of customized training pipeline 522. Although not illustrated in FIG. 5B, executed retrieval engine 156 may perform any of the exemplary processes described herein to obtain one or more source data tables from source data store 134 in accordance with the elements of modified retrieval configuration data 222, executed preprocessing engine 158 may perform any of the exemplary processes described herein, consistent with the elements of preprocessing configuration data 159, to ingest the one or more source data tables, and to generate one or more ingested data tables based on an application of one or more preprocessing operations to the one or more source data tables.

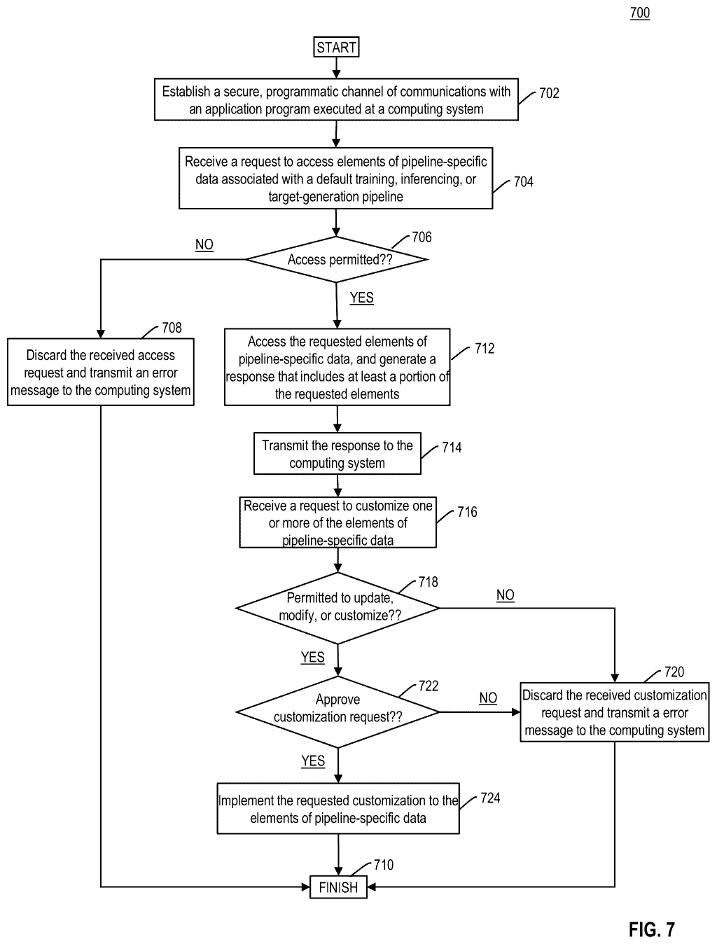

Further, while not illustrated in FIG. 7B, executed indexing engine 160 may perform any of the exemplary processes described herein, consistent with the elements of indexing configuration data 161, that generate a training PKI dataframe having discrete rows associated with corresponding ones of the subset of the customers associated with the use-case of interest to developer 103 (e.g., including a corresponding user identifier) and that reference a corresponding prediction date (e.g., an initiation time or date of the current run of customized training pipeline 522), and executed target-generation engine 162 may perform any of the exemplary processes described herein, may perform any of the exemplary processes described herein, consistent with the elements of modified target-generation configuration data 224, that generate, for each row of the training PKI dataframe, a corresponding ground-truth label indicative of the occurrence, or non-occurrence, of the target event associated with the use-case of interest to developer 103 during the future target temporal interval, and that generate a labelled PKI data frame that includes each row of the PKI dataframe and the corresponding, and appended, one of the ground-truth labels. Additionally, although not illustrated in FIG. 5B, executed splitting engine 164 may perform any of the exemplary processes described herein, consistent with the elements of modified splitting configuration data 226, that partition the rows of the labelled PKI dataframe into corresponding dataframes associated with a training, validation, and testing interval, and that generate, as output artifacts, corresponding ones of a training dataframe, a validation dataframe, and a testing dataframe, such as, but not limited to training dataframe 322, validation dataframe 324, and a testing dataframe 326 of FIGS. 3A and 3B. Executed splitting engine 164 may also perform operations that generate, as output artifacts, elements of sampling data, such as splitting data 328, that characterize the temporal boundaries of the training, validation, and testing intervals.

Referring back to FIG. 5B, and consistent with executed customized training pipeline script 510, executed orchestration engine 144 may trigger an execution of a plurality of discrete instances of time-series featurizer engine 166 by the one or more processors of computing system 130, such as, but not limited to, instances 528A, 528B, . . . , and 528N. For example, and as described herein, the one or more processors of computing system 130 may establish collectively a plurality of interconnected, distributed computing components, which may be configured to implement one or more parallelized, fault-tolerant distributed computing and analytical processes. In some instances, executed orchestration engine 144 may perform operations, consistent with executed customized training pipeline script 510, that trigger an execution in parallel of each of instances 528A, 528B, . . . , and 528N of time-series featurizer engine 166 across corresponding ones of the distributed computing components of computing system 130, e.g., via one or more parallelized, fault-tolerant distributed computing and analytical processes described herein. Additionally, in some examples, executed orchestration engine 144 may perform operations that cause the one or more processors of computing system 130 to instantiate a plurality of virtual machines, and that provision time-series featurizer engine 166 and corresponding ones of the input artifacts described herein to each of the instantiated virtual machines, which may executed corresponding ones of instances 528A, 528B, . . . , and 528N of time-series featurizer engine 166.

In some examples, each of the discrete instances of executed training engine 160 may ingest, as input artifacts, one or more of the pre-processed source data tables described herein, such as ingested data tables 308, and corresponding ones of training dataframe 322, validation dataframe 324, and testing dataframe 326, along with splitting data 328, e.g., based on programmatic interactions with executed orchestration engine 144. Further, each instance of executed time-series featurizer engine 166 may also ingest, as an input artifact, a corresponding one of vector-specific elements 520A, 520B . . . 520N of customized featurizer configuration data. For example, as illustrated in FIG. 5B, instance 528A of executed time-series featurizer engine 166 may ingest vector-specific element 520A of customized featurizer configuration data as an input artifact, instance 528B of executed time-series featurizer engine 166 may ingest vector-specific element 520B of customized featurizer configuration data as an input artifact, and instance 528N of executed time-series featurizer engine 166 may ingest vector-specific element 520N of customized featurizer configuration data as an input artifact, and as described herein, each of vector-specific elements 520A, 520B . . . 520N of customized featurizer configuration data may be associated with, and may characterize a composition and structure, of a corresponding one of the discrete feature vectors.

Based on an established consistency of the input artifacts with the imposed engine- and pipeline-specific operational constraints (e.g., via a corresponding programmatic interface), each instance of executed time-series featurizer engine 166 may perform one or more of the exemplary processes described herein that, consistent with the corresponding, vector-specific elements 520A, 520B . . . 520N of customized featurizer configuration data, generate a corresponding one of the discrete feature vectors for each row of training dataframe 322, validation dataframe 324, and testing dataframe 326. For example, using any of the exemplary processes described herein, each instance of executed time-series featurizer engine 166 may generate the corresponding one of the discrete feature vectors for each row of training dataframe 322, validation dataframe 324, and testing dataframe 326 based on, among other things, an application of the group-specific aggregation operations and the group-specific post-processing operations to processed partitions of ingested data table(s) 308 associated with each of training dataframe 322, validation dataframe 324, and testing dataframe 326 during corresponding ones of the group-specific, prior lookback intervals (e.g., as specified with the corresponding ones of vector-specific elements 520A, 520B . . . 520N of customized featurizer configuration data). Further, each of instance of executed time-series featurizer engine 166 may perform operations, described herein, that append each of the generated, row-specific feature vectors to a corresponding row of row of training dataframe 322, validation dataframe 324, and testing dataframe 326, and that generate a vectorized training, validation, and testing dataframe that includes corresponding ones of training dataframe 322 and the appended row-specific feature vectors, validation dataframe 324 and the appended row-specific feature vectors, and testing dataframe 326 and the appended row-specific feature vectors.

By way of example, executed orchestration engine 144 may provision training dataframe 322, validation dataframe 324, and testing dataframe 326, and ingested data table(s) 308, as input artifacts to each of instances 528A, 528B, . . . , and 528N of executed time-series featurizer engine 166. As illustrated in FIG. 5B, executed orchestration engine 144 may also provision vector-specific elements 520A of customized featurizer configuration data as a further input artifact of instance 528A of executed time-series featurizer engine 166. As described herein, vector-specific elements 520A of customized featurizer configuration data may characterize a composition and structure of a first one of the discrete feature vectors (e.g., a first feature vector), and may specify each of the declared feature groups, the discrete features within each of the discrete feature groups, the corresponding, group-specific, prior lookback interval, and the corresponding, group-specific aggregation and/or post-processing operations. Based on the provisioned input artifacts, instance 528A of executed time-series featurizer engine 166 may perform any of the exemplary processes described herein to generate a row-specific one of the first feature vector for each row of training dataframe 322, validation dataframe 324, and testing dataframe 326, e.g., based on, among other things, an application of the group-specific aggregation operations and the group-specific post-processing operations to processed partitions of ingested data table(s) 308 associated with each of training dataframe 322, validation dataframe 324, and testing dataframe 326 during corresponding ones of the group-specific, prior lookback intervals.

Instance 528A of executed time-series featurizer engine 166 may also perform any of the exemplary processes described herein to append a corresponding, row-specific one of the first feature vectors to each row of training dataframe 322, and generate a vectorized training dataframe 530A that includes training dataframe 322 and the appended, row-specific ones of the first feature vectors. Instance 528A of executed time-series featurizer engine 166 may operations, described herein, that generate a vectorized validation dataframe 530B (e.g., that includes validation dataframe 324 and appended, row-specific ones of the first feature vectors) and a vectorized testing dataframe 530C (e.g., that includes testing dataframe 326 and appended, row-specific ones of the first feature vectors). Further, instance 528A of executed time-series featurizer engine 166 may perform any of the exemplary processes described herein to generate a featurizer pipeline script 530D that include elements of executable code (e.g., in Python™ format) that, upon execution by the one or more processors of computing system 130, may establish a “featurizer pipeline” of sequentially executed ones of the mapped, default stateless aggregation and post-processing operations associated each of the declared feature groups, and the corresponding discrete features, of the first feature vector.

Further, in some examples, instance 528A of executed time-series featurizer engine 166 may also provision vectorized training dataframe 530A, vectorized validation dataframe 530B, and vectorized testing dataframe 530C, and featurizer pipeline script 530D (and in some instances, the pre-processed training, validation, and testing data tables described herein) to executed artifact management engine 146 as instance-specific output artifacts, e.g., output artifacts 532, within customized training pipeline 522. In some instances, executed artifact management engine 146 may receive each of output artifacts 532, and may perform operations that package each of output artifacts 532 into a corresponding portion of featurizer artifact data 534, along with a unique component identifier 166A of executed time-series featurizer engine 166 and a unique identifier 536A of instance 528A (e.g., a unique alphanumeric identifier), and that store featurizer artifact data 534 within a corresponding portion of artifact data store 142, e.g., within data record 526 associated with customized training pipeline 522 and run identifier 524A. Further, although not illustrated in FIG. 5B, executed artifact management engine 146 may also package, into a corresponding portion of featurizer artifact data 534, additional data identifying and characterizing one or more of the input artifacts ingested by instance 528A of executed time-series featurizer engine 166, such as, but not limited to, training dataframe 322, validation dataframe 324, testing dataframe 326, and splitting data 328.

Referring back to FIG. 5B, executed orchestration engine 144 may also provision vector-specific elements 520B of customized featurizer configuration data as a further input artifact of instance 528B of executed time-series featurizer engine 166. As described herein, vector-specific elements 520B of customized featurizer configuration data may characterize a composition and structure of a second one of the discrete feature vectors (e.g., a second feature vector), and specify each of the declared feature groups, the discrete features within each of the discrete feature groups, the corresponding, group-specific, prior lookback interval, and the corresponding, group-specific aggregation and/or post-processing operations for the second feature vector. Based on the provisioned input artifacts, instance 528B of executed time-series featurizer engine 166 may perform any of the exemplary processes described herein to generate a row-specific one of the second feature vector for each row of training dataframe 322, validation dataframe 324, and testing dataframe 326, e.g., based on, among other things, an application of the group-specific aggregation operations and the group-specific post-processing operations to processed partitions of ingested data table(s) 308 associated with each of training dataframe 322, validation dataframe 324, and testing dataframe 326 during corresponding ones of the group-specific, prior lookback intervals.

Instance 528B of executed time-series featurizer engine 166 may also perform any of the exemplary processes described herein to generate a vectorized training dataframe 538A (e.g., that includes training dataframe 322 and appended, row-specific ones of the second feature vectors), a vectorized validation dataframe 538B (e.g., that includes validation dataframe 324 and appended, row-specific ones of the second feature vectors) and a vectorized testing dataframe 538C (e.g., that includes testing dataframe 326 and appended, row-specific ones of the second feature vectors). Further, instance 528B of executed time-series featurizer engine 166 may perform any of the exemplary processes described herein to generate a featurizer pipeline script 538D that include elements of executable code (e.g., in Python™ format) that, upon execution by the one or more processors of computing system 130, may establish a “featurizer pipeline” of sequentially executed ones of the mapped, default stateless aggregation and post-processing operations associated each of the declared feature groups, and the corresponding discrete features, of the second feature vector.

Further, in some examples, instance 528B of executed time-series featurizer engine 166 may also provision vectorized training dataframe 538A, vectorized validation dataframe 538B, and vectorized testing dataframe 538C, and featurizer pipeline script 538D (and in some instances, the pre-processed training, validation, and testing data tables described herein) to executed artifact management engine 146, e.g., as instance-specific output artifacts 540 within customized training pipeline 522. As described herein, executed artifact management engine 146 may package each of output artifacts 540 into an additional portion of featurizer artifact data 534, along with a unique identifier 536B of instance 528B. Further, although not illustrated in FIG. 5B, executed artifact management engine 146 may also package, into a corresponding portion of featurizer artifact data 534, additional data identifying and characterizing one or more of the input artifacts ingested by instance 528B of executed time-series featurizer engine 166.

Executed orchestration engine 144 may also provision further vector-specific elements of customized featurizer configuration data as an input artifact to each additional, or alternate, instance of executed time-series featurizer engine 166. For example, executed orchestration engine 144 may provision, as a further input artifact to instance 528N of executed time-series featurizer engine 166, vector-specific elements 520N of customized featurizer configuration data, which may characterize a composition and structure of a final one of the discrete feature vectors (e.g., a final feature vector), and which specify each of the declared feature groups, the discrete features within each of the discrete feature groups, the corresponding, group-specific, prior lookback interval, and the corresponding, group-specific aggregation and/or post-processing operations for the final feature vector.

Based on the provisioned input artifacts, instance 528N of executed time-series featurizer engine 166 may perform any of the exemplary processes described herein to generate a row-specific one of the second feature vector for each row of training dataframe 322, validation dataframe 324, and testing dataframe 326, e.g., based on, among other things, an application of the group-specific aggregation operations and the group-specific post-processing operations to processed partitions of ingested data table(s) 308 associated with each of training dataframe 322, validation dataframe 324, and testing dataframe 326 during corresponding ones of the group-specific, prior lookback intervals. Instance 528B of executed time-series featurizer engine 166 may also perform any of the exemplary processes described herein to generate a vectorized training dataframe 542A (e.g., that includes training dataframe 322 and appended, row-specific ones of the second feature vectors), a vectorized validation dataframe 542B (e.g., that includes validation dataframe 324 and appended, row-specific ones of the second feature vectors) and a vectorized testing dataframe 542C (e.g., that includes testing dataframe 326 and appended, row-specific ones of the second feature vectors). Further, instance 528N of executed time-series featurizer engine 166 may perform any of the exemplary processes described herein to generate a featurizer pipeline script 542D that include elements of executable code (e.g., in Python™ format) that, upon execution by the one or more processors of computing system 130, may establish a “featurizer pipeline” of sequentially executed ones of the mapped, default stateless aggregation and post-processing operations associated each of the declared feature groups, and the corresponding discrete features, of the final feature vector.

Instance 528N of executed time-series featurizer engine 166 may also provision vectorized training dataframe 542A, vectorized validation dataframe 542B, and vectorized testing dataframe 542C, and featurizer pipeline script 542D (and in some instances, the pre-processed training, validation, and testing data tables described herein) to executed artifact management engine 146, e.g., as instance-specific output artifacts 544 within customized training pipeline 522. As described herein, executed artifact management engine 146 may package each of output artifacts 544 into a further portion of featurizer artifact data 534, along with a unique identifier 536N of instance 528N. Further, although not illustrated in FIG. 5B, executed artifact management engine 146 may also package, into a corresponding portion of featurizer artifact data 534, additional data identifying and characterizing one or more of the input artifacts ingested by instance 528N of executed time-series featurizer engine 166.

Further, as illustrated in FIG. 5B, and consistent with executed customized training pipeline script 510, executed orchestration engine 144 may also trigger an execution of a plurality of discrete instances of training engine 168 by the one or more processors of computing system 130, such as, but not limited to, instances 546A, 546B, . . . 546N. For example, and as described herein, the one or more processors of computing system 130 may establish collectively a plurality of interconnected, distributed computing components, which may be configured to implement one or more parallelized, fault-tolerant distributed computing and analytical processes. In some instances, executed orchestration engine 144 may perform operations, consistent with executed customized training pipeline script 510, that trigger an execution in parallel of each of instances 546A, 546B, . . . , and 546N of training engine 168 across corresponding ones of the distributed computing components of computing system 130, e.g., via one or more parallelized, fault-tolerant distributed computing and analytical processes described herein. Additionally, in some examples, executed orchestration engine 144 may perform operations that cause the one or more processors of computing system 130 to instantiate a plurality of virtual machines, and that provision time-series featurizer engine 166 and corresponding ones of the input artifacts described herein to each of the instantiated virtual machines, which may execute corresponding ones of instances 546A, 546B, . . . 546N of training engine 168.

In some examples, in accordance with executed customized training pipeline script 510, executed orchestration engine 144 may provision the elements of modified training configuration data 230 to each of instances 546A, 546B, . . . , and 546N of executed training engine 168, e.g., as input artifacts. Further, executed orchestration engine 144 may also perform operations that provision, to each of instances 546A, 546B, . . . , and 546N of executed training engine 168, the vectorized training, validation, and testing dataframes generated by a corresponding one of the instances 528A, 528B, . . . , and 528N of executed time-series featurizer engine 166, e.g., as further input artifacts. For example, as illustrated in FIG. 5B, instance 546A of executed training engine 168 may receive vectorized training dataframe 530A, vectorized validation dataframe 530B, and vectorized testing dataframe 530C (e.g., generated by instance 528A of executed time-series featurizer engine 166) as further input artifacts, instance 546B of executed training engine 168 may receive vectorized training dataframe 538A, vectorized validation dataframe 538B, and vectorized testing dataframe 538C (e.g., generated by instance 528B of executed time-series featurizer engine 166) as further input artifacts, and instance 546N of executed training engine 168 may receive vectorized training dataframe 542A, vectorized validation dataframe 542B, and vectorized testing dataframe 542C (e.g., generated by instance 528N of executed time-series featurizer engine 166) as further input artifacts.

Based on an established consistency of the input artifacts with the imposed engine- and pipeline-specific operational constraints (e.g., via a corresponding programmatic interface), each of instances 546A, 546B, . . . , and 546N of executed training engine 168 may perform operations, described herein, that instantiate the forward-in-time machine-learning process in accordance with the value of the one or more process parameters specified within the elements of modified training configuration data 230, and that apply the instantiated, forward in-time, machine-learning process to each row of the ingested vectorized training, validation, and testing dataframes. As described herein, developer 103 may elect to train a gradient-boosted, decision-tree process (e.g., an XGBoost process), to predict a likelihood of an occurrence, or a non-occurrence, of a targeted event involving one or more users during a future, target temporal interval, and the elements of modified training configuration data 230 may include data that identifies the gradient-boosted, decision-tree process (e.g., a helper class or script associated with the XGBoost process and capable of invocation within the namespace of executed training engine 168) and a value of one or more default parameters of the gradient-boosted, decision-tree process.

In some instances, each of instances 546A, 546B, . . . , and 546N of executed training engine 168 may perform operations that instantiate the gradient-boosted, decision-tree process (e.g., the XGBoost process) in accordance with the default parameter values within the elements of modified training configuration data 230, and to apply the instantiated, gradient-boosted, decision-tree process to each row of corresponding ones of the ingested vectorized training, validation, and testing dataframes. By way of example, each of instances 546A, 546B, . . . , and 546N of executed training engine 168 may perform operations that establish a plurality of nodes and a plurality of decision trees for the gradient-boosted, decision-tree process, each of which receive, as inputs, respective rows of the ingested vectorized training, validation, and testing dataframes.

As illustrated in FIG. 5B, instance 546A of executed training engine 168 may perform any of the exemplary processes described herein to establish a plurality of nodes and a plurality of decision trees for the gradient-boosted, decision-tree process, which receive, as inputs, corresponding rows of vectorized training dataframe 530A, vectorized validation dataframe 530B, and vectorized testing dataframe 530C. Further, instance 546B of executed training engine 168 may perform any of the exemplary processes described herein to establish a plurality of nodes and a plurality of decision trees for the gradient-boosted, decision-tree process, which receive, as inputs, corresponding rows of vectorized training dataframe 538A, vectorized validation dataframe 538B, and vectorized testing dataframe 538C, and instance 546N of executed training engine 168 may perform any of the exemplary processes described herein to establish a plurality of nodes and a plurality of decision trees for the gradient-boosted, decision-tree process, which receive, as inputs, corresponding rows of vectorized training dataframe 542A, vectorized validation dataframe 542B, and vectorized training dataframe 542C.

Based on the application of the instantiated, forward-in-time machine-learning process (e.g., the gradient-boosted, decision-tree process described herein, etc.) to the corresponding rows of the ingested vectorized training, validation, and testing dataframes, each of instances 546A, 546B, . . . , and 546N of executed training engine 168 may perform any of the exemplary processes described herein to: (i) generate corresponding elements of training, validation, and testing output data; and (ii) corresponding elements of training, validation, and testing log data that characterize the application of the forward-in-time machine-learning process to the rows of respective ones of the ingested, vectorized training, validation, and testing dataframes.

Referring to FIG. 5C, and based on the application of the forward-in-time machine-learning process to each of the rows of vectorized training dataframe 530A, instance 546A of executed training engine 168 may generate a row-specific elements of training output data, and may perform any of the exemplary processes described herein to append each of the row-specific elements of training output data to a corresponding row of vectorized training dataframe 530A, and to generate vectorized training output 548A that includes vectorized training dataframe 530A and the appended, row-specific elements of the training output data. Further, and based on the application of the forward-in-time machine-learning process to each of the rows of vectorized training dataframe 530A, instance 546A of executed training engine 168 may generate one or more elements of training log data 550A that characterize the application of the instantiated machine-learning process to the each row of vectorized training dataframe 530A.

Based on the application of the forward-in-time machine-learning process to each of the rows of vectorized validation dataframe 530B, instance 546A of executed training engine 168 may also perform any of the exemplary processes described herein to generate vectorized validation output 548B, which includes vectorized validation dataframe 530B and appended, row-specific elements of validation output data, and to generate one or more elements of validation log data 550B that characterize the application of the instantiated machine-learning process to the each row of vectorized validation dataframe 530B. Further, and based on the application of the forward-in-time machine-learning process to each of the rows of vectorized testing dataframe 530C, instance 546A of executed training engine 168 may perform any of the exemplary processes described herein to generate vectorized testing output 548C, which includes vectorized testing dataframe 530C and appended, row-specific elements of testing output data, and to generate one or more elements of testing log data 550C that characterize the application of the instantiated machine-learning process to the each row of vectorized testing dataframe 530C.

As described herein, the row-specific elements of the training, validation, and the testing output may each indicate, for the values of the primary keys within each of respective rows of vectorized training dataframe 530A, vectorized validation dataframe 530B, and vectorized testing dataframe 530C (e.g., the alphanumeric, user identifier and the timestamp, as described herein), an element of output data indicative of the predicted likelihood of the occurrence, or non-occurrence, of the targeted, developer-specified event within the future target temporal interval, e.g., subsequent to the corresponding, row-specific timestamp. Further, and by way of example, the elements of training log data 550A, validation log data 550B, and testing log data 550C may characterize a success, or alternatively, a failure, in the application of the instantiated machine-learning process to the rows of corresponding ones of vectorized training dataframe 354, vectorized validation dataframe 356, and vectorized testing dataframe 358, and may include any of the exemplary run, dataframe, and output identifiers, any of the exemplary elements of performance data, and any of the exemplary process parameter values described wherein.

Referring back to FIG. 5C, instance 546A of executed training engine 168 may also provision vectorized training output 548A, vectorized validation output 548B, and vectorized testing output 548C, and the elements of training log data 550A, validation log data 550B, and testing log data 550C, as to executed artifact management engine 146 as instance-specific output artifacts, e.g., output artifacts 552, within customized training pipeline 522. In some instances, executed artifact management engine 146 may receive each of output artifacts 552, and may perform operations that package each of output artifacts 552 into a corresponding portion of training artifact data 554, along with a unique component identifier 168A of executed training engine 168 and a unique identifier 556A of instance 546A (e.g., a unique alphanumeric identifier), and that store featurizer artifact data 534 within a corresponding portion of artifact data store 142, e.g., within data record 526 associated with customized training pipeline 522 and run identifier 524A. Further, although not illustrated in FIG. 5C, executed artifact management engine 146 may also package, into a corresponding portion of training artifact data 554, additional data identifying and characterizing one or more of the input artifacts ingested by instance 546A of executed time-series featurizer engine 166, such as, but not limited to, those described herein.

Further, based on the application of the forward-in-time machine-learning process to each of the rows of vectorized training dataframe 538A, vectorized validation dataframe 538B, and vectorized testing dataframe 538C, instance 546B of executed training engine 168 may perform any of the exemplary processes described herein to generate vectorized training output 558A (e.g., including vectorized training dataframe 538A and appended, row-specific elements of training output data), vectorized validation output 558B (e.g., including vectorized validation dataframe 538B and appended, row-specific elements of validation output data), and vectorized testing output 548C, which includes vectorized testing dataframe 530C and appended, row-specific elements of testing output data). Instance 546B of executed training engine 168 may also perform any of the exemplary processes described herein to generate elements of training log data 560A, validation log data 560B, and testing log data 560C that characterize the application of the instantiated machine-learning process to the corresponding rows of vectorized training dataframe 538A, vectorized validation dataframe 538B, and vectorized testing dataframe 538C.

As described herein, instance 546B of executed training engine 168 may provision vectorized training output 558A, vectorized validation output 558B, and vectorized testing output 558C, and the elements of training log data 560A, validation log data 560B, and testing log data 560C, as to executed artifact management engine 146 as additional, instance-specific output artifacts, e.g., output artifacts 562, within customized training pipeline 522. In some instances, executed artifact management engine 146 may receive each of output artifacts 562, and may perform operations that package each of output artifacts 562 into a corresponding portion of training artifact data 554, along with a unique identifier 556B of instance 546B (e.g., a unique alphanumeric identifier). Further, although not illustrated in FIG. 5C, executed artifact management engine 146 may also package, into a corresponding portion of training artifact data 554, additional data identifying and characterizing one or more of the input artifacts ingested by instance 546B, such as, but not limited to, those described herein.

Referring back to FIG. 5C, and based on the application of the forward-in-time machine-learning process to each of the rows of vectorized training dataframe 542A, vectorized validation dataframe 542B, and vectorized testing dataframe 542C, instance 546N of executed training engine 168 may perform any of the exemplary processes described herein to generate vectorized training output 564A (e.g., including vectorized training dataframe 542A and appended, row-specific elements of training output data), vectorized validation output 564B (e.g., including vectorized validation dataframe 542B and appended, row-specific elements of validation output data), and vectorized testing output 564C, which includes vectorized testing dataframe 542C and appended, row-specific elements of testing output data). Instance 546N of executed training engine 168 may also perform any of the exemplary processes described herein to generate elements of training log data 566A, validation log data 566B, and testing log data 566C that characterize the application of the instantiated machine-learning process to the corresponding rows of vectorized training dataframe 542A, vectorized validation dataframe 542B, and vectorized testing dataframe 542C.

Instance 546N of executed training engine 168 may provision vectorized training output 564A, vectorized validation output 564B, and vectorized testing output 564C, and the elements of training log data 566A, validation log data 566B, and testing log data 566C, as to executed artifact management engine 146 as further, instance-specific output artifacts, e.g., output artifacts 568, within customized training pipeline 522. In some instances, executed artifact management engine 146 may receive each of output artifacts 568, and may perform operations that package each of output artifacts 562 into a corresponding portion of training artifact data 554, along with a unique identifier 556N of instance 546N (e.g., a unique alphanumeric identifier). Further, although not illustrated in FIG. 5C, executed artifact management engine 146 may also package, into a corresponding portion of training artifact data 554, additional data identifying and characterizing one or more of the input artifacts ingested by instance 546N, such as, but not limited to, those described herein.

In accordance with executed customized training pipeline script 510, executed orchestration engine 144 may provision the elements of modified reporting configuration data 232 as inputs to reporting engine 172 executed by the one or more processors of computing system 130, e.g., as input artifacts. Further, each of instances 546A, 546B, . . . , and 546N of executed training engine 168 may also provision each of output artifacts 552, 562, and 568, including the instance-specific vectorized training, validation, and testing output, and the instance-specific elements of training, validation, and testing log data, as further inputs to executed reporting engine 172 (e.g., as further input artifacts). In some instances, executed orchestration engine 144 may also provision, to executed reporting engine 172, output artifacts generated by respective ones of retrieval engine 156, preprocessing engine 158, indexing engine 160, target-generation engine 162, time-series splitting engine 164, time-series featurizer engine 166, executed sequentially during the current run of customized training pipeline 522, including, but not limited to, instance-specific training output artifacts 532, 540, and 544.

Based on an established consistency of the input artifacts with the imposed engine- and pipeline-specific operational constraints (e.g., via the corresponding programmatic interface), executed reporting engine 172 may perform operations any of the exemplary processes described herein, consistent with the elements of reporting configuration data 232, that generate elements of pipeline reporting data 570 characterizing an operation and a performance of the discrete, modular components executed by the one or more processors of computing system 130 within customized training pipeline 522, and that characterize the predictive performance, predictive accuracy, and fairness and bias of the machine-learning process during application to corresponding ones of vectorized training, validation, and testing dataframes the customized training pipeline 522. The elements of modified reporting configuration data 232 may specify a default composition of pipeline reporting data 570 and a customized format of pipeline reporting data 384, e.g., DOCX format, and examples of pipeline reporting data 570 may include, but are not limited to, the exemplary elements of process, composition, fairness data described herein, e.g., with respect to default training pipeline 302.

Further, in some examples, executed reporting engine 172 may also access the elements of vectorized training, validation, and testing output, and the elements of training, validation, and testing logs, generated by each of the instances of executed training engine 168, such as, but not limited to, instances 546A, 546B, . . . , and 546N of executed training engine 168. Consistent with the elements of modified reporting configuration data 232, executed reporting engine 172 may perform any of the exemplary processes described herein to generate instance-specific elements 572A, 572B, . . . , and 572N of explainability data, which characterize the predictive performance and accuracy of the forward-in-time machine-learning process during application to a respective one of vectorized training, validation, and testing dataframes by corresponding ones of instances 546A, 546B, . . . , and 546N of executed training engine 168.

By way of example, the instance-specific elements 572A of explainability data may include one or more Shapley values that characterize a relative importance of each of the discrete features of the first one of the discrete feature vectors (e.g., the first feature vector described herein), and that characterize a relative contribution of each of the discrete features to the predictive output of the forward-in-time, machine-learning process and/or a reliance of the forward-in-time, machine-learning process on a pairwise interactions between the discrete features (e.g., upon application to the feature vectors maintained within the respective one of vectorized training dataframe 530A, vectorized validation dataframe 530B, and vectorized testing dataframe 530C). The instance-specific elements 572B of explainability data may also include one or more Shapley values that characterize a relative importance of each of the additional features of the second one of the discrete feature vectors (e.g., the second feature vector described herein), and that characterize a relative contribution of each of the additional features to the predictive output of the forward-in-time, machine-learning process and/or a reliance of the forward-in-time, machine-learning process on a pairwise interactions between the additional features.

Additionally, by way of example, the instance-specific elements 572N of explainability data may also include one or more Shapley values that characterize a relative importance of each of the further features of the final one of the discrete feature vectors (e.g., the final feature vector described herein), and that characterize a relative contribution of each of the further features to the predictive output of the forward-in-time, machine-learning process and/or a reliance of the forward-in-time, machine-learning process on a pairwise interactions between the further features. As described herein, the forward-in-time, machine-learning process may include a gradient-boosted, decision-tree process, such as an XGBoost process, and executed reporting engine 172 may generate the Shapley values in accordance with one or more Shapley Additive explanations (SHAP) processes, such as, but not limited to, a KernelSHAP process or a TreeShap process.

Further, and in addition to, or as an alternate to, the Shapley values, one or more of instance-specific elements 572A, 572B, . . . , and 572N of explainability data may also include values of one or more deterministic or probabilistic metrics that characterize further the relative importance of the each of the discrete features of corresponding ones of the discrete feature vectors (e.g., the first, second, and final feature vectors described herein), and the relative contribution of each of the discrete features to the predictive output of the forward-in-time, machine-learning process. By way of example, the elements of explainability data maintained within the one or more of one or more of instance-specific elements 572A, 572B, . . . , and 572N may also, for one or more of the discrete features of the corresponding one of the discrete feature vectors, associate a corresponding feature identifier with data establishing a feature-specific ICE curve and/or data specifying a feature-specific PDP.

Executed reporting engine 172 may perform operations, consistent with the modified elements of reporting configuration data 232, that combine or concatenate together each of the instance-specific elements 572A, 572B, . . . , and 572N of explainability data, and that generate combined or concatenated, instance-specific elements characterizing the relative importance, or contribution of, each of the discrete features collectively maintained within the discrete feature vectors (e.g., the first, second, and final feature vectors described herein) to the predictive output of the forward-in-time, machine-learning process. In some instances, executed reporting engine 172 may perform operations that filter out and remove one or more of the feature identifiers, and corresponding Shapley values (or values of the deterministic of probabilistic or deterministic variables). By way of example, executed reporting engine 172 may apply one or more correlation processes to corresponding pairs of the feature identifiers within the concatenated or combined instance-specific elements, and generate a corresponding correlation value for each of the corresponding pairs.

The correlation value for each of the corresponding pairs of feature identifiers may range from zero to unity, and the one or more one or more correlation processes applied by executed reporting engine 172 may include, but are not limited to, processes that generate a Kendall, Spearman, or a Pearson rank correlation coefficient for the each of the corresponding pairs of feature identifiers. In some instances, executed reporting engine 172 may performed operations that identify those pairs of the feature identifiers associated with a correlation value that exceeds a predetermined threshold value or a developer-specified threshold value (e.g., as set forth within the elements of modified reporting configuration data 232), and delete, from the concatenated or combined instance-specific elements, a feature identifier and corresponding Shapley value (or value of the deterministic of probabilistic or deterministic variables) from each of the identified pairs. In some instances, executed reporting engine 172 may also perform operations that rank each of the remaining feature identifiers and corresponding Shapley values within the filtered, and concatenated or combined instance-specific elements in accordance with the magnitude of that corresponding Shapley value (or alternatively, with the magnitude of the value of the deterministic of probabilistic or deterministic variables), and that generate elements of consolidated explainability data 574 that include the ranked, and concatenated or combined instance-specific elements.

Executed reporting engine 172 may perform operations that structure pipeline reporting data 570, including the elements of consolidated explainability data 574, and the elements of process, composition, and fairness data described herein, in accordance with a format specified within the elements of modified reporting configuration data 232, such as, but not limited to, a PDF or a DOCX format. Executed reporting engine 172 may also provide pipeline reporting data 570 to executed artifact management engine 146, e.g., as output artifacts 576 of executed reporting engine 172 within customized training pipeline 522. In some instances, executed artifact management engine 146 may receive each of the output artifacts of executed reporting engine 172, e.g., the elements of pipeline reporting data 570, and may perform operations that package the elements of pipeline reporting data 570 into a corresponding portion of reporting artifact data 578, along with a unique, alphanumeric identifier 172A of executed reporting engine 172, and that store reporting artifact data 394 within a corresponding portion of artifact data store 142, e.g., within data record 304 associated with default training pipeline 302 and run identifier 303A. Further, although not illustrated in FIG. 3B, executed artifact management engine 146 may also package, into a corresponding portion of reporting artifact data 394, additional data identifying and characterizing the input artifacts ingested by executed reporting engine 172.

Although not illustrated in FIG. 5C, executed orchestration engine 144 may obtain portions of reporting artifact data 578, including identifier 172A and output artifacts 576, which include pipeline reporting data 570. As described herein, pipeline reporting data 570 may include the elements of consolidated explainability data 574, which include the combined or concatenated, combine or concatenate together instance-specific elements 572A, 572B, . . . , and 572N of explainability data, and in some instances, executed orchestration engine 144 may generate a response to customization request 514 that includes the elements of consolidated explainability data 574, and may perform operations that cause computing system 130 to transmit the generated response across network 120 to computing system 130, e.g., via the secure, programmatic channel of communications established between executed programmatic web service 148 of computing system 130 and executed web browser 108 of developer system 102.

The programmatic interface established and maintained by developer system 102, such as an application programming interface 404 associated with web browser 108, may receive and route the response (e.g., elements of consolidated explainability data 574) to web browser 108, which may be executed by the one or more processors of developer system 102. In some instances, executed web browser 108 may store the response within a portion of memory 104, and may process portions of the response to generate interface elements representative of, among other things, the elements of consolidated explainability data 574 described herein. Executed web browser 108 may provide all, or a selected portion, of the interface elements to display device 110, which may render the interface elements within one or more portions or display screens of a digital interface, such as, but not limited to, portion 414 of explainability interface 408 of FIG. 4B.

Although not illustrated in FIG. 5A, 5B, or 5C, portion 414 of explainability interface 408 may provide a graphical representation of a magnitude of the Shapely feature value (or the value of the deterministic or probabilistic variable) characterizing each of the ranked features specified within the elements of consolidated explainability data 574, which may be drawn from among the multiple, discrete feature vectors associated with elements 520A, 520B, . . . 520N of customized featurizer configuration data. In some examples, the ranked features characterized by the elements of consolidated explainability data 574 may represent a set of stable, impactful features that are consistent with the particular use-case of interest to developer 103, and that may form a basis for additional training, validation, and testing of the forward-in-time, machine-learning process within a corresponding development environment using any of the exemplary processes described herein, or a deployment of the trained, forward-in-time, machine-learning process within a corresponding production environment using any of the exemplary processes described herein.

Through a performance of one or more of the exemplary processes described herein, the one or more processors of computing system 130 may facilitate a customization of an execution flow of the default application engines within default training pipeline 302 based on a corresponding modification to training pipeline script, and without any modification to the executable code that establishes the default application engines. Certain of these exemplary processes, which facilitate a sequential execution of the default application engines in accordance with the modified execution flow (e.g., in parallel across the one or more processors of computing system 130 based on programmatic interaction with executed orchestration engine 144) may establish a customized training pipeline 522 that facilitates the adaptive selection of a set of stable, impactful features that are consistent with the particular use-case of interest to developer 103, while maintaining compliance with the one or more process-validation operations or requirements and with the one or more governmental or regulatory requirements, and without the data leakage that characterizes feature generation in many existing processes that train forward-in-time machine-learning processes. One or more of these exemplary processes may, in some instances, facilitate a reduction in consumption of the processing, memory, network, and other computational resources associated with successive implementations of default training pipeline 302 within many existing processes that train forward-in-time machine-learning processes and may be used in addition to, or as alternate to, the existing processes.

### C. Configurable Pipelines for Deploying Trained, Forward-In-Time Machine-Learning Processes in Distributed Computing Environments

By way of example, developer 103 may elect to apply the now-trained machine-learning process to the feature vectors derived from the elements of user data and obtain elements of predictive output associated with a particular use-case of interest to developer 103, e.g., in support of one or more customer-facing or back-end decisioning processes. For instance, the predictive output of associated with a particular use-case of interest may include, but is not limited to, data indicative of an occurrence, or a non-occurrence, of a targeted event involving one or more users associated with organization or enterprise (e.g., users of the distributed computing components of computing system 130, customers of the financial institution, etc.) during a future temporal interval.

In some instances, and based on input provisioned by developer 103, developer system 102 may perform any of the exemplary described herein to access to one or more of the elements of configuration data associated with the application engines executed sequentially within a default inferencing pipeline established by the one or more process of computing system 130 (e.g., in accordance with inferencing pipeline script 152), and to update, modify, or “customize” the one or more of the accessed elements of configuration data to reflect the particular use-case of interest to developer 103. As described herein, the modification of the accessed elements of configuration data by developer system 102 may enable developer 103 to customize the sequential execution of the application engines within the default inference pipeline to reflect the particular use-case without modification to the underlying code associated with the executed application engines or to inferencing pipeline script 152, and while maintaining compliance with the one or more process-validation operations or requirements and with the one or more governmental or regulatory requirements.

For example, developer 103 may provide input to developer system 102 (e.g., via input device 112), which causes executed web browser 108 to perform any of the exemplary processes described herein to request access to the elements of configuration data associated with the application engines executed sequentially within the default inferencing pipeline. As described herein, and upon execution by the one or more processors of computing system 130 (e.g., via executed orchestration engine 144), inferencing pipeline script 152 may establish the default training pipeline, and sequentially execute retrieval engine 156, preprocessing engine 158, indexing engine 160, time-series featurizer engine 166, inferencing engine 170, and reporting engine 172 in accordance with respective elements of engine-specific configuration data. In some instances, executed web browser 108 may perform operations, described herein, that generate a corresponding access request identifying the default inferencing pipeline (e.g., via a unique, alphanumeric identifier of the default inferencing pipeline) and developer system 102 or executed web browser 108 (e.g., via the IP address of developer system 102, the MAC address of developer system 102, or the digital token or application cryptogram of executed web browser 108.

As described herein, executed web browser 108 may transmit the corresponding access request across network 120 to computing system 130, e.g., via the secure, programmatic channel of communications established between executed web browser 108 and executed programmatic web service 148. In some instances, customization API 206 of executed customization application 204 at computing system 130 may receive the corresponding access request, and based on an established permission of developer system 102 (and executed web browser 108) to access the elements of configuration data maintained within configuration data store 140, executed customization application 204 may obtain each of the elements of configuration data associated with the default inferencing pipeline (e.g., the elements of retrieval configuration data 157, preprocessing configuration data 159, indexing configuration data 161, featurizer configuration data 167, inferencing configuration data 171, and reporting configuration data 173), and package the obtained elements of engine-specific configuration within a response to the corresponding access request, which computing system 130 may transmit across network 120 to developer system 102.

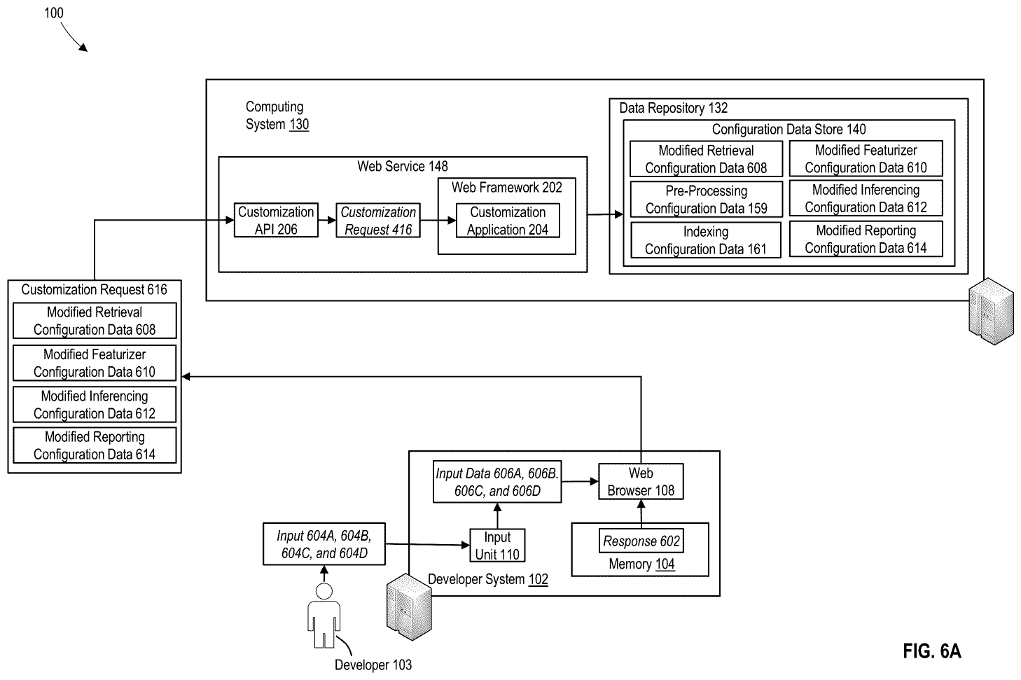

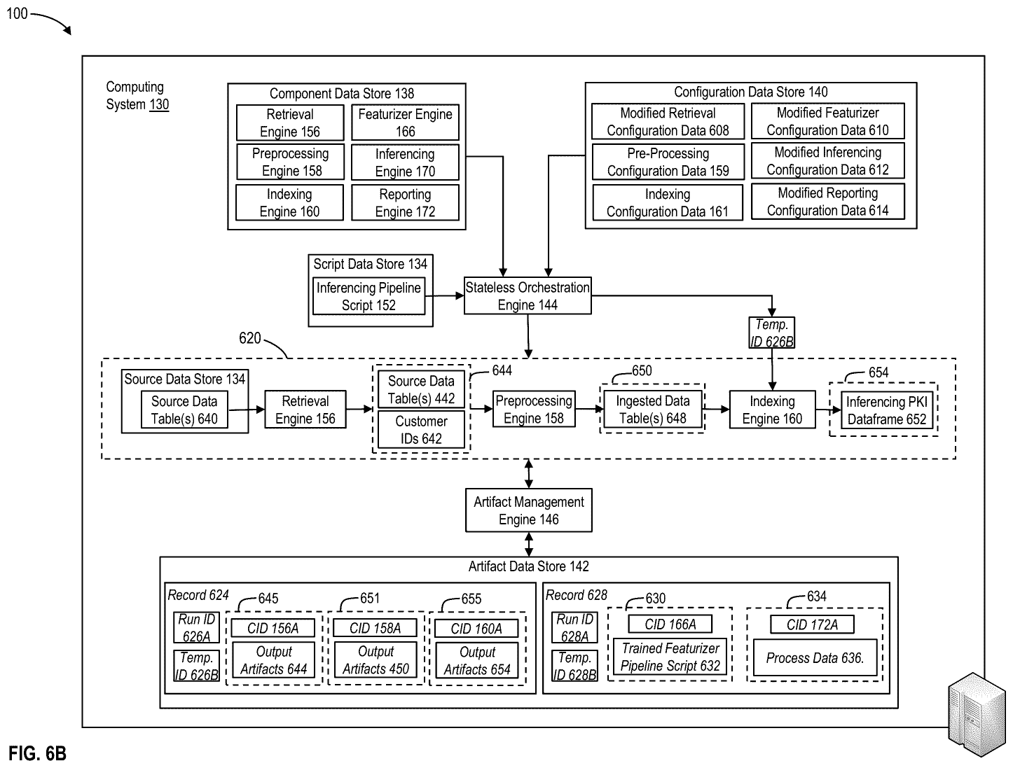

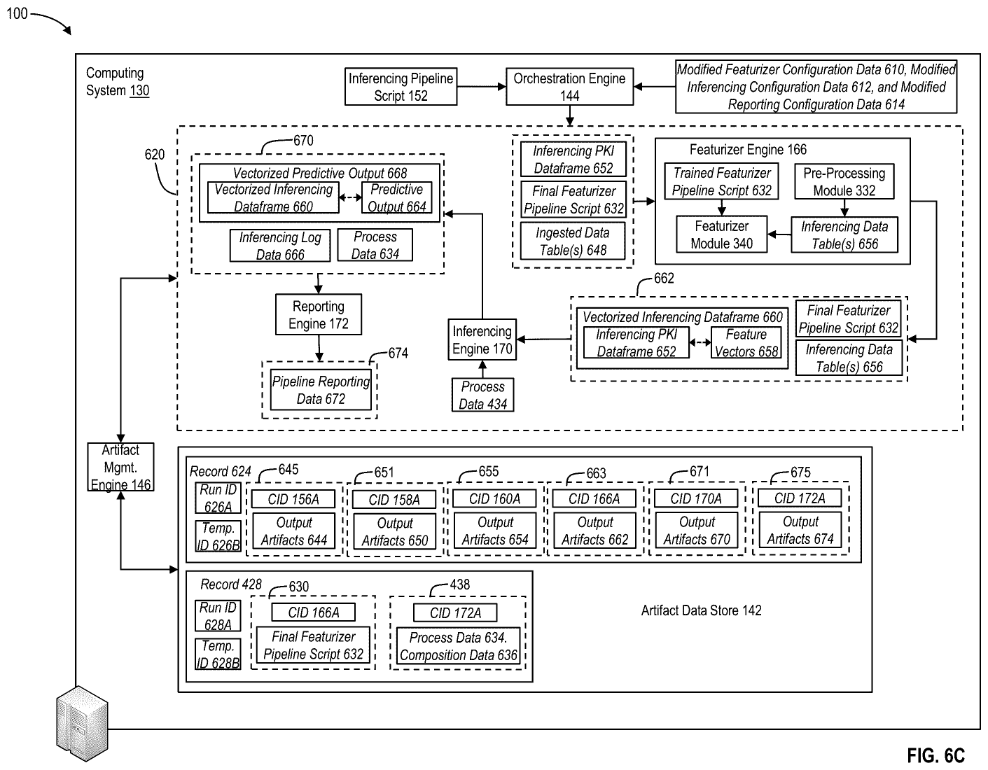

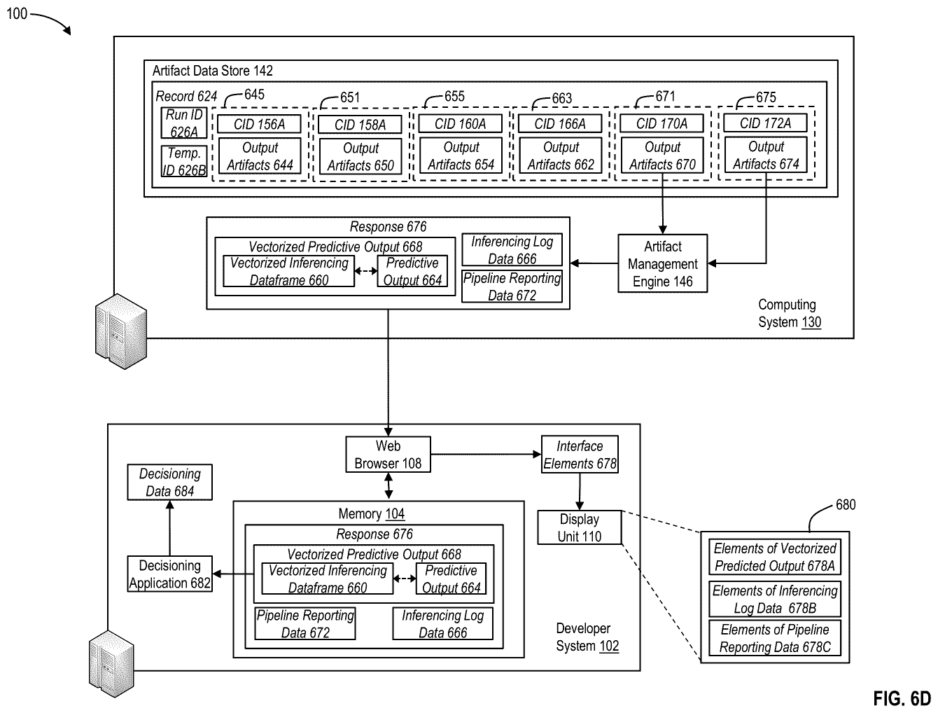

Referring to FIG. 6A, developer system 102 may receive the response to the corresponding access request, and executed web browser 108 may store the response, e.g., response 602, within a portion of memory 104. Executed web browser 108 may access response 602 within memory 104, and may obtain the requested elements of retrieval configuration data 157, preprocessing configuration data 159, indexing configuration data 161, featurizer configuration data 167, inferencing configuration data 171, and reporting configuration data 173 from response 602, and executed web browser 108 may perform any of the exemplary processes described herein that that process these requested elements of configuration data and present corresponding interface elements within one or more display screens of a digital interface, e.g., via display device 110. In some instances, and based on input received from developer 103 via input device 112, developer system 102 may perform operations that update, modify, or customize corresponding portions of the elements of engine-specific configuration data in accordance with the particular use-case of interest to developer 103. As described herein, the particular use-case of interest to developer 103 may be associated with an application of the gradient-boosted, decision-tree process (e.g., the XGBoost process) to the feature vectors derived from elements of source data, and a prediction of the likelihood of the occurrence, or the non-occurrence, of the targeted event during the future temporal interval.

To facilitate the modification and customization of the elements of retrieval configuration data 157, developer 103 may provide, to input device 112, elements of developer input 604A that, among other things, specify a unique identifier of each of the subset of the users associated with the particular use-case, a unique identifier of each source data table that supports the generation of feature vectors for each of the users, a primary key or composite primary key of each of the source data tables, and a network address of an accessible data repository that maintains each of the source data tables, e.g., a file path or an IP address of source data store 134, etc. Input device 112 may, for example, may receive developer input 604A, and may route corresponding elements of input data 606A to executed web browser 108, which may modify the elements of retrieval configuration data 157 to reflect input data 606A and that generate corresponding elements of modified retrieval configuration data 608.

Further, developer 103 may not elect to modify any of the elements of preprocessing configuration data 159 or indexing configuration data 161. Instead, developer 103 may elect to rely on the default preprocessing and data-indexing operations performed by corresponding ones of preprocessing engine 158 and indexing engine 160 within the default inferencing pipeline, and on the default values for the one or more parameters of the default preprocessing and data-indexing operations implemented by respective ones of preprocessing engine 158 and indexing engine 160.

Developer 103 may also elect to modify and customize one or more of the elements of featurizer configuration data 167 to reflect the particular use-case of interest to developer 103 within the default inferencing pipeline. For example, developer 103 may elect to apply, to the source data tables ingested as artifacts by time-series featurizer engine 166 within the default inferencing pipeline, one or more temporal filters that exclude, from the corresponding inferencing data table(s), rows associated with timestamps disposed outside of the scope of the particular use-case (e.g., prior to a corresponding extraction interval, etc.). Further, developer 103 may elect to rely on the additional default preprocessing operations that generate, based on the ingested source data tables, one or more inferencing data tables that include rows characterizing each of the subset of the customers associated with the particular use-case.

In some instances, developer 103 may provide, to input device 112, corresponding elements of developer input 604B that specify each of the temporal filtration operations, along with corresponding values of the parameters that facilitate the application of each of the one or more temporal filtration operations, and that specify a specify a unique identifier of each of the subset of the users associated with the particular use-case, e.g., to support the implementation of the additional default preprocessing operations that generate the inferencing data table(s). Input device 112 may, for example, receive developer input 604B, and may route corresponding elements of input data 606B to executed web browser 108, which may modify the elements of featurizer configuration data 167 to reflect input data 606B and that generate corresponding elements of modified featurizer configuration data 610.

Further, developer 103 may elect to modify and customize one or more of the elements of inferencing configuration data 171 and reporting configuration data 173 to reflect the particular use-case of interest to developer 103. By way of example, developer 103 may provide, to input device 112, elements of developer input 604C that, among other things, specify the trained, forward-in-time machine-learning process of interest to developer 103 (e.g., the trained, gradient-boosted, decision-tree process, such as the XGBoost process), and a value of one or more process parameters of the trained, forward-in-time machine-learning processes (and additionally, or alternatively, an identifier and location of an ingestible artifact specifying the one or more process parameter values, e.g., output artifact generated by executed training engine 168 during the final training run of default training pipeline 302).

As described herein, the data that specifies the gradient-boosted, decision-tree process may include a helper script or function callable within the namespace of inferencing engine 170 or a corresponding class path, and the value of one or more process parameters of the trained gradient-boosted, decision-tree process, such as, but not limited to, those described herein, may facilitate an instantiation of the gradient-boosted, decision-tree process during the default inferencing pipeline (e.g., by executed inferencing engine 170). Further, in some instances, the elements of developer input 604C may also specify a structure of format of the elements of predictive output, and a structure of format of the generated inferencing logs (e.g., as an output file having a corresponding file format accessible at developer system 102, such as a PDF or a DOCX file). Input device 112 may, for example, receive developer input 604C, and may route corresponding elements of input data 606C to executed web browser 108, which may modify the elements of training configuration data 169 to reflect input data 606C and that generate corresponding elements of modified inferencing configuration data 612.

Further, as described herein, the elements of reporting configuration data 173 may specify a default composition of the elements of pipelined reporting data generated by executed reporting engine 172 during the default inferencing pipeline and a default structure or format of the pipeline monitoring and/or validation data, e.g., in PDF form, in DOCX form, in XML form, etc.). In some instances, upon review of interface elements 602F of digital interface 603, developer 103 may elect not to modify the default composition of either of the pipeline reporting data for the default inferencing pipeline, but may provide, to input device 112, elements of developer input 604D that, among other things, specifying that reporting engine 172 generate the pipeline reporting data in DOCX format. Input device 112 may, for example, receive developer input 604D, and may route corresponding elements of input data 606D to executed web browser 108, which may modify the elements of reporting configuration data 173 to reflect input data 606D and that generate corresponding elements of modified reporting configuration data 614.

Executed web browser 108 may perform operations that package the elements of modified retrieval configuration data 608, modified featurizer configuration data 610, modified inferencing configuration data 612, and modified reporting configuration data 614 into corresponding portions of a customization request 616. In some instances, executed web browser 108 may also package, into an additional portion of customization request 616, a unique identifier of the default inferencing pipeline and the identifiers of developer system 102 or executed web browser 108, such as, but not limited to, those described herein. Executed web browser 108 may also perform operations that cause developer system 102 to transmit customization request 616 across communications network 120 to computing system 130.

In some instances, customization API 206 of executed customization application 204 may receive customization request 616, and perform any of the exemplary processes described herein to determine that computing system 130 permits a source of customization request 234, e.g., developer system 102 or executed web browser 108, to modify or customize the elements of configuration data maintained within configuration data store 140, and that routes customization request 616 to executed customization application 204. As illustrated in FIG. 6B, executed customization application 204 may obtain, from customization request 616, the identifier of the default inferencing pipeline, the elements of modified retrieval configuration data 608, modified featurizer configuration data 610, modified inferencing configuration data 612, and modified reporting configuration data 614, which reflect a customization of the default elements of retrieval configuration data 157, featurizer configuration data 167, inferencing configuration data 171, and reporting configuration data 173 in accordance with the particular use-case of interest to developer 103.

Based on the identifier, executed customization application 204 may access the elements of engine-specific configuration data associated with the default inferencing pipeline and maintained within configuration data store 140, and perform operations that replace, or modify, the elements of retrieval configuration data 157, featurizer configuration data 167, inferencing configuration data 171, and reporting configuration data 173 with corresponding ones of the elements of modified retrieval configuration data 608, modified featurizer configuration data 610, modified inferencing configuration data 612, and modified reporting configuration data 614. Through a modification of one or more of the elements of configuration data in accordance with the particular use-case of interest to developer 103, the exemplary processes described herein may enable developer system 102 to customize the sequential execution of the application engines within the default inferencing pipeline to reflect the particular use-case without any modification, by developer system 102, to inferencing pipeline script 152, or to the underlying code of any of the application engines executed sequentially within the default inferencing pipeline by the one or more processors of computing system 130.

Referring to FIG. 6B, the one or more processors of computing system 130 may execute orchestration engine 144, data store 136 and obtain inferencing pipeline script 152. Inferencing pipeline script 152 may specify the execution flow of the default inferencing pipeline (e.g., an order of sequential execution of each of the application engines within the default inferencing pipeline) and may include, for each of the sequentially executed application engines, data identifying corresponding elements of engine-specific configuration data, one or more input artifacts ingested by the sequentially executed application engine, and additionally, or alternatively, one or more output artifacts generated by the sequentially executed application engine. By way of example, and as described herein, the default training pipeline may include retrieval engine 156, preprocessing engine 158, indexing engine 160, time-series featurizer engine 166, inferencing engine 170, and reporting engine 172, which may be executed sequentially by the one or more processors in accordance with the execution flow specified within executed training pipeline script.

Executed orchestration engine 144 may trigger an execution of inferencing pipeline script 152 by the one or more processors of computing system 130, which may establish the default inferencing pipeline, e.g., default inferencing pipeline 620. In some instances, upon execution of inferencing pipeline script 152, executed orchestration engine 144 may generate a unique, alphanumeric identifier, e.g., run identifier 626A, for a current run of default inferencing pipeline 620 in accordance with the corresponding elements of engine-specific configuration data (e.g., which developer 103 may customize in accordance with the particular use-case of interest using any of the exemplary processes described herein), and executed orchestration engine 144 may provision run identifier 626A to artifact management engine 146 via artifact API. Executed artifact management engine 146 may perform operations that, based on run identifier 626A, associate one or more data record 624 of artifact data store 142 with the current implementation, or run, of default inferencing pipeline 620, and that store run identifier 626A within data record 624 along with a corresponding temporal identifier 626B indicative of date at which executed orchestration engine 144 executed inferencing pipeline script 152 and established default inferencing pipeline 620 (e.g., on Jun. 1, 2024)

Upon execution by the one or more processors of computing system 130, each of retrieval engine 156, preprocessing engine 158, indexing engine 160, time-series featurizer engine 166, inferencing engine 170, and reporting engine 172 may ingest one or more input artifacts and corresponding elements of configuration data specified within executed inferencing pipeline script 152, and may generate one or more output artifacts. In some instances, executed artifact management engine 146 may obtain the output artifacts generated by corresponding ones of these application engines, and store the obtained output artifacts within a corresponding portion of data record 624, e.g., in conjunction within a unique, alphanumeric component identifier of the corresponding one of the executed application engines and run identifier 626A. Further, executed artifact management engine 146 may also maintain, in conjunction with the component identifier and corresponding output artifacts within data record 304, data characterizing input artifacts ingested by one, or more, of the executed application engines within default inferencing pipeline 620. As described herein, the maintenance of input artifacts ingested by a corresponding one of these executed application engines within default inferencing pipeline 620, and the association of the ingested input artifacts with the corresponding component identifier and run identifier 626A, may establish an artifact lineage that facilitates an audit of a provenance of an artifact ingested by the corresponding one of the executed application engines during the current implementation or run of default inferencing pipeline 620 (e.g., associated with run identifier 626A), and recursive tracking of the generation or ingestion of that artifact across the current implementation or run of default inferencing pipeline 620 (e.g., associated with run identifier 626A) and one or more prior runs of default inferencing pipeline 620 (or of the default training and target-generation pipelines described herein).

Further, and in addition to data record 624 characterizing the current run of default inferencing pipeline 620, executed artifact management engine 146 may also maintain, within artifact data store 142, data records characterizing prior runs of default inferencing pipeline 620, one or more prior runs of a default target-generation pipeline, and one or more prior runs of default training pipeline 302. For example, as illustrated in FIG. 4B. artifact data store 142 may also include additional data record 628, which characterizes the output artifacts generated by (and in some instances, the input artifacts ingested by), each of the application engines executed sequentially by the one or more processors of computing system 130 during the final training run of default training pipeline 302. Additional data record 628 may include a unique, alphanumeric identifier 628A of the final training run of default training pipeline 302, a temporal identifier 628B that identifies an initiation time or date of final training run of default training pipeline 302, and elements of engine-specific artifact data that include the output artifacts generated by corresponding ones of the sequentially application engines and that associate each of the engine-specific output artifacts with a corresponding component identifier.

By way of example, the elements of engine-specific artifact data may include, among other things, elements of featurizer artifact data 630, which include component identifier 166A of time-series featurizer engine 166 and a final featurizer pipeline script 632 generated by executed time-series featurizer engine 166 during the final training run of default training pipeline 302, and elements of reporting artifact data 634, which include component identifier 172A of reporting engine 172 and elements of process data 636 characterizing the trained, forward-in-time machine-learning process. As described herein, final featurizer pipeline script 632 may establish a final featurizer pipeline of sequentially executed ones of the mapped, default stateless transformation and the mapped, default estimation operations that, upon application to the rows of corresponding ones an inferencing data table, generate a feature vector appropriate for ingestion by the trained, forward-in-time machine-learning process. Further, the elements of process data 636 include the values of one or more process parameters associated with the trained, forward-in-time machine-learning process.

In some instances, one or more of the elements of artifact data characterizing the final training run of default training pipeline 302, including the elements of elements of featurizer artifact data 630 and reporting artifact data 634, may represent input artifacts for executed inferencing pipeline script 152 (and for default inferencing pipeline 620), and may be ingested by corresponding ones of the executed application engines within default inferencing pipeline 620. By way of example, featurizer module 340 of executed time-series featurizer engine 166 within default inferencing pipeline 620 may ingest final featurizer pipeline script 632 and generate feature vectors for the trained machine-learning process based on sequential application the mapped, default stateless transformation operations and the mapped, default estimation operations to rows of one or more inferencing data tables, e.g., in accordance with final featurizer pipeline script 632. Further, within default inferencing pipeline 620, executed inferencing engine 170 may ingest the elements of process data 636 and perform operations described herein that cause the one or more processors of computing system 130 to instantiate the trained, forward-in-time machine-learning process in accordance with the values of the one or more process parameters.

Referring to FIG. 6B, executed inferencing pipeline script 152 may trigger an execution of retrieval engine 156 by the one or more one or more processors of computing system 130, and orchestration engine 144 may provision one or more of the elements of modified retrieval configuration data 608 to the programmatic interface associated with executed retrieval engine 156 (e.g., as corresponding input artifacts). Based on an established consistency of the input artifacts with the imposed engine- and pipeline-specific operational constraints (e.g., via the corresponding, programmatic interface), executed retrieval engine 156 may perform operations, described herein, to access source data store 134, and obtain one or more of source data table(s) 640 associated with the particular use-case of developer 103, based on the elements of modified retrieval configuration data 608. Further, executed retrieval engine 156 may also perform operations that obtain the unique identifiers of the subset of the users associated with the particular use-case from the elements of modified retrieval configuration data 608 (e.g., as user identifiers 642), and that provision source data table(s) 640 and user identifiers 642 to executed artifact management engine 146, e.g., as output artifacts 644 of executed retrieval engine 156.

In some instances, executed artifact management engine 146 may receive each of output artifacts 644 via the artifact API, and may perform operations that package each of output artifacts 644 into a corresponding portion of retrieval artifact data 665, along with identifier 156A of executed retrieval engine 156, and that store retrieval artifact data 645 within a corresponding portion of artifact data store 142, e.g., within data record 624 associated with default inferencing pipeline 620 and run identifier 626A. Further, although not illustrated in FIG. 6B, executed artifact management engine 146 may also package, into a corresponding portion of retrieval artifact data 645, additional data identifying and characterizing one or more of the input artifacts ingested by executed retrieval engine 156, such as, but not limited to, the elements of modified retrieval configuration data 222.

Further, and in accordance with default inferencing pipeline 620, executed retrieval engine 156 may provide output artifacts 644, including source data table(s) 640 and user identifiers 642, as inputs to preprocessing engine 158 executed by the one or more processors of computing system 130, and executed orchestration engine 144 may provision one or more elements of preprocessing configuration data 159 maintained within configuration data store 140 to executed preprocessing engine 158, e.g., in accordance with executed training pipeline script 150. In some instances, the programmatic interface associated with executed preprocessing engine 158 may ingest each of source data table(s) 640, user identifiers 642 and one or more elements of preprocessing configuration data 159 (e.g., as corresponding input artifacts), and may perform any of the exemplary processes described herein to establish a consistency of the corresponding input artifacts with the engine- and pipeline-specific operational constraints imposed on executed preprocessing engine 158.

Based on an established consistency of the input artifacts with the imposed engine- and pipeline-specific operational constraints, executed preprocessing engine 158 may perform operations that apply each of the default preprocessing operations to corresponding ones of source data table(s) 640 (and in some instances, to user identifiers 642 of the target subset of the customers) in accordance with the elements of preprocessing configuration data 159 (e.g., through an execution or invocation of each of the specified default scripts or classes within the namespace of executed preprocessing engine 158, etc.). Further, and based on the application of each of the default preprocessing operations to source data table(s) 640 and/or user identifiers 642, executed preprocessing engine 158 may also generate one or more ingested data table(s) 648 having identifiers, and structures or formats, consistent with the default identifier, and default structures or formats, specified within the elements of preprocessing configuration data 159.

In some instances, executed preprocessing engine 158 may perform operations that provision ingested data table(s) 648 to executed artifact management engine 146, e.g., as output artifacts 650 of executed preprocessing engine 158. Executed artifact management engine 146 may receive each of output artifacts 650 via the artifact API, and may perform operations that package each of output artifacts 650 into a corresponding portion of preprocessing artifact data 651, along with identifier 158A of executed preprocessing engine 158, and that store preprocessing artifact data 651 within a corresponding portion of artifact data store 142, e.g., within data record 624 associated with default inferencing pipeline 620 and run identifier 626A. Further, although not illustrated in FIG. 6B, executed artifact management engine 146 may also package, into a corresponding portion of preprocessing artifact data 651, additional data identifying and characterizing one or more of the input artifacts ingested by executed preprocessing engine 158, such as, but not limited to, the elements of preprocessing configuration data 159, source data tables 640, and/or user identifiers 642.

Executed preprocessing engine 158 may provide output artifacts 650, including ingested data table(s) 648, as inputs to indexing engine 160 executed by the one or more processors of computing system 130. Executed orchestration engine 144 may also perform operations that provision one or more elements of indexing configuration data 161 maintained within configuration data store 140 to executed indexing engine 160, Further, and based on programmatic communications with executed artifact management engine 146, executed orchestration engine 144 may perform operations that obtain user identifiers 642 (e.g., a portion of output artifacts 644) and temporal identifier 626B (e.g., identifying the Jun. 1, 2024, initiation date of default inferencing pipeline 620) from record 624 of artifact data store 142, and that provision temporal identifier 626B and user identifiers 642 to executed indexing engine 160 in accordance with default inferencing pipeline 620. As described herein, the programmatic interface associated with executed indexing engine 160 may receive temporal identifier 626B, user identifiers 642, ingested data table(s) 648, and the one or more elements of indexing configuration data 161 (e.g., as input artifacts), and may perform operations that establish a consistency of these input artifacts with the engine- and pipeline-specific operational constraints imposed on executed indexing engine 160.

Based on an established consistency of the input artifacts with the imposed engine- and pipeline-specific operational constraints, executed indexing engine 160 may perform operations, consistent with the elements of indexing configuration data 161, that generate an inferencing PKI dataframe 652 for the current run of default inferencing pipeline 620, e.g., initiated on Jun. 1, 2024. By way of example, the elements of indexing configuration data 161 may include, among other things, an identifier of each of the ingested data table(s) 648, a primary key or composite primary key of each of ingested data table(s) 648, data characterizing a structure, format, or storage location of an output artifact generated by executed indexing engine 160, such as inferencing PKI dataframe 652, and one or more constraints imposed on the output artifact, e.g., inferencing PKI dataframe 652. Based on the elements of indexing configuration data 161, executed indexing engine 160 access each of ingested data table(s) 648, select one or more columns from each of the each of ingested data table(s) 648 that are consistent with the corresponding primary key (or composite primary key), and generate a dataframe, e.g., inferencing PKI dataframe 652, that includes the entries of each of the selected columns.

Inferencing PKI dataframe 652 may, for example, include a plurality of discrete rows populated with corresponding ones of the entries of each of the selected columns, e.g., the values of corresponding ones of the primary keys (or composite primary keys) obtained from each of ingested data table(s) 640, and as described herein, examples of these primary keys (or composite primary keys) may include, but are not limited to, a unique, alphanumeric identifier assigned to corresponding users by the organization or enterprise, and temporal data, such as a timestamp. Further, in some instances the one or more constraints imposed on inferencing PKI dataframe 652 within default inferencing pipeline 620 may include, but are not limited to, a constraint that inferencing PKI dataframe 652 include a single row for each of the subset of the customers associated with the particular use-case (e.g., including a corresponding one of user identifiers 642), and that the temporal data maintained within each customer-specific row of inferencing PKI dataframe 652 reflect a prediction date of the inferencing operations performed within default inferencing pipeline 620, e.g., the Jun. 1, 2024, initiation time of default inferencing pipeline 620.

In some instances, within default inferencing pipeline 620, executed indexing engine 160 may perform additional operations that process inferencing PKI dataframe 652 in accordance with the imposed constraints, e.g., by deleting one or more customer-specific rows that maintain duplicate or redundant ones of user identifiers 642 and by populating each of the customer-specific rows with temporal data characterizing the prediction date of Jun. 1, 2024. Upon processing in accordance with the imposed constraints, each of the discrete rows of inferencing PKI dataframe 652 may be associated with a corresponding one of the subset of the customers associated with the particular use-case (and may include a corresponding one of user identifiers 642) and may reference the prediction date for the inferencing processes described herein, the rows maintained within inferencing PKI dataframe 652 may represent a base population for one or more of the exemplary feature-generation and inferencing processes performed by the one or more processors of computing system 130 within default inferencing pipeline 620 (e.g., in accordance with executed inferencing pipeline script 152).

In some instances, executed indexing engine 160 may perform operations that provision inferencing PKI dataframe 652 to executed artifact management engine 146, e.g., as output artifacts 654 of executed indexing engine 160. In some instances, executed artifact management engine 146 may receive output artifacts 654 via the artifact API, and may perform operations that package output artifacts 654 into a corresponding portion of indexing artifact data 655, along with a unique, alphanumeric identifier 160A of executed indexing engine 160, and that store indexing artifact data 655 within a corresponding portion of artifact data store 142, e.g., within data record 624 associated with default inferencing pipeline 620 and run identifier 626A. Further, although not illustrated in FIG. 4B, executed artifact management engine 146 may also package, into a corresponding portion of retrieval artifact data 607, additional data identifying and characterizing one or more of the input artifacts ingested by executed indexing engine 160, such as, but not limited to, ingested data table(s) 308 and the elements of indexing configuration data 161.

Referring to FIG. 6C, and in accordance with default inferencing pipeline 620, executed indexing engine 160 may provide output artifacts 654, including inferencing PKI dataframe 652, as input to time-series featurizer engine 166 executed by the one or more processors of computing system 130. In some instances, within default inferencing pipeline 620, executed orchestration engine 144 may provision one or more elements of modified featurizer configuration data 610 maintained within configuration data store 140. Further, and based on programmatic communications with executed artifact management engine 146, executed orchestration engine 144 may perform operations that obtain ingested data table(s) 648 (e.g., a portion of output artifacts 650 of executed preprocessing engine 158) from record 624 of artifact data store 142, and that obtain a featurizer pipeline script associated with a final training run of default training pipeline 302 and with the trained, forward-in-time machine-learning process, such as, but not limited final featurizer pipeline script 632 maintained as a portion of featurizer artifact data 630 within data record 628 of artifact data store 142. As described herein, final featurizer pipeline script 632 may establish a final featurizer pipeline of sequentially executed ones of the mapped, default stateless transformation and the mapped, default estimation operations that, upon application to the rows of inferencing data table(s) 648, generate a customer-specific feature vector appropriate for ingestion by the trained, forward-in-time machine-learning process. Executed orchestration engine 144 may provision final featurizer pipeline script 632 and each of ingested data table(s) 648 as additional input to executed time-series featurizer engine 166.

In some instances, the programmatic interface of executed time-series featurizer engine 166 may receive modified featurizer configuration data 610, final featurizer pipeline script 632, ingested data table(s) 648, and inferencing PKI dataframe 652 (e.g., as corresponding input artifacts), and may perform operations that establish a consistency of these input artifacts with the engine- and pipeline-specific operational constraints imposed on executed time-series featurizer engine 166. Based on an established consistency of the input artifacts with the imposed engine- and pipeline-specific operational constraints, executed time-series featurizer engine 166 may perform one or more of the exemplary processes described herein that, consistent with the elements of modified featurizer configuration data 610, generate a customer-specific feature vector of corresponding feature values for each row of inferencing PKI dataframe 652 based on, among other things, a sequential application of the mapped, default stateless transformations and the mapped, default estimation operations specified within final featurizer pipeline script 632 to elements of an inferencing data table.

For example, within default inferencing pipeline 620, preprocessing module 332 of executed time-series featurizer engine 166 may obtain each of ingested data table(s) 648, and may apply sequentially one or more of the preprocessing operations to selected ones of ingested data table(s) 648 in accordance with the elements of modified featurizer configuration data 610. As described herein, elements of modified featurizer configuration data 610 may include, among other things, data specifying each of the one or more preprocessing operations and a sequential order in which executed preprocessing module 332 applies the one or more preprocessing operations to ingested data table(s) 648 (e.g., via sequentially ordered scripts or functions callable within the namespace of time-series featurizer engine 166, etc.) and values of one or more parameters of each of the specified preprocessing operations, which may customized to reflect the particular use-case of interest to developer 103 using any of the exemplary processes described herein.

Examples of the specified preprocessing operations may include, but are not limited to, one or more temporal filtration operations, one or more user- or data-specific filtration operations, and a join operation (e.g., an inner- or outer-join operations, etc.) applied to a subset of ingested data table(s) 648. Further, in applying the join operation to the subset of the subset of ingested data table(s) 648, executed time-series featurizer engine 166 may perform operations, described herein, that establish a presence or absence, within each of subset of ingested data table(s) 648, of columns associated with each of the primary keys within inferencing PKI dataframe 652 (e.g., the customer identifier and temporal data described herein, etc.). In some instances, and based on an absence of a column associated with one of the primary keys within at least one of ingested data table(s) 308 subject to the join operation, executed preprocessing module 332 may perform operations that augment the at least one of ingested data table(s) 640 to include an additional column associated with the absent primary key, e.g., based on an application of a “fuzzy join” operation based on fuzzy string matching.

Based on an application of the one or more preprocessing operations to corresponding ones of ingested data table(s) 648 in accordance with the modified elements of featurizer configuration data 610, executed preprocessing module 332 may generate one or more inferencing data table(s) 656, which may facilitate a generation, using any of the exemplary processes described herein, of a feature vector of specified, or adaptively determined, feature values for each row of inferencing PKI dataframe 652. For example, as illustrated in FIG. 6C, featurizer module 340 of executed time-series featurizer engine 166 may obtain final featurizer pipeline script 632, inferencing PKI dataframe 652, and inferencing data table(s) 656, and executed featurizer module 340 may trigger an execution of final featurizer pipeline script 632 by the one or more processors of computing system 130. As described herein, the execution of final featurizer pipeline script 632 may establish the final featurizer pipeline of the sequentially executed ones of the mapped, default stateless transformation operations and the mapped, default estimation operations associated with the trained, forward-in-time machine-learning process, and the established, final featurizer pipeline may ingest inferencing data table(s) 656.

Within the established, final featurizer pipeline, executed featurizer module 340 may apply sequentially each of the mapped, default stateless transformation operations and the mapped, default estimation operations to the rows of inferencing data table(s) 656, and generate a corresponding feature vector of sequentially ordered feature values for each of the rows of inferencing PKI dataframe 652, e.g., a corresponding one of feature vectors 658. As described herein, each of feature vectors 658 may include feature values associated with a corresponding set of features, and executed featurizer module 340 may perform operations that append each of feature vectors 658 to a corresponding row of inferencing PKI dataframe 652, and that generate elements of a vectorized inferencing dataframe 660 that include each row of inferencing PKI dataframe 652 and the appended one of feature vectors 658.

Further, executed featurizer module 340 may also perform operations that provision vectorized inferencing dataframe 660 and in some instances, final featurizer pipeline script 632 and inferencing data table(s) 656 to executed artifact management engine 146, e.g., as output artifacts 662 of executed featurizer module 340 within default inferencing pipeline 620. In some instances, executed artifact management engine 146 may receive each of output artifacts 662, and may perform operations that package each of output artifacts 360 into a corresponding portion of featurizer artifact data 663, along with identifier 166A of executed time-series featurizer engine 166, and that store featurizer artifact data 663 within a corresponding portion of artifact data store 142, e.g., within data record 624 associated with default inferencing pipeline 620 and run identifier 626A. Further, although not illustrated in FIG. 6C, executed artifact management engine 146 may also package, into a corresponding portion of featurizer artifact data 663, additional data identifying and characterizing one or more of the input artifacts ingested by executed time-series featurizer engine 166.

In some instances, and in accordance with default inferencing pipeline 620, executed time-series featurizer engine 166 may provide vectorized inferencing dataframe 660 as an input to inferencing engine 170 executed by the one or more processors of computing system 130 within default inferencing pipeline 620, e.g., in accordance with executed inferencing pipeline script 152. Further, and based on programmatic communications with executed artifact management engine 146, executed orchestration engine 144 may perform operations that obtain a value of one or more processor parameters that characterize the trained, forward-in-time machine-learning process, such as, but not limited to, the elements of process data 636 maintained as a portion of reporting artifact data 634 within data record 628 of artifact data store 142 (e.g., generated during the final training run of default training pipeline 302). Executed orchestration engine 144 may also provision the elements of process data 636, and the one or more elements of modified inferencing configuration data 612 maintained within configuration data store 140, as additional inputs to executed inferencing engine 170 within default inferencing pipeline 620.

A programmatic interface associated with executed inferencing engine 170 may receive the elements of modified inferencing configuration data 612, the elements of process data 636, vectorized inferencing dataframe 660, e.g., as input artifacts, and based on an established consistency of the input artifacts with the imposed engine- and pipeline-specific operational constraints (e.g., via the corresponding programmatic interface), executed inferencing engine 170 may cause the one or more processors of computing system 130 to perform operations that instantiate the trained, forward-in-time machine-learning process specified within the elements of modified inferencing configuration data 612 in accordance with the values of the corresponding process parameters. In some instances, as described herein, the elements of process data 636 may specify all, or a selected subset, of the process parameter values associated with the trained, forward-in-time machine-learning process, although in other instances, one or more of the process parameter values may be specified within the elements of modified inferencing configuration data 612 (e.g., which may be customized to reflect the particular use-case of interest to developer 103 using any of the exemplary processes described herein). Examples of these developer-specified parameter values for the trained, gradient-boosted decision-tree process include, but are not limited to, a learning rate, a number of discrete decision trees (e.g., the “n_estimator” for the trained, gradient-boosted, decision-tree process), a tree depth characterizing a depth of each of the discrete decision trees, a minimum number of observations in terminal nodes of the decision trees, and/or values of one or more hyperparameters that reduce potential model overfitting.

Through the implementation of one or more parallelized, fault-tolerant distributed computing and analytical processes described herein, the one or more processors of computing system 130 may perform operations that apply the instantiated, and trained, forward-in-time machine-learning process to each row of vectorized inferencing dataframe 660 (e.g., the corresponding row of inferencing PKI dataframe 652 and the appended one of feature vectors 658). Further, based on the application of the trained, forward-in-time machine-learning process to each row of vectorized inferencing dataframe 660, the one or more processors of computing system 130 may generate an element of predictive output 664 associated with the corresponding user and prediction date, and elements of inferencing log data 666 that characterize the application of the trained, forward-in-time machine-learning process to the each row of vectorized inferencing dataframe 660. In some instances, the elements of inferencing log data 666 may include performance data characterizing the application of the trained machine-learning process to the rows of vectorized inferencing dataframe 660 (e.g., execution times, memory or processor usage, etc.) and the values of the process parameters associated with the trained, forward-in-time machine-learning process, as described herein.

By way of example, and as described herein, developer 103 may elect to train a gradient-boosted, decision-tree process (e.g., an XGBoost process), to predict a likelihood of an occurrence, or a non-occurrence, of a targeted event during a future temporal interval. As described herein, elements of modified inferencing configuration data 612 may include data that identifies the gradient-boosted, decision-tree process (e.g., a helper class or script associated with the XGBoost process and capable of invocation within the namespace of executed inferencing engine 170). In some instances, and based on the elements of modified inferencing configuration data 612, executed training engine 168 may cause the one or more processors of computing system 130 to instantiate the gradient-boosted, decision-tree process (e.g., the XGBoost process) in accordance with the values of the corresponding process parameters specified within process data 636 and additionally, or alternatively, within modified inferencing configuration data 612.

Executed inferencing engine 170 may cause the one or more processors of computing system 130 may perform operations that establish a plurality of nodes and a plurality of decision trees for the trained gradient-boosted, decision-tree process, each of which receive, as inputs, each of the rows of vectorized inferencing dataframe 660, which include the corresponding row of inferencing PKI dataframe 652 and the appended one of feature vectors 658. Based on the ingestion of the rows of vectorized inferencing dataframe 660 by the plurality of nodes and decision trees of the trained gradient-boosted, decision-tree process (e.g., which apply the trained gradient-boosted, decision-tree process to each of the rows of vectorized inferencing dataframe 660), the one or more processors of computing system 130 may generate corresponding ones of the elements of predictive output 664, which may indicate the predicted likelihood of the occurrence, or non-occurrence, of the targeted event during the future temporal interval, and the elements of inferencing log data 666, which characterize the application of the trained gradient-boosted, decision-tree process to the rows of vectorized inferencing dataframe 660.

As illustrated in FIG. 6C, executed inferencing engine 170 may append each of the elements of predictive output 664 to the corresponding row of vectorized inferencing dataframe 660, and generate elements of vectorized predictive output 668 that include each row of vectorized inferencing dataframe 660 and the appended element of predictive output 664. Further, executed inferencing engine 170 may perform operations that provision vectorized predictive output 668, the elements of inferencing log data 666, and in some instances, the elements of process data 636, to executed artifact management engine 146, e.g., as output artifacts 670 of executed inferencing engine 170 within default inferencing pipeline 620.

Executed artifact management engine 146 may receive each of output artifacts 670, and may perform operations that package each of output artifacts 670 into a corresponding portion of inferencing artifact data 671, along with a unique, component identifier 170A of executed inferencing engine 170, and that store inferencing artifact data 671 within a corresponding portion of artifact data store 142, e.g., within data record 624 associated with default inferencing pipeline 620 and run identifier 626A. Further, although not illustrated in FIG. 6C, executed artifact management engine 146 may also package, into a corresponding portion of inferencing artifact data 671, additional data identifying and characterizing one or more of the input artifacts ingested by executed inferencing engine 170, and as described herein, the inclusion of the data characterizing the input artifacts ingested by executed inferencing engine 170, and the association of the data characterizing these input artifacts with the identifier of executed inferencing engine 170 and run identifier 626A of the current run of the default inferencing pipeline, may establish an artifact lineage facilitating recursive artifact auditing and tracking using any of the exemplary processes described herein.

Further, and in accordance with default inferencing pipeline 620, executed inferencing engine 170 may provide output artifacts 670, including vectorized predictive output 668 (e.g., the rows vectorized inferencing dataframe 660 and the appended elements of predictive output 664) and the elements of inferencing log data 666 as inputs to reporting engine 172 executed by the one or more processors of computing system 130. Based on programmatic communications with executed artifact management engine 146, executed orchestration engine 144 may perform operations that obtain output artifacts generated by respective ones of retrieval engine 156, preprocessing engine 158, indexing engine 160, target-generation engine 162, time-series splitting engine 164, time-series featurizer engine 166, and inferencing engine 170 within the current run of default inferencing pipeline 620, such as, but not limited to, output artifacts 644, 650, 654, and 662 maintained within data record 624 of artifact data store 142. Executed orchestration engine 144 may also provision each of the obtained output artifacts, and the elements of modified reporting configuration data 614 maintained configuration data store 1401, to executed reporting engine 172.

In some instances, executed reporting engine 172 may perform any of the exemplary processes described herein to establish a consistency of these input artifacts with the engine- and pipeline-specific operational constraints imposed on executed reporting engine 172. Based on an established consistency of the input artifacts with the imposed engine- and pipeline-specific operational constraints, executed reporting engine 172 may perform operations that generate one or more elements of pipeline reporting data 672 that characterize an operation and a performance of the discrete, modular components executed by the one or more processors of computing system 130 within default inferencing pipeline 620, and that characterize the predictive performance and accuracy of the machine-learning process during application to vectorized inferencing dataframe 660. As described herein, the elements of modified reporting configuration data 614 may specify a default composition of pipeline reporting data 672 and a customized format of pipeline reporting data 672, e.g., DOCX format.

By way of example, and based on corresponding ones of output artifacts 644, 650, 654, and 662, executed reporting engine 172 may perform operations that establish a successful, or failed, execution of corresponding ones of executed retrieval engine 156, preprocessing engine 158, indexing engine 160, target-generation engine 162, time-series splitting engine 164, time-series featurizer engine 166, and inferencing engine 170 within the current run of default inferencing pipeline 620, e.g., by confirming that each of the generated elements of artifact data are consistent, or inconsistent, with corresponding ones of the imposed, and enforced, operational constraints imposed and enforced by corresponding ones of the elements of configuration data and APIs. In some instances, executed reporting engine 172 may generate one or more elements of pipeline reporting data 384 indicative of the successful execution of the application engines within default inferencing pipeline 620 (and a successful execution of default inferencing pipeline 620) or alternatively, an established failure in an execution of one, or more, of the application engines within default inferencing pipeline 620 (e.g., and a corresponding failure of default inferencing pipeline 620).

In some examples, based on output artifacts 662 generated by time-series featurizer engine 166, and on output artifacts 670 generated by executed inferencing engine 170 (e.g., within default inferencing pipeline 620), executed reporting engine 172 may package, into portions of pipeline reporting data 672, final featurizer pipeline script 632 and the elements of process data 636 associated with the trained machine-learning process. Further, and based on output artifacts 662 generated by time-series featurizer engine 166, and on output artifacts 670 generated by executed inferencing engine 170, executed reporting engine 172 may perform any of the exemplary processes described herein to generate elements of explainability data characterizing the predictive performance and accuracy of the trained machine-learning process (e.g., the gradient-boosted, decision-tree process described herein, such as the XGBoost process) during application to vectorized inferencing dataframe 660 within default inferencing pipeline 620.

By way of example, the elements of explainability data may include, but are not limited to, one or more Shapley feature values that a relative importance of each of the discrete features within feature vectors 658 and/or values of one or more deterministic or probabilistic metrics that characterize the relative importance of discrete ones of the features, such as, but not limited to, data establishing ICE curves or PDPs, computed precision values, computed recall values, computed AUCs for ROC curves or PR curves, and/or computed MAUCs for ROC curves. Executed reporting engine 172 may also may perform operations that package the obtained portions of the explainability data into corresponding portions of pipeline reporting data 672.

Additionally, or alternatively, and based on one or more of output artifacts 644, 650, 654, and 662, executed reporting engine 172 may perform operations that generate values of metrics characterizing a bias or a fairness of the machine-learning process and additionally, or alternatively, at a bias or a fairness associated with the calculations performed at all, or a selected subset, of the discrete steps of the execution flow established by default inferencing pipeline 620, e.g., the sequential execution of retrieval engine 156, preprocessing engine 158, indexing engine 160, time-series featurizer engine 166, and inferencing engine 170 within default inferencing pipeline 620. As described herein, the metrics characterizing the bias or fairness may be imposed internally by the organization or enterprise, or may be associated with one or more governmental or regulatory entities, and executed reporting engine may package the generated metric values with a portion of pipeline reporting data 384.

Executed reporting engine 172 may structure the pipeline reporting data 672 in accordance with the elements of modified reporting configuration data 614, such as, but not limited to, DOCX format, and executed reporting engine 172 may provide pipeline reporting data 672 to executed artifact management engine 146, e.g., as output artifacts 674 of executed reporting engine 172 within default inferencing pipeline 620. In some instances, executed artifact management engine 146 may receive each of output artifacts 674, and may perform operations that package each of output artifacts 674 into a corresponding portion of reporting artifact data 675, along with identifier 168A of executed training engine 168, and that store reporting artifact data 675 within a corresponding portion of artifact data store 142, e.g., within data record 624 associated with default inferencing pipeline 620 and run identifier 626A. Further, although not illustrated in FIG. 6C, executed artifact management engine 146 may also package, into a corresponding portion of reporting artifact data 675, additional data identifying and characterizing one or more of the input artifacts ingested by executed reporting engine 172 within default inferencing pipeline 620.

In some instances, and upon completion of the current run of default inferencing pipeline 620 (e.g., at the prediction date of Jun. 1, 2024), executed orchestration engine 144 may also perform operations that cause the one or more processors of computing system 130 to transmit each, or a selected subset, of the elements of inferencing artifact data 671, which include output artifacts 670 generated by executed inferencing engine 170 during the current run of default inferencing pipeline 620, and the elements of reporting artifact data 675, which include output artifacts 674 generated by executed reporting engine 174 during the current run of default inferencing pipeline 620, to developer system 102. For example, referring to FIG. 6D, executed orchestration engine 144 may access data record 624 of artifact data store 142, which includes run identifier 626 of the current, June 1st run of default inferencing pipeline 620, and obtain output artifacts 670 and 674 from respective ones of inferencing artifact data 671 and reporting artifact data 675. As described herein, output artifacts 670 may include the elements of vectorized predictive output 668, which include each row of vectorized inferencing dataframe 660 and the appended element of predictive output 664, and inferencing log data 666, and output artifacts 674 may include pipeline reporting data 672, and executed orchestration engine 144 may package the elements of vectorized predictive output 668, inferencing log data 666, and pipeline reporting data 672 into corresponding portions of a response 676 to customization request 616, which computing system 130 may transmit across network 120 to developer system 102, e.g., via the secure, programmatic channel of communications established between executed web browser 108 and executed programmatic web service 148.

Developer system 102 may, for example, receive response 676, which includes vectorized predictive output 668, inferencing log data 666, and pipeline reporting data 672, and executed web browser 108 may store the elements of response 676 within a portion of memory 104. In some instances, executed web browser may process portions of response 676, such as, but not limited to, portions of vectorized predictive output 668, inferencing log data 666, and pipeline reporting data 672, and generate corresponding interface elements 678, which executed web browser 108 may route to display device 110 of developer system 102. Display device 110 may, for example, present portions of interface elements 678 within one or more display screens of an additional digital interface 480, and developer 103 may review interface elements 678A characterizing the elements of vectorized predicted output 668, interface elements 678B characterizing the elements of interface log data 666, and interface elements 678C characterizing the elements of pipeline reporting data 672 within the one or more display screens of digital interface 680.

As described herein, and for the particular use-case of interest to developer 103, the elements of predictive output 664 (e.g., as maintained within vectorized predictive output 668) may indicate a predicted likelihood of an occurrence, or a non-occurrence, of a targeted event involving corresponding ones of the subset of the users during the future temporal interval, e.g., a future, three-month temporal interval. By way of example, for the current, June 1st inferencing run of default inferencing pipeline 620, the elements of predictive output 664 may indicate the predicted likelihood of the occurrence, or the non-occurrence, of the targeted event involving the corresponding ones of the subset of users between Jun. 1, 2024, and Aug. 30, 2024, and the elements of predictive output 664 may inform, and support, one or more user-facing or back-end decisioning operations involving the corresponding ones of the subset of users.

To facilitate the user-facing or back-end decisioning operations, a decisioning application 482 executed by processor(s) 106 of developer system 102 may access the vectorized predictive output 668 maintained within memory 104, and obtain the elements of predictive output 664 and identifiers of the corresponding ones of the subset of the users (e.g., maintained within the rows of vectorized inferencing dataframe 660). For each of the subset of users, the elements of predictive output 664 may include a numerical value indicative of the predicted likelihood of the occurrence of the targeted event during the future temporal interval (e.g., a value of unity) or the predicted likelihood of the non-occurrence of the targeted event during the future temporal interval (e.g., a value of zero), and based on an application of one or more decision rubrics associated with the particular user-case of interest to developer 103 to the elements of predictive output 664, decisioning application 482 may generate elements of decisioning data 684, which may inform the user-facing or back-end decisioning operations involving corresponding ones of the users.

Though a performance of one or more of the exemplary processes described herein, the one or more processors of computing system 130 may facilitate a customization of a plurality of sequentially executed, default application engines within default inferencing pipeline 620 to reflect a particular use-case of interest to developer 103 without requiring any modification to the elements of executable code of these default application engines, any modification to inferencing pipeline script 152 that, upon execution, establishes default inferencing pipeline 620, and any modifications to an execution flow of the default application engines within default training pipeline 302. Certain of these exemplary processes, which leverage engine-specific elements of configuration data formatted and structured in a human-readable data-serialization language (e.g., a YAML™ data-serialization language, etc.) and accessible, and modifiable, using a browser-based interface, may enable analysts, data scientists, developers, and other representatives of the organization or enterprise characterized by various familiarities with machine-learning processes, and various skill levels in coding and scripting, to incorporate machine-learning processes into various, customer-facing or back-end decisioning operations, and to train adaptively, and deploy and monitor, machine-learning processes through default pipelines customized to reflect these decisioning processes.

D. Exemplary Computer-Implemented Processes for Configuring and Executing Sequentially Application Engines within Training and Inferencing Pipelines

FIG. 7 is a flowchart of an exemplary process 700 for configuring an execution of sequential operations within a default training, inferencing, or target-generation pipeline associated with a machine-learning process. In some examples, one or more computing systems within a distributed computing environment, such as one or more of the distributed computing components of computing system 130, may perform one or more of the steps of exemplary process 700, as described herein.

Referring to FIG. 7, the one or more processors of computing system 130 may perform operations, described herein, to establish a secure, programmatic channel of communications across communications network 120 with an application program executed at a computing system or device (e.g., in step 702 of FIG. 7). In some instances, computing system or device may be associated with, or operable by, a data scientist, developer, or other representative of the organization or enterprise associated with computing system 130 (e.g., developer system 102 operable by developer 103 of FIG. 1), and the one or more processors of computing system 130 may execute a programmatic web server, such programmatic web service 148 of FIG. 1, which may perform any of the exemplary processes described herein to establish the secure, programmatic channel of communications across communications network 120 with a web browser or other application program (e.g., web browser 108 of FIG. 1) executed by developer system 102 in accordance with one, or more, appropriate communications protocols, such as, but not limited to, a hypertext transfer protocol (HTTP), a transmission control protocol (TCP), or an internet protocol (IP).

In some instances, the one or more processors of computing system 130 may receive, from developer system 102, the one or more processors of computing system 130 a request to access one or more elements of pipeline-specific data associated with a corresponding one of the default training or inferencing pipelines described herein (e.g., in step 704 of FIG. 7). The requested elements of pipeline-specific data may include, but is not limited to, one or more executable pipelines scripts maintained within script data store 136 (e.g., training pipeline script 150 associated with default training pipeline 302 and inferencing pipeline script 152 associated with default inferencing pipeline 420), one or more default application engines maintained within component data store 138 (e.g. retrieval engine 156, preprocessing engine 158, indexing engine 160, a target-generation engine 162, splitting engine 164, time-series featurizer engine 166, training engine 168, inferencing engine 170, and reporting engine 172 executed sequentially within one, or more, of training pipeline script 150, inferencing pipeline script 152, and target-generation pipeline script 154).

The requested elements of pipeline-specific data may also include one or more elements of engine-specific configuration data maintained within configuration data store 140, such as, but not limited to, the elements of retrieval configuration data 157, preprocessing configuration data 159, indexing configuration data 161, target-generation configuration data 163, featurizer configuration data 167, training configuration data 169, inferencing configuration data 171, and reporting configuration data 173. Further, the received access request may also include an alphanumeric identifier of a corresponding one of the default training pipeline or the inferencing pipeline associated with the access request, along with one or more identifiers of developer system 102 (e.g., an IP address, a MAC address, etc.) and/or identifiers of executed web browser 108 (e.g., an application cryptogram, a digital token, etc.).

Referring back to FIG. 7, the one or more processors of computing system 130 may perform any of the exemplary processes described herein to determine whether a source of the access request is permitted to access the elements of pipeline-specific data (e.g., in step 706 of FIG. 7). For example, in step 706, the one or more processors of computing system 130 may obtain, from the access request, the one or more identifiers of developer system 102 or executed web browser 108, and may perform operations that determine, based on the one or more identifiers of developer system 102 or executed web browser 108, whether computing system 130 grants developer system 102 or executed web browser 108 permission to access the elements of pipeline-specific data (e.g., based on a comparison of the one or more identifiers against a compiled list of blocked computing devices, computing systems, or application programs).

If the one or more processors of computing system 130 were to determine that developer system 102, or executed web browser 108, is not permitted to access the elements of pipeline-specific data (e.g., step 706; NO), the one or more distributed computing components of computing system 130 may discard the access request and may perform operations that transmit an error message to developer system 102 (e.g., in step 708 of FIG. 7). Exemplary process 700 is then complete in step 710.

Alternatively, if the one or more processors of computing system 130 were to establish that developer system 102 and executed web browser 108 are permitted to access the requested elements of pipeline-specific data (e.g., step 706; YES), the one or more processors of computing system 130 may perform any of the exemplary processes described herein to obtain the pipeline identifier from the received access request, which identifies the corresponding one of the default training pipeline, the inferencing pipeline, or the target-generation pipeline associated with the access request, and based on the pipeline identifier, obtain the requested elements of pipeline-specific data associated with the corresponding one of the default training pipeline, the inferencing pipeline, or the target-generation pipeline (e.g., in step 712 of FIG. 7). The one or more processors of computing system 130 may also perform operations that generate a response to the access request that includes at least a portion of the requested elements of module-specific configuration data (e.g., also in step 712 of FIG. 7). The one or more processors of computing system 130 may also perform operations, in step 714 of FIG. 7, that transmit the generated response to the access request across communications network 120 to developer system 102, e.g., across the established, secure programmatic channel of communications.

In some instances, developer system 102 may receive the response to the access request from the one or more distributed computing components of computing system 130, and one or more application programs executed by developer system 102, such as executed web browser 108, may access the received response and perform operations that obtain, from the received response, at least the portion of the requested elements of pipeline-specific data (e.g., the elements of engine-specific configuration data associated with the corresponding one of the default training pipeline or the default inferencing pipeline, the executable pipeline script associated with the corresponding one of the default training pipeline or the inferencing pipeline. As described herein, executed web browser 108 may perform any of the exemplary processes described herein to process the obtained portion of the requested elements of pipeline-specific data, generate corresponding interface elements that provide a graphical or textual representation of the requested elements of pipeline-specific data, and render the generate interface elements for presentation within one or more display screens of a digital interface.

As described herein, developer 103 may elect to update, modify, or customize one or more of the requested elements of pipeline-specific data, such as, but not limited to, the default pipeline scripts, one or more of the default application engines, and/or one or more of the elements of engine-specific configuration data associated with the corresponding one of the default training pipeline or the inferencing pipeline, to reflect a particular use-case of interest to developer 103. In some instances, and based on the displayed interface elements, developer 103 may provision input to developer system 102 (e.g., via input device 112 of FIG. 1) that updates, modifies, or customizes one or more of the requested elements of pipeline-specific data, and based on the received input, executed web browser 108 may perform any of the exemplary processes described herein to update, modify, or customize the elements of pipeline-specific data and generate corresponding elements of customized, pipeline-specific data.

Executed web browser 108 may also perform operations, described herein, that package each of the elements of customized, pipeline-specific data into corresponding portions of a customization request, along with the pipeline identifier of the corresponding one of the default training pipeline or the default inferencing pipeline and the one or more identifiers of developer system 102 or executed web browser 108. Executed web browser 108 may transmit the customization request across communications network 120 to the one or more distributed computing components of computing system 130, e.g., via the established, secure, programmatic channel of communications.

By way of example, to reflect the particular use-case, developer 103 may elect to modify an operation of one or more of the default application engines executed sequentially within the corresponding one of the default training pipeline, the default inferencing pipeline or the default target-generation pipeline (e.g., default training pipeline 302, default inferencing pipeline 420, etc.), without any modification to the execution flow of that default pipeline or to the executable code of the one or more default application engines. As described herein, developer 103 may provision input to developer system 102 that updates, modifies, or customizes the elements of engine-specific configuration data associated with the one or more default application engines, and based on the provisioned input, executed web browser 108 may perform operations, described herein, that generate elements of customized, engine-specific configuration data that reflect the particular use-case of interest to developer 103 (e.g., the elements of customized, pipeline-specific data), and that package each of the elements of customized, engine-specific configuration data into corresponding portions of the customization request, along with the pipeline identifier and the one or more identifiers of developer system 102 or executed web browser 108.

Further, in some examples, developer 103 may elect replace one or more of the default application engines executed sequentially within the corresponding one of the default training pipeline or the default inferencing pipeline with a customized application engine that performs operations appropriate to the particular use-case, and consistent with the imposed engine- and pipeline-specific constraints, within the execution flow of that default pipeline. As described herein, and based on input provisioned to developer system 102, developer system 102 may perform any of the exemplary processes described herein to generate the customized application engine and corresponding elements of engine-specific configuration data, and to package, into corresponding portions of the customization request, the customized application engine, a component identifier, and the elements of customized, engine-specific configuration data (e.g., as the elements of customized, pipeline-specific data), along with the pipeline identifier and the one or more identifiers of developer system 102 or executed web browser 108.

Additionally, and as described herein, developer 103 may elect to modify an execution flow of the sequentially executed default application engines within the corresponding one of the default training pipeline of the default inferencing pipeline to reflect the particular use-case. By way of example, and as described herein, developer 103 may elect, within the default training pipeline (e.g., default training pipeline 302), to calls or invokes multiple instances of time-series featurizer engine 166 (e.g., in accordance with respective ones of vector-specific elements 520A, 520B . . . 520N of customized featurizer configuration data of FIG. 5A), multiple instances of training engine 168, and a single instance of reporting engine 172 within a customized training pipeline established by a developer-specified, customized training script (e.g., customized training pipeline script 510 of FIGS. 5A and 5B). As described herein, and based on input provisioned to developer system 102, developer system 102 may perform any of the exemplary processes described herein to generate a customized pipeline script (e.g., the customized training script) and corresponding elements of engine-specified configuration data that support the execution flow of the customized pipeline script, and to package, into corresponding portions of the customization request, the customized pipeline script and corresponding elements of engine-specified configuration data (e.g., as the elements of customized, pipeline-specific data), along with the pipeline identifier and the one or more identifiers of developer system 102 or executed web browser 108.

Referring back to FIG. 7, the one or more processors of computing system 130 may receive the customization request across communications network 120 from developer system 102 (e.g., in step 716 of FIG. 7). In some instances, the one or more distributed computing components of computing system 130 may receive the customization request from developer system 102 across communications network 120 via the established, secure, programmatic channel of communications using one or more appropriate communications protocols.

As described herein, the customization request may include, among other things, one or more identifiers of developer system 102 or executed web browser 108, such as, but not limited to, the IP or MAC address of developer system 102 and/or the digital token or application cryptogram identifying executed web browser 108. The received customization request may also include the pipeline identifier of the corresponding one of the default training pipeline, the inferencing pipeline, or the target-generation pipeline associated with the access request and the elements of customized, pipeline-specific data the particular application or use-case of interest to developer 103, such as, but not limited to, the exemplary elements of customized, pipeline-specific data described herein.

In some instances, the one or more processors of computing system 130 may perform any of the exemplary processes described herein to determine whether a source of the customization request is permitted to update, modify, or customize the elements of pipeline-specific data maintained within script data store 136, component data store 138, and/or configuration data store 140 (e.g., in step 718 of FIG. 7). For example, in step 818, the one or more processors of computing system 130 may obtain, from the customization request, the one or more identifiers of developer system 102 or executed web browser 108, and may also perform operations that determine, based on the one or more identifiers of developer system 102 or executed web browser 108, whether computing system 130 grants developer system 102 or executed web browser 108 permission to update, modify, or customize the elements of module-specific configuration data and/or pipeline-specific scripts (e.g., based on a comparison of the one or more identifiers against a compiled list of blocked computing devices, computing systems, or application programs).

If the one or more processors of computing system 130 were to determine that developer system 102, or executed web browser 108, is not permitted to update, modify, or customize the elements of pipeline-specific data (e.g., step 718; NO), the one or more processors of computing system 130 may discard the received customization request and may perform operations that transmit an error message to developer system 102 (e.g., in step 720 of FIG. 7). Exemplary process 700 is then complete in step 710.

Alternatively, if the one or more processors of computing system 130 to establish that developer system 102 and executed web browser 108 are permitted to update, modify, or customize the elements of pipeline-specific data (e.g., step 718; YES), the one or more processors of computing system 130 may obtain the elements of customized, pipeline-specific data from the customization request, and may perform any of the exemplary processes described herein to determine whether the requested customization, and the elements of customized, pipeline-specific data, are consistent with one or more engine-specific and pipeline-specific constraints associated with the corresponding one of the default training pipeline or the inferencing pipeline (e.g., in step 722 of FIG. 7). If, for example, the one or more processors of computing system 130 were to determine an inconsistency between the elements of customized, pipeline-specific data and at least one or more of the imposed constraints, the one or more processors of computing system 130 may decline to implement the requested customization (e.g., step 722; NO). Exemplary process 700 may pass back to step 720, and the one or more processors of computing system 130 may discard the received customization request and may perform operations that transmit an error message to developer system 102. Exemplary process 700 is then complete in step 710.

Alternatively, if the one or more processors of computing system 130 executed customization application 204 were to determine a consistency between each of the imposed constraints and the elements of customized, pipeline-specific data, the one or more processors of computing system 130 may approve customization request and perform any of the exemplary processes described herein to implement the requested customization to the elements of pipeline-specific data maintained within script data store 136, component data store 138, and/or configuration data store 140 (e.g., in step 724 of FIG. 7). By way of example, in step 824, the one or more processors of computing system 130 may obtain the customized pipeline script (e.g., customized training pipeline script 510 of FIG. 5A) and corresponding elements of engine-specific configuration data from the customization request, and may perform operations, described herein, to access a corresponding one of the executable pipeline scripts (e.g., maintained within script data store 136) associated with the pipeline identifier and to replace the default pipeline script with the customized pipeline script. The one or more processors of computing system 130 may also perform operations, in step 824, that store the corresponding elements of engine-specific configuration data within configuration data store 140. Upon implementation of the requested customization by the one or more processors of computing system 130 in step 724, exemplary process 700 is complete in step 710.

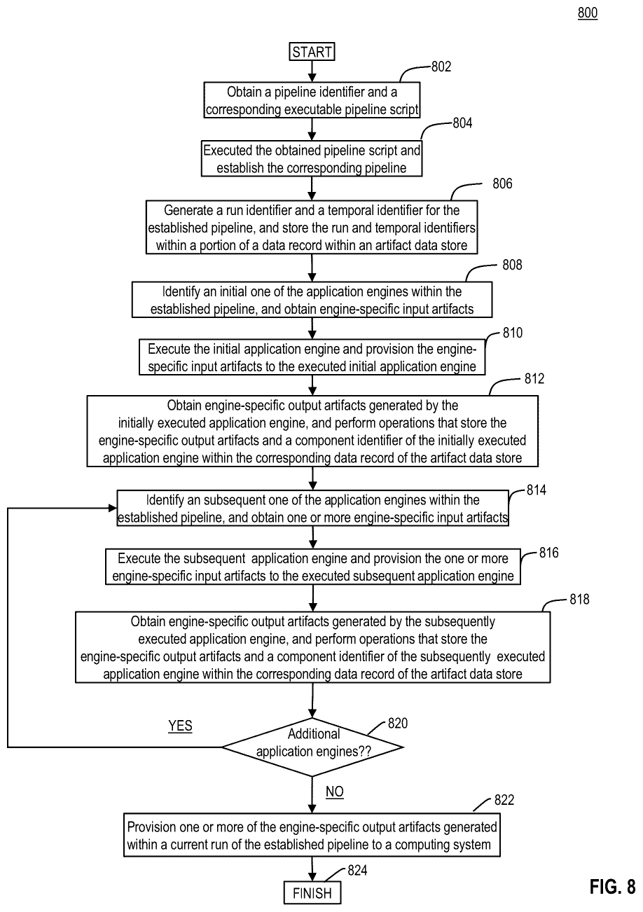

FIG. 8 is a flowchart of an exemplary process 800 for executing sequentially application engines within training, inferencing, or target-generation pipeline associated with a machine-learning process. As described herein, within a corresponding one of the training, inferencing, or target-generation pipelines, one or more of the sequentially executed application engines may include a default application that perform operations in accordance with one or more elements of engine-specific configuration data, which may be customized by computing system 130 to reflect a particular use-case of interest to developer 103 using any of the exemplary processes described herein. In some instances, and within a corresponding one of the training or inferencing pipelines, one or more of the sequentially executed application engines may include a customized or “bespoke” application engine generated by developer 103 reflect the particular use-case of interest. The customized or “bespoke” application engine may, for example, confirm to the engine- and pipeline-specific constraints imposed on the corresponding one of the training or inferencing pipelines, and when sequentially executed within the corresponding one of the training or inferencing, pipelines, the executed customized or bespoke application engine may perform operations in accordance with one or more elements of engine-specific, customized configuration data.

Further, and as described herein, one or more of the training, inferencing, or target-generation pipelines may represent a default pipeline characterized by a corresponding, default execution flow (e.g., a sequential order in which the corresponding default pipeline executed the application engines) established by corresponding, default pipeline script (e.g., a corresponding one of default training pipeline script 150, default inferencing pipeline script 152, etc.). In other instances, also described herein, one or more training or inferencing pipelines may represent a customized pipeline characterized by a customized, or “bespoke” execution flow established by a corresponding pipeline script, which may be customized by computing system 130 to reflect the potential use-case of interest to developer 103 using any of the exemplary processes described herein. In some examples, one or more computing systems, such as one or more of the distributed computing components of computing system 130, may perform one or more of the steps of exemplary process 800, as described herein.

Referring to FIG. 8, the one or more processors of computing system 130 may perform any of the exemplary processes described herein to obtain a pipeline identifier associated with a corresponding one of the training, inferencing, and target-generation pipelines described herein, and to obtain an executable pipeline script associated with the pipeline identifier (e.g., in step 802 of FIG. 8). By way of example, the one or more processors of computing system 130 may obtain the pipeline identifier from a customization request generated by, and received from, the computing system 130, which requests an update to, modification of, or customization of, one or more elements of engine-specific configuration data (e.g., as maintained within configuration data store 140), one or more executable application engines (e.g., as maintained within component data store 138), and additionally, or alternatively, one or more executable pipeline scripts (e.g., as maintained within script data store 136), and in some instances, the one or more processors of computing system 130 may obtain the pipeline identifier upon approval and implementation of the requested customization using any of the exemplary processes described herein.

Further, in some instances, the one or more processors of computing system 130 may perform operations, in step 802, that access script data store 136 and obtain the executable pipeline script associated with the pipeline identifier from script data store 136. The executable pipeline script may, for example, include one of training pipeline script 150 associated with default training pipeline 302 and inferencing pipeline script 152 associated with default inferencing pipeline 420. Additionally, in some examples, the executable pipeline script may include a customized pipeline script associated with a corresponding one of the customized pipelines characterized by the customized, or “bespoke” execution flows (e.g., customized training pipeline script 510 associated with customized training pipeline 522, etc.).

The one or more processors of computing system 130 may also perform operations that execute the obtained pipeline script, and establish and initiate the corresponding pipeline based on the execution of the obtained pipeline script (e.g., in step 804 of FIG. 8). In some instances, the established pipeline may correspond to one of the default pipelines described herein (e.g., one of default training pipeline 302 or default inferencing pipeline 420, etc.) or one or the customized or bespoke pipelines described herein (e.g., customized training pipeline 522, etc.). Further, the one or more processors may generate a unique, alphanumeric run identifier for the established pipeline and a temporal identifier characterizing an initiation date of the established pipeline, and may perform any of the exemplary processes described herein to store the run identifier and the temporal identifier within a corresponding, data record of a data repository, such as artifact data store 142 (e.g., in step 806 of FIG. 8). In some instances, the storage of the run identifier and the temporal identifier may associate the corresponding data record with the current implementation or “run” of the established pipeline.

Based on the executed pipeline script, the one or more processors of computing system 130 may identify an initial one of the application engines executed sequentially within the established pipeline (e.g., one of the default application engines, or the customized applications, maintained within component data store 138), and obtain, as an input artifact, one or more elements of engine-specific configuration data associated with the identified application engine, such as, but not limited to, one or more of the elements of default, modified, or customized engine-specific configuration data maintained within configuration data store 140 (e.g., in step 808 of FIG. 8). The one or more processors of computing system 130 may also perform operations, described herein, that execute the identified application engine and provision the one or more input artifacts, including the elements of engine-specific configuration data, to the initially executed application engine (e.g., in step 810 of FIG. 8).

In some instances, upon executed within the established pipeline, the initially executed application engine may ingest the one or more input artifacts (e.g., the corresponding elements of engine-specific configuration data), and a programmatic interface of the initially executed application engine may perform any of the exemplary processes described herein to establish a consistency of the corresponding input artifacts with the engine- and pipeline-specific operational constraints imposed on executed splitting engine 164 (e.g., also in step 810 of FIG. 8). Based on an established consistency of the input artifacts with the imposed engine- and pipeline-specific operational constraints, the initially executed application engine may perform operations, described herein, that are consistent with the one or more elements of engine-specific configuration data (e.g., which may be customized to reflect the particular use-case of interest to developer 103 using any of the exemplary processes described herein), and that generate one or more engine-specific output artifacts based on the performance of the operations (e.g., also in step 810 of FIG. 8).

In some instances, the one or more processors of computing system 130 may obtain each of the engine-specific output artifacts generated by the initially executed application engine (and in some instances, the one or more engine-specific input artifacts), and perform any of the exemplary processes described herein to store each of the engine-specific input and/or output artifacts and the component identifier of initially executed application engine within the corresponding data record of artifact data store 142 (e.g., in step 812 of FIG. 8). As described herein, the storage of the engine-specific input and/or output artifacts in association with the component identifier of the initially executed application, and with the run and temporal identifiers, may associate the engine-specific output artifacts with the current run of the established pipeline, and may facilitate an auditing and tracking of these output artifacts using any of the exemplary processes described herein.

Referring back to FIG. 8, the one or more processors of computing system 130 may identify a subsequent one of the application engines executed sequentially within the established pipeline based on the executed pipeline script, and may perform any of the exemplary processes described herein to obtain one or more engine-specific input artifacts for the identified, subsequently executed application engine (e.g., in step 814 of FIG. 8). The engine-specific input artifacts for the subsequently executed application engine may include additional elements of the engine-specific configuration data maintained within configuration data store 140 and in some instances, one or more of the output artifacts generated by previously executed application engine(s) within the established pipeline and maintained with the corresponding row of artifact data store 142. The one or more processors of computing system 130 may also perform operations, described herein, that execute the identified application engine and provision the one or more engine-specific input artifacts, including the additional elements of engine-specific configuration data, to the subsequently executed application engine (e.g., in step 816 of FIG. 8).

In some instances, subsequently executed application engine may perform any of the exemplary processes described herein, in step 816, to establish a consistency of the one or more engine-specific input artifacts with one or more operational constraints imposed on the subsequently executed application engine. Based on the established consistency, the subsequently executed application engine may perform operations, described herein, that are consistent with the additional elements of engine-specific configuration data (e.g., which may be customized to reflect the particular use-case of interest to developer 103 using any of the exemplary processes described herein), and that generate one or more engine-specific output artifacts based on the performance of the operations (e.g., also in step 816). The one or more processors of computing system 130 may obtain each of the engine-specific artifacts generated by the subsequently executed application engine (and in some instances, one or more of the engine-specific input artifacts), and perform any of the exemplary processes described herein to store each of the engine-specific input and/or output artifacts and a component identifier of subsequently executed application engine within the corresponding data record of artifact data store 142 (e.g., in step 818 of FIG. 8). As described herein, the storage of the engine-specific input and/or output artifacts in association with the component identifier of the subsequently executed application, and with the run and temporal identifiers, may associate the engine-specific input and/or output artifacts with the current run of the established pipeline, and may facilitate an auditing and tracking of these input and/or output artifacts using any of the exemplary processes described herein.

Further, and based on the executed pipeline script, the one or more processors of computing system 130 may determine whether additional application engines (e.g., the default or customized application engines described herein) await sequential execution within the established pipeline (e.g., in step 820 of FIG. 8). If the one or more processors of computing system 130 were to establish that additional application engines await execution within the established pipeline (e.g., step 820; YES), exemplary process 800 may pass back to step 814, and the one or more processors of computing system 130 may perform any of the exemplary processes described herein to identify a subsequent one of the application engines awaiting execution within the established pipeline based on the executed pipeline script, and to obtain one or more engine-specific input artifacts for the identified, subsequently executed application engine.

Alternatively, if the one or more processors of computing system 130 were to establish that no additional application engines await execution within the established pipeline (e.g., step 820; NO), the one or more processes of computing system 130 may deem complete the current run of the established pipeline, and may perform any of the exemplary processes described herein to transmit one or more of the engine-specific output artifacts generated through the sequential execution of the application engines within the current run of the established pipeline across network 120 to a computing system or device associated with a developer or a computer scientists, such as, but not limited to, developer system 102 of FIG. 1 (e.g., in step 822 of FIG. 8). By way of example, the one or more processors of computing system 130 may transmit the one or more output artifacts to developer system 102 via a secure, programmatic channel of communications across communications network 120 established between web browser 108 executed at developer system 102 and programmatic web service 148 executed by the one or more processors of computing system 130. Exemplary process 800 is then complete in step 824.

### E. Exemplary Computing Architectures

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Exemplary embodiments of the subject matter described in this specification, including, but not limited to, web browser 108, orchestration engine 144, artifact management engine 146, programmatic web service 148, training pipeline script 150, inferencing pipeline script 152, target-generation pipeline script 154, retrieval engine 156, preprocessing engine 158, indexing engine 160, target-generation engine 162, splitting engine 164, time-series featurizer engine 166, training engine 168, inferencing engine 170, reporting engine 172, web framework 202, customization application 204, application programming interface (API) 206, preprocessing module 332, featurizer module 340, code 351, featurizer pipeline script 352, initial training script element 508, customized training pipeline script 510, customized training script element 512, scripts 518, and final featurizer pipeline script 632, may be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
obtain a dataset comprising a plurality of indexed data elements, each of the indexed data elements comprising a sample identifier and a temporal identifier associated with a corresponding temporal interval;
based on the sample and temporal identifiers, perform operations that partition the dataset into corresponding ones of a plurality of partitioned datasets in accordance with first configuration data, each of the partitioned datasets comprising a subset of the indexed data elements;
generate feature vectors associated with each of the partitioned datasets based on the corresponding subset of the indexed data elements, the feature vectors being generated in accordance with second configuration data; and
perform operations, in accordance with third configuration data, that train a machine-learning process to predict an occurrence of a target event during a future temporal interval based on the feature vectors associated with each of the partitioned datasets.

2. The apparatus of claim 1, wherein:
the machine-learning process comprises a forward-in-time machine learning process; and
the at least one processor is further configured to perform the operations that partition the dataset into corresponding ones of the plurality of partitioned datasets, and to generate the feature vectors associated with each of the partitioned datasets, without data leakage.

3. The apparatus of claim 1, wherein:
the first configuration data comprises sampling data and temporal splitting data;
the partitioned datasets comprise a training dataset, a validation dataset, and a testing dataset; and
the at least one processor is further configured to execute the instructions to partition the dataset into corresponding ones of the training dataset, the validation dataset, and the testing dataset in accordance with the sampling data and the temporal splitting data, each of the training dataset, the validation dataset, and the testing dataset comprising the corresponding subset of the indexed data elements and ground-truth labels associated with corresponding ones of the indexed data elements.

4. The apparatus of claim 1, wherein:
each of the feature vectors comprise values of a plurality of features;
the second configuration data specifies, for each of the feature values, at least one of an aggregation operation or a post-processing operation, source data associated with the feature values, and a prior temporal interval; and
the at least one processor is further configured to execute the instructions to, for each of the subset of the indexed data elements of a corresponding one of the partitioned datasets, generate the feature values based on an application of the at least one of the aggregation operation or the post-processing operation to elements of source data associated with the prior temporal interval.

5. The apparatus of claim 4, wherein the at least one processor is further configured to execute the instructions to:
obtain the sample identifier and the temporal identifier associated with each of the subset of the indexed data elements of the corresponding one of the partitioned datasets;
for each of the subset of the indexed data elements of the corresponding one of the partitioned datasets, perform operations that obtain the elements of source data based on the second configuration data, and determine that the elements of source data are (i) associated with the prior temporal interval based on the corresponding temporal identifier and (ii) associated with the sample identifier; and
for each of the subset of the indexed data elements of the corresponding one of the partitioned datasets, generate each of the feature values based on an application of the at least one of the aggregation operation or the post-processing operation to elements of source data.

6. The apparatus of claim 4, wherein:
the feature values of at least one of the feature vectors are associated with a feature group, and the at least one of the aggregation operation or the post-processing operation is associated with the feature group; and
the second configuration data comprises a group identifier of the feature group, feature identifiers of the feature values, and an operation identifier of the at least one of the aggregation operation or the post-processing operation, the second configuration data associating the group identifier with each of the feature identifiers and with the operation identifier.

7. The apparatus of claim 1, wherein:
the third configuration data comprises an identifier of the machine-learning process and a value of a process parameter of the machine-learning process; and
the at least one processor is further configured to execute the instructions to:
apply the machine-learning process to the feature vectors associated with each of the partitioned datasets in accordance with the process parameter value; and
based on the application the machine-learning process to the feature vectors, generate elements of predictive output associated with corresponding ones of the indexed data elements of each of the partitioned datasets.

8. The apparatus of claim 1, wherein the at least one processor is further configured to execute the instructions to generate elements of explainability data characterizing the training of the machine-learning process in accordance with fourth configuration data, the elements of explainability data comprising at least one of (i) a first value characterizing an importance of one or more features on an output of the trained machine-learning process or (ii) a second value characterizing a performance of the trained machine-learning process.

9. The apparatus of claim 8, wherein the at least one processor is further configured to:
based on at least a portion of the explainability data, determine a modified composition of the feature vectors, and generate modified second configuration data that specifies the modified composition;
in accordance with the modified second configuration data, generate additional feature vectors associated with each of the partitioned datasets based on the corresponding subset of the indexed data elements; and
perform additional operations, in accordance with the third configuration data, that train the machine-learning process to predict the occurrence of the target event during the future temporal interval based on the additional feature vectors associated with each of the partitioned datasets.

10. The apparatus of claim 1, wherein the at least one processor is further configured to execute the instructions to:
obtain a plurality of elements of the second configuration data, each of the elements of the second configuration data being associated with an additional feature vector and specifying a composition of the additional feature vector;
for each of the subset of the indexed data elements of corresponding ones of the partitioned datasets, generate each of the additional feature vectors based on a corresponding one of the elements of the second configuration data;
perform operations, in accordance with the third configuration data, that train the machine-learning process to predict the occurrence of the target event during the future temporal interval based on the additional feature vectors associated with each of the partitioned datasets; and
generate elements of explainability data characterizing the training of the machine-learning process based on the additional feature vectors, the elements of explainability data comprising ranked values characterizing an importance of each feature within the additional feature vectors on an output of the trained machine-learning process.

11. The apparatus of claim 1, wherein the at least one processor is further configured to receive, via the communications interface, at least one of the first configuration data, the second configuration data, or the third configuration data from a computing system, the computing system being configured to generate the at least one of the first configuration data, the second configuration data, or the third configuration data.

12. The apparatus of claim 1, wherein the at least one processor is further configured to:
obtain, from the memory, pipelining data characterizing a sequential execution of a plurality of application engines, each of the application engines being associated with a corresponding one of the first, second, and third configuration data;
based on the pipelining data, execute sequentially the application engines based on the corresponding ones of the first, second, and third configuration data, the executed application engines causing the at least one processor to
obtain the dataset comprising the plurality of indexed data elements;
perform the operations that partition the dataset into the corresponding ones of the partitioned datasets based on the sample and temporal identifiers;
generate the feature vectors associated with each of the partitioned datasets based on the corresponding subset of the indexed data elements; and
perform the operations that train the machine-learning process based on the feature vectors associated with each of the partitioned datasets;
obtain artifact data generated by the executed application engines and store the artifact data within a portion of the memory; and
transmit at least a portion of the artifact data to a computing system via the communications interface.

13. A computer-implemented method, comprising:
obtaining, using at least one processor, a dataset comprising a plurality of indexed data elements, each of the indexed data elements comprising a sample identifier and a temporal identifier associated with a corresponding temporal interval;
based on the sample and temporal identifiers, performing operations, using the at least one processor, that partition the dataset into corresponding ones of a plurality of partitioned datasets in accordance with first configuration data, each of the partitioned datasets comprising a subset of the indexed data elements;
generating, using the at least one processor, feature vectors associated with each of the partitioned datasets based on the corresponding subset of the indexed data elements, the feature vectors being generated in accordance with second configuration data; and
using the at least one processor, performing operations, in accordance with third configuration data, that train a machine-learning process to predict an occurrence of a target event during a future temporal interval based on the feature vectors associated with each of the partitioned datasets.

14. The computer-implemented method of claim 13, wherein:
the first configuration data comprises sampling data and temporal splitting data;
the partitioned datasets comprise a training dataset, a validation dataset, and a testing dataset; and
the computer-implemented method further comprises partitioning, using the at least one processor, the dataset into corresponding ones of the training dataset, the validation dataset, and the testing dataset in accordance with the sampling data and the temporal splitting data, each of the training dataset, the validation dataset, and the testing dataset comprising the corresponding subset of the indexed data elements and ground-truth labels associated with corresponding ones of the indexed data elements.

15. The computer-implemented method of claim 13, wherein:
each of the feature vectors comprise values of a plurality of features;
the second configuration data specifies, for each of the feature values, at least one of an aggregation operation or a post-processing operation, source data associated with the feature values, and a prior temporal interval; and
the generating comprises, for each of the subset of the indexed data elements of a corresponding one of the partitioned datasets, generating the feature values based on an application of the at least one of the aggregation operation or the post-processing operation to elements of source data associated with the prior temporal interval.

16. The computer-implemented method of claim 13, wherein:
the third configuration data comprises an identifier of the machine-learning process and a value of a process parameter of the machine-learning process; and
the performing the operations that train the machine-learning process comprises:
applying the machine-learning process to the feature vectors associated with each of the partitioned datasets in accordance with the process parameter value; and
based on the application the machine-learning process to the feature vectors, generating elements of predictive output associated with corresponding ones of the indexed data elements of each of the partitioned datasets.

17. The computer-implemented method of claim 13, further comprising:
generating, using the at least one processor, elements of explainability data characterizing the training of the machine-learning process in accordance with fourth configuration data, the elements of explainability data comprising at least one of (i) a first value characterizing an importance of one or more features on an output of the trained machine-learning process or (ii) a second value characterizing a performance of the trained machine-learning process;
based on at least a portion of the explainability data, and using the at least one processor, determine a modified composition of the feature vectors, and generate modified second configuration data that specifies the modified composition;
in accordance with the modified second configuration data, generating, using the at least one processor, additional feature vectors associated with each of the partitioned datasets based on the corresponding subset of the indexed data elements; and
using the at least one processor, performing additional operations, in accordance with the third configuration data, that train the machine-learning process to predict the occurrence of the target event during the future temporal interval based on the additional feature vectors associated with each of the partitioned datasets.

18. The computer-implemented method of claim 13, further comprising:
obtaining, using the at least one processor, a plurality of elements of the second configuration data, each of the elements of the second configuration data being associated with an additional feature vector and specifying a composition of the additional feature vector;
for each of the subset of the indexed data elements of corresponding ones of the partitioned datasets, generating, using the at least one processor, each of the additional feature vectors based on a corresponding one of the elements of the second configuration data;
using the at least one processor, performing operations, in accordance with third configuration data, that train the machine-learning process to predict the occurrence of the target event during the future temporal interval based on the additional feature vectors associated with each of the partitioned datasets; and
generating, using the at least one processor, elements of explainability data characterizing the training of the machine-learning process based on the additional feature vectors, the elements of explainability data comprising ranked values characterizing an importance of each of the features within the additional feature vectors on an output of the trained machine-learning process.

19. The computer-implemented method of claim 13, further comprising receiving, using the at least one processor, at least one of the first configuration data, the second configuration data, or the third configuration data from a computing system, the computing system being configured to generate the at least one of the first configuration data, the second configuration data, or the third configuration data.

20. A tangible, non-transitory computer-readable medium storing instructions that, when executed by at least one processor, cause the at least one processor to perform a method, comprising:
obtaining a dataset comprising a plurality of indexed data elements, each of the indexed data elements comprising a sample identifier and a temporal identifier associated with a corresponding temporal interval;
based on the sample and temporal identifiers, performing operations that partition the dataset into corresponding ones of a plurality of partitioned datasets in accordance with first configuration data, each of the partitioned datasets comprising a subset of the indexed data elements;
generating feature vectors associated with each of the partitioned datasets based on the corresponding subset of the indexed data elements, the feature vectors being generated in accordance with second configuration data; and
performing operations, in accordance with third configuration data, that train a machine-learning process to predict an occurrence of a target event during a future temporal interval based on the feature vectors associated with each of the partitioned datasets.
